(19) United States
(12) Patent Application Publication
(10) Pub. No.: US 2020/0210158 A1
(43) Pub. Date: Jul. 2, 2020

(54) AUTOMATED OR MACHINE-ENHANCED SOURCE CODE DEBUGGING

(71) Applicant: PHASE CHANGE SOFTWARE LLC, Golden, CO (US)

(72) Inventors: Steven BUCUVALAS, Golden, CO (US); Hugolin BERGIER, Boulder, CO (US)

(21) Appl. No.: 16/614,453

(22) PCT Filed: May 1, 2018
(86) PCT No.: PCT/US2018/030395

§ 371 Date: Nov. 18, 2019

Related U.S. Application Data
(60) Provisional application No. 62/512,428, filed on May 30, 2017.
(60) Provisional application No. 62/620,756, filed on Jan. 23, 2018.

(51) Int. Cl. G06F 8/41; G06F 11/36; G06F 8/75

(52) U.S. Cl. CPC G06F 8/433; G06F 8/427; G06F 8/75; G06F 11/3604

(57) ABSTRACT

Analyzing software, in particular, a voluminous quantity of source code is significant burden for many computing platforms. Bugs must be found, features added, removed, and modified, all without inducing new errors. By providing a Dependency Ordered Behavior (DOB), a language-agnostic model of software may be machine-derived and associated with natural human terminology for a particular domain. As a result, software may be reviewed and/or automatically edited with confidence in knowing what portions of the code will and will not be impacted.

### CROSS-REFERENCE TO RELATED APPLICATIONS

The present application claims the benefit of U.S. Provisional Patent Application No. 62/512,428, filed May 30, 2017, entitled “Mia-Equinox: Introduction to DOB-Concepts and Agent-Based Collaboration” and U.S. Provisional Patent Application No. 62/620,756, filed Jan. 23, 2018, entitled “Automated or Machine-Enhanced Source Code Debugging” each of which are incorporated herein by reference in their entirety.

### FIELD OF THE DISCLOSURE

The system herein generally relates to electronic computing devices and more specifically electronic computing devices utilized to modify computer instructions without human intervention.

### BACKGROUND

As is generally true in most aspects of human endeavor, the identification of a target source code element is not particularly challenging when the corpus comprising the target (e.g., a module, program, programs, etc.) is relatively small. However, as the corpus grows, so too does the difficulty in locating a target element. While a text or character search for a literal string is one way to locate the target element, such techniques fail when the target is in a form that cannot be located by mere textual searching.

Searching is often a first step in a process to validate, debug, or update source code. The target element is identified, such as by trial-and-error scanning or text-based searching, monitoring execution traces, or other means known in the prior art. With the target element identified, a particular portion of computer code related to or comprising the target element may be presented to a user to receive a modification, which may address an error or update functionality of the source code. However, the code presented may be erroneously identified and thereby lure the user into modifying the wrong computer code. Alternatively, the modification to the correct target source code may have unintended consequences, such as to cause other functionality to become errant. Even when the correct target source code is identified, the process of identifying the target source code may be distributed across one or more modules, programs, or systems. For large software systems, such modifications often require a multitude of programmers working over an extended period of time. This labor intensive, brute-force, approach can be effective, but it's error prone and often incomplete with no assurances that the desired modification was exhaustively applied or applied as expected. As a result, at least one iteration of retesting the modified code is usually essential. But even with modern testing software, rarely does software get released bug-free or, when adding new functionally, accurately enabled to the extent intended. These and other issues unduly burden the systems, individuals, and methodologies of the prior art.

### SUMMARY

It is with respect to the above issues and other problems that the embodiments presented herein were contemplated.

It is with respect to the above issues and other problems that the embodiments presented herein were contemplated. Locating a target source code in a large program (e.g., multi-million-line source code) is a daunting task. Computer systems, and their associated programs determined by source code, change. Changes may occur during development as well as over time, such as error patches and functionality updates. Additionally, modifications not previously contemplated may require additional and extensive modifications, for example, a business with one system may merge with another business using a second system. The two systems may each perform similar, or even identical, business operations but with differing computer systems and software. Differences may result from the selection of dissimilar programming languages, architectures, error handling philosophies, security philosophies, speed requirements, programmer preferences, backup strategies, or innumerable other aspects of system development.

In one example, one bank has purchased a second bank and wishes to merge their computer systems. If the two banks offered exactly the same banking products, the merger could be quite simple, such as when the only task is to merge the data records of the clients and/or cosmetic changes. However, this is only possible as a theoretical example, as real-world differences inevitably exist, both minor (e.g., one bank uses “client_name_last” as a data field and the corresponding system for the other bank uses “n.last” as the data field) and major differences that run much deeper. For example, system architectures may cause differences such as when prior to approving a withdrawal, one bank polls all branch computers for any transactions imitated for the subject account. In contrast, the other bank may not use branch computers for account debiting, and instead, all branches send transaction requests to a central system. Other differences may result from computerization of a particular business technique when other techniques are equally valid. For example, one bank may calculate daily interest as the daily interest rate multiplied by the account balance as of one second after midnight. Another bank may calculate interest based upon the account balance as of the close of business. While the difference may be negligible for all but the largest corporate accounts, a resolution cannot be provided arbitrarily without invoking the wrath of corporate customers or banking regulators. Capriciously changing an interest calculation may only result in minuscule discrepancies but stealing small fractions of pennies over many instances has been the subject of many fictionalized, and possible actual, bank robbery attempts—a fact not likely to go unnoticed by banking regulators and large customers. In other examples, the differences may be even more substantial, such as when one bank offers loans and deposit accounts (e.g., savings, checking, certificates of deposit, etc.) and the other bank offers investment products. While some software may remain segregated, others may need to be combined. These are but some of the nuanced-to-substantial differences that may exist between two systems.

The architecture of the two systems may define many of the differences between two disparate systems. For example, the merger of a bank that provides real-time balance information to every terminal (e.g., automated teller machines, main and branch office teller terminals, wire terminal, website, etc.) with real-time, transaction-based backups, may merge with an insurance company that provides balance information to a single account manager's terminal (ergo, no need for multi-location access to a real-time account balance), performs nightly system backups, and weekly batch transactions. Other architectural differences may present a multitude of integration issues.

The insurance company may be unconcerned about a simultaneous attempt to withdrawal the same funds from different locations, a feature reflected in its architecture, which may have intermittent connection to a central repository. For, examples, agents may be entirely locked out of accounts during the batch update, which may occur after hours. In contrast, a bank may need to backup transactions at the main bank and at each branch bank, including ATMs, but with rapid updates and record and/or transaction-based locking, such as to prevent unauthorized withdrawals of the same funds at multiple location.

In addition to such high-level differences, countless low-level differences may also exist. An architecture that utilizes batch updates may have a different communication architecture than a real-time banking system. Security implementations may require all terminals to be polled for activity on an account before another terminal can grant access to withdrawal account funds. One error system may discard an update and instruct an operator or user to try again while another error handling system may lock records, notify a supervisor (human and/or automated component), attempt to resolve the issue, or permit the transaction, or a portion thereof, but with the transaction being flagged to require subsequent action (by human and/or automated component). Certain errors may resolve over time, such as a questionable amount of a check presented for deposit may automatically be resolved by a component upon such a component determining that the issuer of the check raised no objection within a protest period.

Humans have an ability to infer meaning, or to “know it when I see it,” into statements. Such inferences are difficult to quantify at a level necessary for machine execution of the same operation and, in the prior art, not possible. In one embodiment, in a first step, a user's instruction is received by a computer, the instruction being to locate a target source code. Like all human conversation, the user's instruction may comprise various degrees of context—whether or not the user is aware of such context. For example, the user may issue instructions such as, “show me line 450,000 of the code.” Such an instruction, when presented to a suitably configured machine, may require a lower reliance on context, assuming the meaning of “the code” and “show me” are known to the machine. The machine may assume “the code” is a source-code file currently being presented to a user on a display and that counting line feed, carriage control, characters, or similar methodology may accurately determine which line of code is at the target line. More likely, only “450000” is input into a search field and the other parameters are determined from the context (e.g., the source code presently being displayed, the search field being known to be associated with line numbers, etc.).

The machine may then present, highlight, or otherwise indicate to the user the target line of code in compliance with the user's instruction to “show me.” Of course, if the particular code that is determined to be the subject of the request is found to comprise fewer than 450,000 lines of code, or the subject “the code” could not be determined with a suitable degree of certainty, the machine may be configured to respond accordingly, such as, “I'm sorry, Dave. I'm afraid I can't do that. The current file only has 23,599 lines of code.” Or, “The current file does not have that many lines of code, but here is line 450,000 of the linked file ‘bigFile.c.’ Is this what you wanted?” Or, “This file does not have than many lines of code, which file did you mean?”

In another embodiment, the first step may rely more on context, which the machine may acquire in real-time, in advance of receiving the instructions, or a combination thereof. For example, the user's instruction may be, “show me where interest rates are calculated.” A human, such as a programmer, may not know where a particular operation occurs in a source code, which could be substantial in size. Additionally, terminology differences may make text-based searches unsuccessful or unusable. For example, searching for “interest” may reveal no matches but if the source code utilized “i” for interest rate, and one knew to search for “i,” the results may be too numerous to be of any use.

In this example there is no tag or other label indicating that “interest rates are calculated” at a certain point in the source code. The machine must parse the instruction and acquire knowledge to ascertain what is being requested and how to comply with the request. The “show me” portion of the request may be relatively straightforward and the machine may readily determine that the user is requesting “something” to be presented to the user in a default or configured manner.

The machine may have, or have access to, knowledge of a domain, such as one or more source code files that are the subject of the instruction. The machine may also learn what is commonly meant by certain terms. For example, if the user previously issued a search request and the machine began traversing the Internet to respond to the search request, the user may instruct the machine to confine the request to a particular file, set of files, source of files, or other constraint. The machine may then utilize this information to limit the domain of future operations unless instructed otherwise. The machine, upon determining the domain is over a certain volume of sources, such as files or other sources (e.g., links to other sources), may request or suggest clarification from the user. For example, a machine may respond with, “interest rates are calculated in over five hundred locations based on account type and location. Do you want to see all of them?”

Alternatively, a domain may be assumed, and the machine may execute the instructions and then ask if the domain should be expanded. Additionally, or alternatively, the domain may be clarified. For example, a machine may respond: “There are many locations where interest rates are calculated. The calculations depend on product type. Would you like to see the interest rates for a particular product type or would you like to see a listing of the product types?” Prior history may also indicate domain. For example, “There are many locations where interest rates are calculated. Here are the interest-rate calculations for the mortgage code you recently reviewed.”

The human, if not content with the response, may then select and/or refine the domain to more accurately reflect a current target. This may be applied to cause the domain to be expanded or altered for this particular operation and/or future operations. In another option, the output of a program may comprise related text, such as the term “interest rate” and conclude that “where interest rates are calculated” may be answered by locating where the output value for a field associated with the label “interest rate” is determined.

With a domain determined, the machine continues. In one embodiment, the machine may attempt to parse the instruction as a literal request, similar to displaying a particular line number or other tag (e.g., “Show me ‘InterestCal.lib’”). If no identifier, such as a tag or label is found, additional analysis may be performed. Metaphorically, the machine may be thought of as asking itself: “Do I know what ‘interest rates are calculated’ means?” The machine may determine that if the question of “where are” (or similar phrasing) implies the answer sought will be a location of code within the domain of code files, and, therefore, successfully responding to the instruction will comprise the identification of a portion of the domain. The machine may be configured to answer the question, such as by stating: “The interest rates are calculated in the cal_i.lib file from line 3,250 through line 22,795,” and/or causing the target to be presented to the user and/or solicit refinement instructions from the user.

Continuing the example, the machine determines whether a terminology, such as “show me where interest rates are calculated,” is equivalent to “show me where” and being directed to the presentation of the instruction portion of the source code, and not the result itself, such as in a statement for a particular bank customer. The parsing may comprise looking at the individual words of the remaining instruction (i.e., “interest,” “rates,” “are,” and “calculated”) and/or multi-word combinations (i.e., “interest rates,” “rates are,” “are calculated,” interest rates are,” “rates are calculated,” and “interest rates are calculated”) and determine if any one or more of the words or word forms (e.g., “rate” instead of “rates”) have known equivalents (e.g., “period interest” instead of “interest” or “interest rates”). Accordingly, in one embodiment, an n-gram of words comprising the instruction may be evaluated to determine a match with a particular DOB, as will be discussed in more detail with respect to certain embodiments herein.

In one embodiment, the machine may “know” that “periodic interest” is equivalent to “interest rates” based upon a prior association, such as may be maintained in a database entry or other record associating the terms as being equivalent. However, the machine may also determine equivalence based on identifying an output to a user that has a field captioned with “interest rate.” The machine may determine that the field being output is determined by a variable “X” and that the value for “X” is set at a particular location. As a result, the machine has the location and may then reply to the instruction by presenting code at the location. Equivalence may be literal (e.g., character-for-character string comparison), near literal (e.g., literal but with variations for word form, word or phrase equivalence, misspellings, grammar, idioms, omission of non-essential words, coding symbols, etc.), and/or equivalent as having a similar meaning. Equivalence may be within an acceptable likelihood. For example, the machine may determine a requested “interest” is equivalent, within a 65% margin of error, to a found module, variable, field, etc. labeled as “periodic interest rate value.” Assuming the acceptability threshold of no more than 65%, the machine may consider the terms as equivalent.

In another embodiment, knowing that the value of a source code is ultimately in an output may provide one source of a value. For example, an output value may have an associated descriptor, such as the label, “interest rate,” and the code that determines value of the output may then be utilized as code when a request is made, such as, “show me the interest rate code.”

Understanding, as known in the human mind, is a concept difficult to implement on a machine, such as a computer system. While we may refer to computers as “knowing” certain things, such as how to perform mathematical operations, what is often described is more of an ability. Human cognition is a different thing, which is particularly difficult to quantify. However, similar results may be achieved by a properly configured machine to provide, to a human observer, the effect of machine-based cognition.

Computer systems serve as a representation of human intentions for a computing device and may operate on three levels of understanding: the “concept” level is the human abstraction often utilized to express a business or other objective (e.g., “a banking system,” “a deposit operation for an account,” etc.). Concept-level computer systems are language and system agnostic. Even when language and system are provided, they merely serve as a reference. For example, a human discussing, “a banking system in COBOL using DB2,” is as tangible to a human as “a banking system.” The differences may occur at other levels as well.

As used herein, the term “concept” (and similar word forms and phrases) refers to a high-level human-centric notion or description related to the machine's purpose.

In one embodiment, a method for improving source code maintenance by identifying a target source code portion having a behavior from a source code is disclosed, comprising: accessing an indicia of the behavior, the behavior comprising a result of an execution of a multi-step computer operation; accessing a first source code, wherein the first source code when converted to machine-readable instructions, comprises the multi-step computer operation, the first source code further comprising a plurality of functional structures, each functional structure performing a logical computing function comprising at least one functional element; deriving, from the first source code, a first dependency ordered behavior (DOB) associated with a plurality of the functional elements independent of their respective functional structures and identifying an execution path utilized to produce the behavior; and storing the plurality of functional elements in a non-transitory media to allow for more efficient maintenance of the first source code.

In another embodiment, a method for improving source code maintenance by identifying a target source code portion having a behavior from a source code is disclosed, comprising: accessing an indicia of the behavior, the behavior comprising a result of an execution of a multi-step computer operation and wherein the result defines a node of an operation in the source code and further defining a cone-of-influence comprising only nodes in the source code reachable by the node to produce the result; accessing a first source code, wherein the first source code when converted to machine-readable instructions, comprises the multi-step computer operation, the first source code further comprising a plurality of functional structures, each functional structure performing a logical computing function comprising at least one functional element; deriving, from the first source code, a first dependency ordered behavior (DOB) associated with a plurality of the functional elements independent of their respective functional structures and identifying an execution path utilized to produce the behavior; and storing the plurality of functional elements in a non-transitory media to allow for more efficient maintenance of the first source code.

In another embodiment, a system is disclosed, comprising: a processor; and a data storage; and wherein the processor: accesses, from the data storage, an indicia of the behavior, the behavior comprising a result of an execution of a multi-step computer operation; accesses, from the data storage, a first source code, wherein the first source code when converted to machine-readable instructions, comprises the multi-step computer operation, the first source code further comprising a plurality of functional structures, each functional structure performing a logical computing function comprising at least one functional element; derives, from the first source code, a first dependency ordered behavior (DOB) associated with a plurality of the functional elements independent of their respective functional structures and identifying an execution path utilized to produce the behavior; and storing, in the data storage, the plurality of functional elements in a non-transitory media to allow for more efficient maintenance of the first source code.

In another embodiment, a system is disclosed, comprising: means for accessing an indicia of the behavior, the behavior comprising a result of an execution of a multi-step computer operation; means for accessing a first source code, wherein the first source code when converted to machine-readable instructions, comprises the multi-step computer operation, the first source code further comprising a plurality of functional structures, each functional structure performing a logical computing function comprising at least one functional element; means for deriving, from the first source code, a first dependency ordered behavior (DOB) associated with a plurality of the functional elements independent of their respective functional structures and identifying an execution path utilized to produce the behavior; and means for storing the plurality of functional elements in a non-transitory media to allow for more efficient maintenance of the first source code.

In a further embodiment, the execution path is one of a plurality of execution paths.

In a further embodiment, deriving the first DOB comprises searching the first source code for an output having an associated human-readable description of the output associated with the behavior.

In a further embodiment, the description of the output associated with the behavior comprises a use-case.

In a further embodiment, the human-readable description of the output is associated with the behavior when the human-readable description is descriptively equivalent to the indicia of the behavior.

In a further embodiment, descriptively equivalent comprises differences between the human-readable description and the indicia of the behavior being synonyms.

In a further embodiment, deriving the first DOB further comprises: deriving an abstract syntax tree (AST) from the source code; deriving a control-flow graph (CFG) from the AST; and deriving a single-static-assignment control-flow graph (SSA-CFG) from the CFG; and wherein the first DOB is derived from the SSA-CFG.

In a further embodiment, deriving the control-flow graph (CFG) from the AST further comprises: deriving an inlined-AST from the AST; and deriving the control-flow graph (CFG) from the inlined-AST.

In a further embodiment, deriving a first DOB further comprises: slicing a source code DOB into sub-DOBs indexed according to their specific and unique data-dependency inheritance.

In a further embodiment, associating with each sub-DOB a unique Concept-Formula identifying the unique statement that generates the inheritance and a unique direction for this inheritance (forward or backward).

In a further embodiment, selecting a second source code, wherein the selection of the second source code is performed based upon the second source code having an associated second DOB and the second DOB being equivalent to the first DOB; and replacing the first source code with the second source code.

In a further embodiment, accessing the stored functional elements for presentation on a display.

In a further embodiment, recursively performing at least once: accessing the indicia of a sub-behavior, the sub-behavior comprising one result of an execution of the plurality of functional elements; accessing a second source code, wherein the second source code when converted to machine-readable instructions, comprises the multi-step computer operation, the second source code further comprising a second plurality of functional structures, each functional structure performing a logical computing function comprising at least one functional element; deriving, from the second source code, a second dependency ordered behavior (DOB) associated with the second plurality of the functional elements independent of their respective functional structures and identifying a second execution path utilized to produce the sub-behavior; and storing the second plurality of functional elements in a non-transitory media.

In a further embodiment, wherein the second source code comprises the first source code.

In a further embodiment, wherein the behavior is an anticipated behavior received as a query.

In a further embodiment, wherein the query further comprises a logical combination of a plurality of queries, each of the plurality of queries being operands in the query.

In a further embodiment: accessing a plurality of candidate source codes; deriving, from ones of the plurality of candidate source codes, an associated and corresponding plurality of candidate DOBs; deriving a query DOB associated with anticipated behavior; and upon determining one of the plurality of candidate DOB s is functionally equivalent to the query DOB, selecting the corresponding one of the candidate source codes as the first source code.

In a further embodiment: accessing a plurality of candidate source codes; deriving, from ones of the plurality of candidate source codes, an associated and corresponding plurality of candidate DOBs; deriving a DOB, resulting from a set operation (union, intersection, and/or complementation) over the plurality of candidate DOBs, that is associated with anticipated behavior; and associating the corresponding first source code to that behavior, and describing that behavior as a logical operation (or, and, not) over the behaviors corresponding to the candidate DOBs.

In a further embodiment, the data storage comprises at least one of: an on-chip memory within the processor, a register of the processor, an on-board memory co-located on a processing board with the processor; a memory accessible to the processor via a bus; a magnetic media; an optical media; a solid-state media; an input-output buffer; a memory of an input-output component in communication with the processor; a network communication buffer; and a networked component in communication with the processor via a network interface.

The phrase “execution path” refers to the specific instructions, in a set of instructions utilized to produce a particular behavior, output, or result.

The phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known to as “the cloud,” but may include a public, private, dedicated, shared and/or other service bureau, computing service, and/or “server farm.”

The terms “determine,” “calculate,” “compute,” and variations thereof, as used herein, are used interchangeably and include any type of methodology, process, mathematical operation, or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process in accordance with embodiments of the present disclosure;

FIG. 3 depicts another process in accordance with embodiments of the present disclosure;

FIG. 4 depicts another process in accordance with embodiments of the present disclosure;

FIG. 5 depicts another process in accordance with embodiments of the present disclosure;

FIG. 6 depicts another process in accordance with embodiments of the present disclosure;

FIG. 7 depicts an implementation in accordance with embodiments of the present disclosure;

FIG. 8 depicts another implementation in accordance with embodiments of the present disclosure;

FIG. 9 depicts another process in accordance with embodiments of the present disclosure;

FIG. 10 depicts another process in accordance with embodiments of the present disclosure;

FIG. 11 depicts a subprocess of DOB normalization in accordance with embodiments of the present disclosure;

FIG. 12 depicts a subprocess of BHK Mapping in accordance with embodiments of the present disclosure;

FIG. 13 depicts a concept-to-formula mapping in accordance with embodiments of the present disclosure;

FIG. 14 depicts a concept-to-concept mapping in accordance with embodiments of the present disclosure;

FIG. 15 depicts a DOB-to-DOB mapping in accordance with embodiments of the present disclosure;

FIG. 16 depicts a name-to-DOB mapping in accordance with embodiments of the present disclosure;

FIGS. 17A-B depicts another process in accordance with embodiments of the present disclosure;

FIG. 18 depicts a DOB union process in accordance with embodiments of the present disclosure;

FIG. 19 depicts an intersection process in accordance with embodiments of the present disclosure;

FIG. 20 depicts a complementation process in accordance with embodiments of the present disclosure;

FIG. 21 depicts another concept mapping in accordance with embodiments of the present disclosure;

FIG. 22 depicts the concept location and refactoring process in accordance with embodiments of the present disclosure;

FIG. 23 depicts another embodiment of the concept location and refactoring process in accordance with embodiments of the present disclosure;

FIG. 24 depicts another process in accordance with embodiments of the present disclosure;

FIG. 25 depicts another process in accordance with embodiments of the present disclosure;

FIG. 26 depicts an example source code in accordance with embodiments of the present disclosure;

FIG. 27A-B depicts a DOB in accordance with embodiments of the present disclosure;

FIG. 28A-B-C depicts an unrolled DOB in accordance with embodiments of the present disclosure;

FIG. 29A-B depicts one embodiment of an unrolled DOB in accordance with embodiments of the present disclosure;

FIG. 30A-B depicts another embodiment of an unrolled DOB in accordance with embodiments of the present disclosure;

FIG. 31 depicts a Venn diagram illustrating an implication expressed as a set inclusion in accordance with embodiments of the present disclosure;

FIG. 32A-B depicts an unrolled DOB in accordance with embodiments of the present disclosure;

FIG. 33 depicts example source code portions in accordance with embodiments of the present disclosure;

FIG. 34 depicts a refactoring in accordance with embodiments of the present disclosure;

FIG. 35 depicts smallExample source code after the refactoring operation in accordance with embodiments of the present disclosure;

FIGS. 36A-B depict an interaction in accordance with embodiments of the present disclosure;

FIG. 37 depicts a process flow in accordance with embodiments of the present disclosure;

FIG. 38 depicts a DOB slicing in accordance with embodiments of the present disclosure;

FIG. 39 depicts a high-level instruction parsing in accordance with embodiments of the present disclosure;

FIG. 40 depicts a more detailed instruction parsing in accordance with embodiments of the present disclosure;

FIG. 41 depicts a first process in accordance with embodiments of the present disclosure;

FIG. 42 depicts a second process in accordance with embodiments of the present disclosure;

FIG. 43 depicts a third process in accordance with embodiments of the present disclosure;

FIG. 44 depicts a DOB generation in accordance with embodiments of the present disclosure;

FIG. 45A-C depicts a DOB in accordance with embodiments of the present disclosure;

FIG. 46A-C depicts a DOB, with a first portion emphasized, in accordance with embodiments of the present disclosure;

FIG. 47A-C depicts a DOB, with a second portion emphasized, in accordance with embodiments of the present disclosure;

FIG. 48 depicts source code, with a first portion emphasized, in accordance with embodiments of the present disclosure; and

FIG. 49 depicts source code, with a second portion emphasized, in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a sub-element identifier when a sub-element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The term “microprocessor” and “processor,” as used herein, are synonymous and refer to an electronic device utilizing input signals, storing/retrieving data to/from an electronic memory, and provide output signals, the signals being encoded electrical signals. A processors may comprise one or more of a memory, such as a number of registers and/or on-chip storage for data and/or instructions, an arithmetic logic unit (ALU), internal communication bus, and/or external communication interface, such as to an external (to the processor) communication bus, thereby allowing the processor to communicate with other components co-located within a single system with the processor or, via a device connection, network interface, and/or other communication components, communicate with other devices and/or systems.

The terms “source code” and “code,” as used herein, are synonymous and refer to the human-readable form of a programming instruction prior to conversion, such as due to compiling or interpreting, into machine instructions for execution by a processor.

As a general overview, and in one embodiment, computer programming on existing source code comprises making the desired change at the correct location. Such a simplistic description pales in comparison to the monumental task of locating the target of the change in many real-world implementations, which may be in one or more of many files and/or lines of code. Then, making the change (e.g., add, remove, and/or amending) to produce the desired result or at least expected to produce the desired result. Oftentimes, a first task is to merely examine a particular portion of code. Finding a target source code may be as simple as executing a text search, or it can be exceedingly complex, such as looking for a particular and often conflicting or obfuscated, operation. Once found, a modification may be applied to the code identified, or as a pre and/or post-operation to the identified code. In large programs, such tasks are monumental and may result in the insertion of new errors or unexpected behaviors.

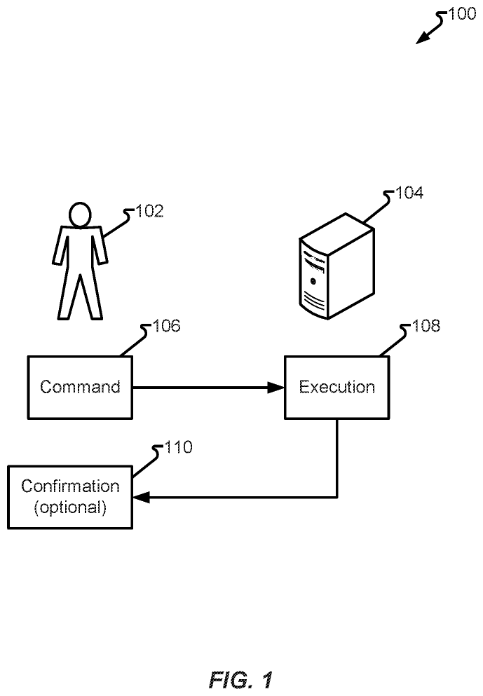

FIG. 1 depicts system 100 in accordance with embodiments of the present disclosure. In one embodiment, system 100 illustrates a subset of human-machine interaction components. Human 102 provides command 106 to computer 104 for execution 108 by computer 104. Optionally, computer 104 may provide feedback or confirmation 110 back to human 102. Computer 104 is one of many possible embodiments of a machine contemplated. Computer 104 may be a stand-alone device (e.g., desktop, laptop, smartphone, etc.), networked computer (e.g., terminal-server), component of a system (e.g., blade, processor on a multi-core processing system, server in a multi-server system, etc.), virtual machine (e.g., hardware executing software performing hardware-mimicking functionality), shared system (e.g., software as a service (SaaS), distributed system, “cloud” based computer, etc.), or other system operable to execute human issued commands.

Human 102 may execute command 106 via hardware (not shown), including but not limited to a keyboard, microphone, mouse, pointer, biometric input, and/or other human-machine input device. Human 102 may receive information from computer 104 via hardware (not shown), including but not limited to a printer, video display, haptic display, audio output, or other human-machine output device. As a result of execution 108 and/or confirmation 110, computer 104 may write data to a media file (e.g., database), device (e.g., optical, magnetic, or electronic media writer), other user (via a display or other component), or other system (e.g., message, indicator display), or other component operable to receive the output of computer 104. Computer 104 may be located remotely and human 102 and/or other components may utilize a computer network to interact with computer 104. Computer 104 may also be networked to one or more other devices via a local-area-network, wide-area-network, virtual-private-network, and/or other private or public networks, including but not limited to, the Internet.

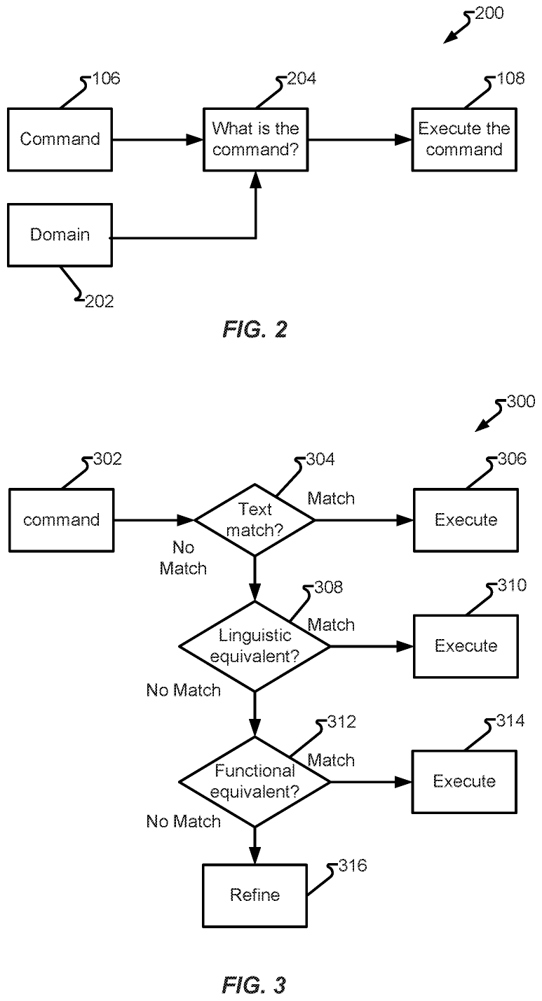

FIG. 2 depicts process 200 in accordance with embodiments of the present disclosure. Process 200 may be executed, at least in part, by an electronic processor(s) of computer 104. In one embodiment, command 106 is received. Step 204 identifies the command which may incorporate domain 202. Step 108 may then execute the command received at step 106.

Command 106, and determining the command in step 204, may comprise a spectrum of readily quantifiable commands (e.g., “Go to the next page.” “Show me line 1,000,” “Go to the output statement,” etc.) to highly nuanced commands (e.g., “This is not what I wanted.” “Where is the statement that performs ‘X?’” “Where is the bug?” etc.). Step 204 may utilize many types of analysis to determine what is required to comply with the command or, if unable to comply with the command, why compliance is not possible and what steps need to be executed in order to enable compliance. For example, linguistic equivalence may be determined from a parsing of command 106, such as to determine that “show me” is a request to display something. The meaning of the “something” may then exclude actions. Commands that may be executed, but for which there is nothing to display, may be eliminated from consideration. For example, sending a message, changing the setting of a device, operating a motor, etc., may be eliminated as the “something” wherein command 106 comprises “show me.” In contrast, if command 106 comprised an action request (e.g., get, set, do, etc.), then the pool of “something,” which can only be displayed, may be eliminated as the subject of command 106 as determined in step 204. Alternatively, words like “something” may be considered fillers and omitted from processing.

In other embodiments, command 106 may comprise a verb (e.g., an action to perform in step 108) that is initially unknown. Therefore, as described in more detail with respect to FIG. 3, the action portion of the command is determined.

FIG. 3 depicts process 300 in accordance with embodiments of the present disclosure. In one embodiment, command 302 is received, such as by computer 104. The action to perform is initially unknown. Step 304 may determine if command 302 has a textual match to a known command. Commands such as “search,” “print,” and “go to,” may be reserved words or other commands known to computer 104. If a match is performed at step 304, step 306 may then execute the command. Command 302 may not take an argument. For example, “print” and “save,” in the domain of an application displaying a file, may not require any additional parameters. Parameters that are needed, but absent, may be prompted in step 306 (e.g., “What would you like to search for?”) and process 300 may be re-executed with the addition of the parameter.

If step 304 is determined as not having a text match, step 308 may determine if command 302 matches a linguistic equivalent. Step 308 may access a database or other data structure to determine whether command 308 is a match, or a match within a previously determined probability. For example, “find” may be associated with a list of known commands which includes “search.” Therefore, should command 302 comprise “find,” computer 104, upon step 308, may execute command 310 whereby a search is performed.

If step 308 fails to identify a match or identifies a match but below a previously determine probability, step 312 may determine if command 302 matches a known functional equivalent. For example, the command “find where the interest rate is calculated,” may be analyzed whereby “interest rate” is presented in a display and populated by the value “i r”. Therefore, computer 104 may determine, or determine with a previously determined probability, that command 302 is a request to be presented with where “i r” is calculated and, as a match, cause step 314 to execute whereby the identified portion of code is presented.

Should step 312 fail to determine a match, step 316 may seek a refinement of command 302. For example, as mentioned above, command 302 may be determined to have omitted a parameter, such as, “move the ‘account-balance’ module” may be a partial match to any one or more of steps 304, 308, and 312. However, a “move” command may comprise a target parameter, such as “account-balance,” and a destination parameter, which is absent. Accordingly, step 316 may then respond with, “Where should I move ‘account-balance’ module?” After which process 300 may be re-executed with the additional parameter. As described more completely below, it should be appreciated that additional, fewer, or alternative orderings of the steps of process 300 may be implemented without departing from the scope of the disclosure.

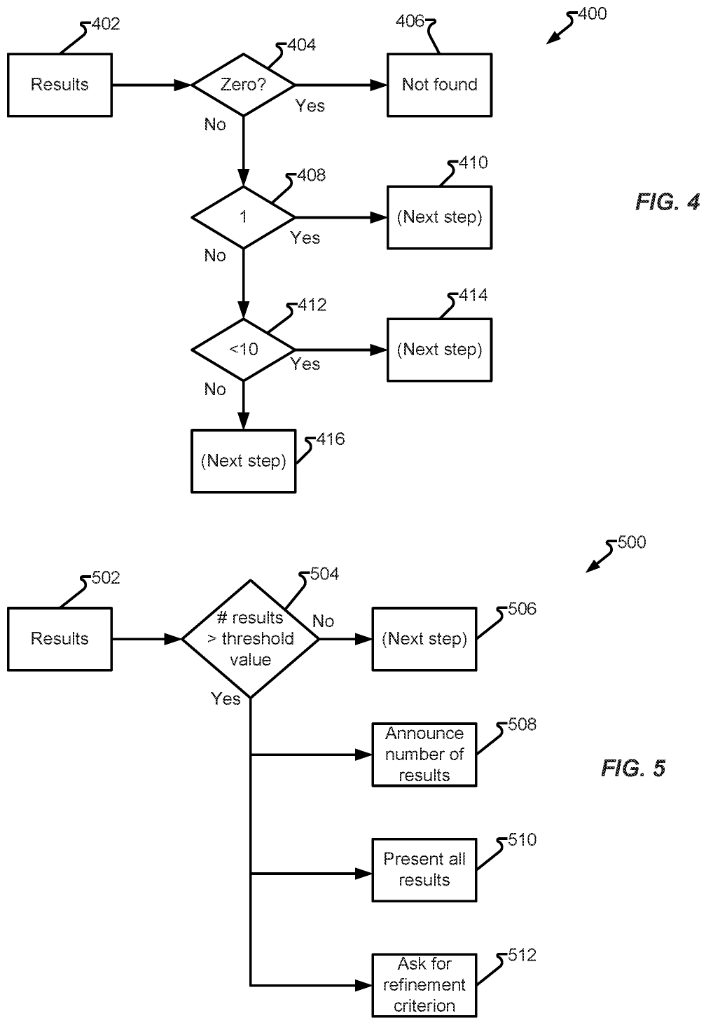

FIG. 4 depicts process 400 in accordance with embodiments of the present disclosure. In one embodiment, such as via execution of process 300 by computer 104, results 402 are identified. Often in human-human interactions, the answer set is constrained by inference to an identified, or unidentified, subset. For example, the question, “what would you like to eat?” may be limited to items on a menu, items presented, options available at a particular area or time of day, or other factors associated with inferred or realistic options. Unrestrained compliance in providing an answer would cause every food item desired to be identified. Computer 104, when provided with command 302, may identify results 402 that are unrealistic, as determined by a previously determined threshold limitation.

In one embodiment, results 402 comprise a set of results. Step 404 determines if the result is zero. If step 404 is determined in the affirmative, step 406 may respond with the indication of an empty set of results 402. For example, “I cannot find . . . ” “I am unable to . . . ” etc.). Step 406 may recommend, solicit, and/or accept refinements or alternatives as a new or modified command 302 whereby process 400 may be re-executed.

If step 404 is determined in the negative, step 408 may determine if the size of the set of results 402 is one and if so, execute step 410 which may be to execute the command, such as performing the operation, providing a result, etc. If step 408 is determined in the negative, an additional criterion, such as step 412 may be executed to determine if the size of set of results 402 is above a subsequent threshold. For example, command 302 may be a request to compile all source code files that use a particular function. In order to avoid unexpected results, computer 104 may have determined that a set of results above a previously determined threshold of, for example, ten, requires confirmation. If, for example, thousands of files utilize the function, the user may be asked to confirm whether that is truly the intention, such that the user is not caught off guard when computer 103 is engaged in compiling tasks for many hours. Alternatively, command 302 may be refined and, thereby, results 402 modified. For example, only those files that utilize the particular function and have not been recompiled within a certain time period may be a more acceptable command and, as a benefit, reduce the size of results 402 to a manageable result set. In another embodiment, certain actions may utilize one or more thresholds, such as step 412, as a safeguard against unintended actions. For example, “delete ‘source_code.c’” may return more than one result, such as when similar file names are used in multiple directories. Accordingly, step 412 may determine that two files returned in results 402 requires step 414 asking for confirmation of whether each file, or one or more particular files, should be deleted and proceeding accordingly. Step 412 may be a dynamic of static limit that, if results exceed the limit, step 416 is executed, which may seek to narrow the scope, present indicia of the number of results, alter the domain, and/or seek confirmation before presenting a large number of results.

FIG. 5 depicts process 500 in accordance with embodiments of the present disclosure. In one embodiment, process 500 provides an additional or alternative to process 400. Step 502 receives a set of results. Step 504 determines if the number of results is greater than a threshold. If determined in the negative, step 506 is executed. Step 506 may be to comply with the command that seeded results 502 or other action. If step 504 is determined in the affirmative, one or more additional steps may be provided. In one embodiment, step 508 announces the number of results. For example, step 508 may respond with: “four instances of ‘i_r’ have been renamed ‘daily_int_rate’” “no files named ‘the_bug_is_here.c’ have been found” etc. In another embodiment, step 510 presents (or performs) all expected results. And, in another embodiment, step 512 asks for a refinement. For example, whether a search returning ten thousand results should be displayed it its entirety or whether a subset should be selected, such as, “there are over ten thousand results found in this project. Twenty-three instances have been found in the file you most recently viewed.”

It should be appreciated that the value of the threshold in step 504 may be determined for specific actions, commands, results, or other factors. Additionally, any two or more of steps 508, 510, and 512 may be performed automatically based upon a recursive implementation of process 500. Continuing the example above, steps 508, 510, and 512 may be performed, such as to have step 510 display the twenty-three instances of a search, as a result of a recursive execution of process 500, while step 508 announces “here are the twenty-three results from the file you were recently viewing, there are over ten thousand instances in this project,” and step 512 asks, “do you want to see additional instances from the project?” or other refinement. The refinement is variously embodied and may comprise a user reforming a command that produced results 502, a response to a structured query (e.g., “twenty-three instances in file ‘a.pas’, three instances in the file ‘b.pas’, . . . , which would you like to see?”), a response to a general query (e.g., “How many should I display?”), or other refinement input whether provided in response to a prompt or sua sponte.

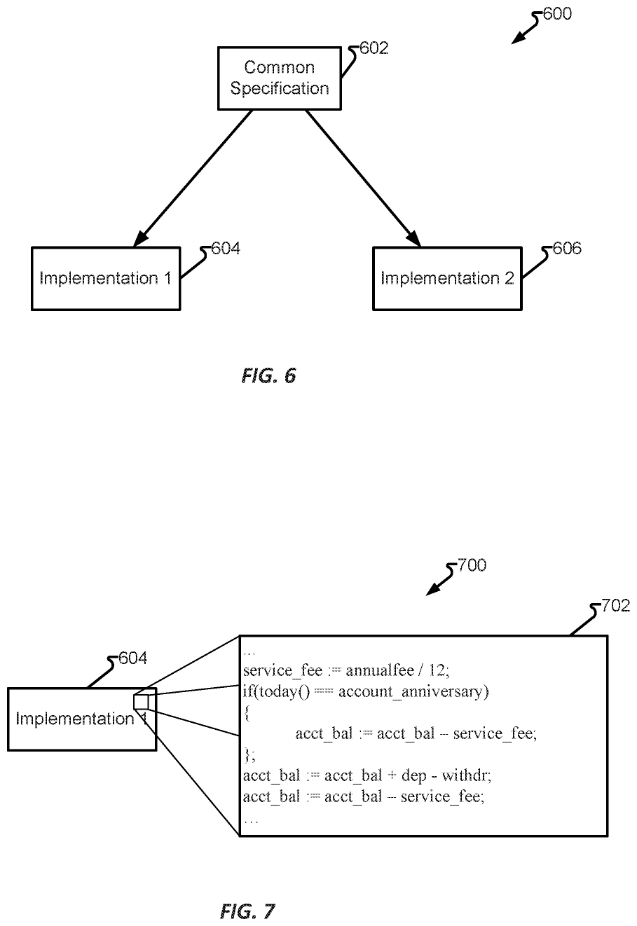

FIG. 6 depicts process 600 in accordance with embodiments of the present disclosure. In one embodiment, specification 602 is implemented as implementation 604 and implementation 606. It should be appreciated than more than two implementations may be utilized without departing from the scope of the disclosure.

Specification 602 comprises a description of what implementations 604, 606 perform. Specification 602 may represent a formalized statement of an intention for implementations 604 and 606. For example, a business intention may be a functional description devoid of operations, such as, a banking system, a loan intake system, etc. In compliance with the business intention, specification 602 describing computer and computer-interface operations is derived. For example, specification 602 may specify that account balance=account_balance+deposits−withdrawals−fees. One implementation, such as implementation 604, may be provided in the programming language C, which defines account_balance as a “double” (double precession floating point) and the instructions to calculate the account_balance. Implementation 606, for example, may be performed in COBOL and define account_balance as “PIC 9(18)” (picture clause, of type 9 (number) with a length of 18). Other differences where implementations 604 and 606 differ in terms of programming language are omitted here for the sake of brevity.

In another embodiment, a difference between implementation 604 and implementation 606 may be functional. For example, specification 602 may be a complete banking system, implementation 604 a mortgage portion, and implementation 606 a savings and checking implementation. Accordingly, implementations 604 and 606 may differ in their entirety, partially, or be identical.

In another embodiment, even if unintentional, an error is provided in at least one of specification 602, implementation 604, or implementation 606.

FIGS. 7-9 illustrate one embodiment of a modification to implementation 604 and automatically, and without requiring human input, extending the modification to implementation 606. FIG. 7 depicts implementation 700 in accordance with embodiments of the present disclosure. In one embodiment, implementation 604 comprises source code 702.

FIG. 8 depicts implementation 800 in accordance with embodiments of the present disclosure. In one embodiment, implementation 604 comprises source code 802. Source code 802 further comprises a modified version of source code 702.

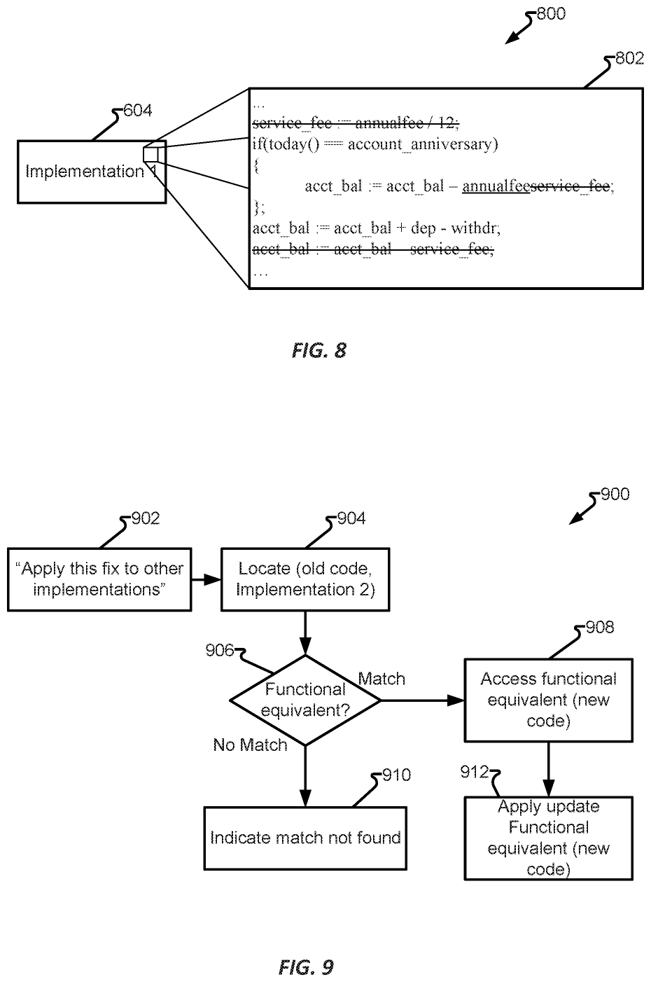

FIG. 9 depicts process 900 in accordance with embodiments of the present disclosure. In one embodiment, step 902 receives a signal to apply the modification applied to source code 702 to cause it to become source code 802 to other implementations (e.g., implementation 606). Step 902 may be initiated via a human input or automatically, such as when computer 104 determines that a modification has been made and/or validated to source code 702 and source code 702 is not the entirety of implementations of the specification that produced source code 702.

If not already identified, step 904 identifies another implementation. Step 904 may comprise selecting the entirety of a source code library for an institution for searching. In another embodiment, step 904 eliminates source code sources that are known to be devoid of the implementation and/or select source code sources that are known or suspected to comprise the implementation. Candidate source code implementations are evaluated and, at step 906, determined as to whether or not a particular source code implementation is a functional equivalent to the (unmodified) source code (i.e., source code 702).

If step 906 is determined to match, process 900 continues to step 908 whereby an associated functional equivalent source code is selected and applied in step 912 to cause the functional equivalent source code to be modified to be functionally equivalent to the (modified) source code (i.e., source code 802). If step 906 is determined to not be a match, process 900 may continue back to step 906 for a different candidate source code, terminate, and/or indicate that the current candidate source code did not match, such as in step 910.

With benefit of the embodiments disclosed, one source code file may be modified, and any alternative embodiments may be automatically modified in a functionally similar manner.

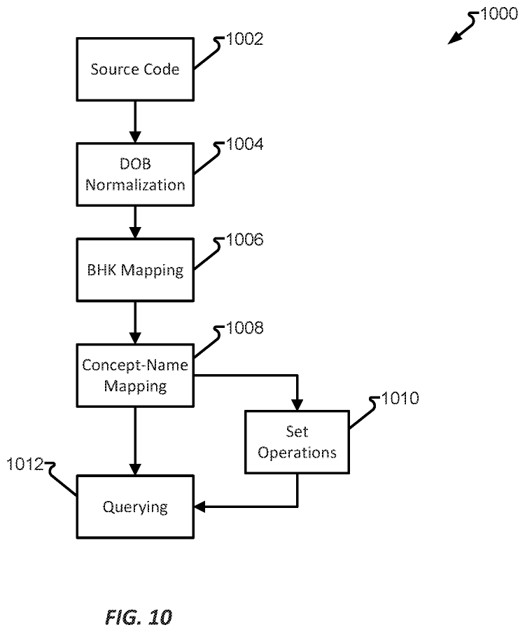

FIG. 10 depicts process 1000 in accordance with embodiments of the present disclosure. Embodiments herein utilize acronyms, including: Abstract Syntax Tree (AST), Control Flow Graph (CFG), and Single Static Assignment (SSA), which will be described more completely elsewhere herein. In one embodiment, process 1000 comprises step 1002 accessing the source code, step 1004 performing DOB normalization, step 1006 performing BHK mapping, step 1008 performing concept-name mapping and, following step 1008, each of step 1010 performing set operations and/or step 2012 performing querying. When step 1010 is performed, step 1012 may be performed following step 1010.

In another embodiment, process 100 is a “querying” process and establishes a mapping between the Concept-Names and Slices of the Source Code by means of the successive mappings presented above: Source Code to DOB (step 1002); DOB to Concept-Formulae (step 1004); Concept-Formulae to Concept-Names (step 1008), and optionally logical operators (step 1010).

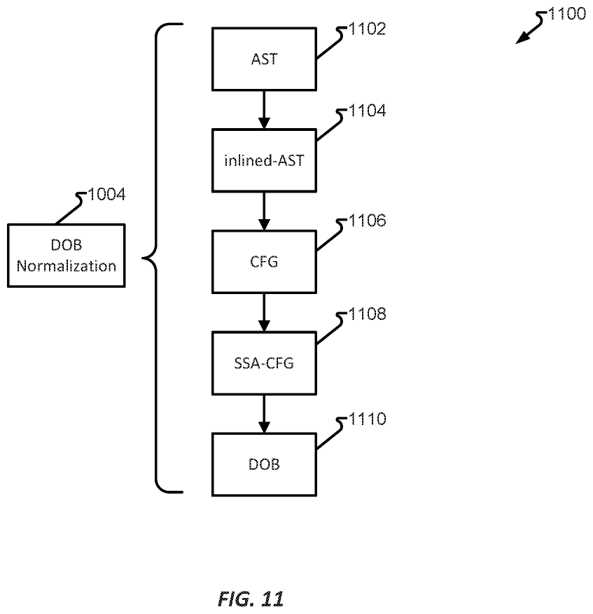

FIG. 11 depicts subprocess 1100 comprising step 1004 for DOB normalization in accordance with embodiments of the present disclosure. DOB normalization 1004 depicts a correspondence between the source code and the DOB. Therefore, a Concept-Formula also maps to a slice of code.

In one embodiment, process 1000 creates a DOB upon performing the steps of: accessing source code (or more simply, “source”) 1002, from source creating an AST at step 1002, from the AST creating an inlined-AST at step 1104, from the inlined-AST creating a CFG at step 1106, from the CFG creating a SSA-CFG at step 1108, and from the SSA-CFG creating a DOB at step 1110.

In another embodiment, step 1102 builds the AST from the source.

In another embodiment, step 1106 builds the control flow graph (CFG) from the AST.

In one embodiment, an AST is a representation known in the prior art and utilized by compilers. An AST is then “flattened” to an inlined-AST. In another embodiment, to capture the computational behavior of an entire application across multiple modules while being abstracted away from this structure, all functions and modules called within the main function of an application are inlined, creating a single Application Model DOB (DOBA). In one embodiment, inlining is a standard computer science technique where a called function's code is stored within the calling code, as if it were not a separate function. In another embodiment, a CFG as known in the prior art is created from the inlined AST. The CFG may unroll loops, remove unreachable code, and perform other optimizations and are often utilized as a middle state between a high-level human-written instruction and a lower-level machine code. A vertex in a CFG represents an elementary block that can be carried out. An edge represents jumps in the control flow between vertices. Next, and in another embodiment, an SSA is built from the CFG as is known in the prior art. An SSA is a representation utilized in certain theory and where every variable is assigned exactly once.

From the CFG, step 1108 transforms the CFG representation to include SSA variables. For example, if x is a variable that changes value, a conventional assignment would be: x=1; x=x+1. In SSA form, the values would instead be assigned as: x1=1; x1=x2=1. SSA is useful for simplifying and thus optimizing code at the compiler level. It is also useful for program analysis by removing all ambiguity regarding a variable's value; the state of the program has no effect on the values and thus results of any particular operation when variables are in SSA form.

In certain embodiments, SSA handles unpredictable variable assignments by employing ϕ (phi) function. A ϕ function takes, as input, all the possible values that might be assigned to a variable. The role of the ϕ function is to “choose” what value is assigned, and then to output that variable with a new assignment, thereby preserving SSA.

From the SSA CFG, step 1110 adds data dependency information and thereby creates the DOB.

Next, and in another embodiment, a DOB is created from the SSA. In one embodiment, data dependency information is combined with the SSA CFG. A data dependency edge exists if and only if v₁→_{d} v₂.

In another embodiment, a DOB specifies an abstract data type (ADT) for a computation. The ADT defines a mathematical model of the data objects that comprise a data type and the behavior of the functions that operate on the data objects. In another embodiment, a DOB comprises a partial order defined by dependency (both control flow and data flow). DOBs may be visualized as graph structures comprising edges illustrating dependencies of various types (e.g., control, data, and input-output). Data dependencies illustrate data flow, and input-output (I/O) illustrates data flow within the program and/or external to the program (e.g., read-writes).

Graph notation may be helpful in representing DOBs and ASTs. For example, given an application A, the corresponding DOB of A is a graph G_{A} whose vertices correspond to program statements and whose edges represent dependencies in A. That is, there is a directed edge between vertices v₁ and v₂ if there is a dependency between statements s₁ and s₂ (s₁ and s₂ are members of A). The notation vᵢ may be utilized for both (1) the statement sᵢ is a member of A and (2) the statement vertex vᵢ is a member of G_{A} to indicate that the vertices of the DOB map to the original statements of the application. The edges between vertices may be control type and/or data type. Vertices are variously embodied and comprise:

1. Declaration

2. Assignment

3. If-Else

4. While

5. ϕ_{1f}

6. ϕ_{While}

7. External function calls

DOB Control Flow Edges:

An edge v₁→_{c} v₂ represents that a control dependency will exist between vertices v₁ and v₂ if only one statement is true:

1. v₁ is a guard to an If-Else statement and v₂ is the first nested statement within the true or false blocks of that If-Else statement. Such an edge will be labeled either if-true or if-false depending on the path upon which v₂ sits.

2. v₁ is a guard to a While statement and v₂ is any nested statement within the loop body. All such edges may be identified as “while.”

1. If-true

2. If-false

3. While

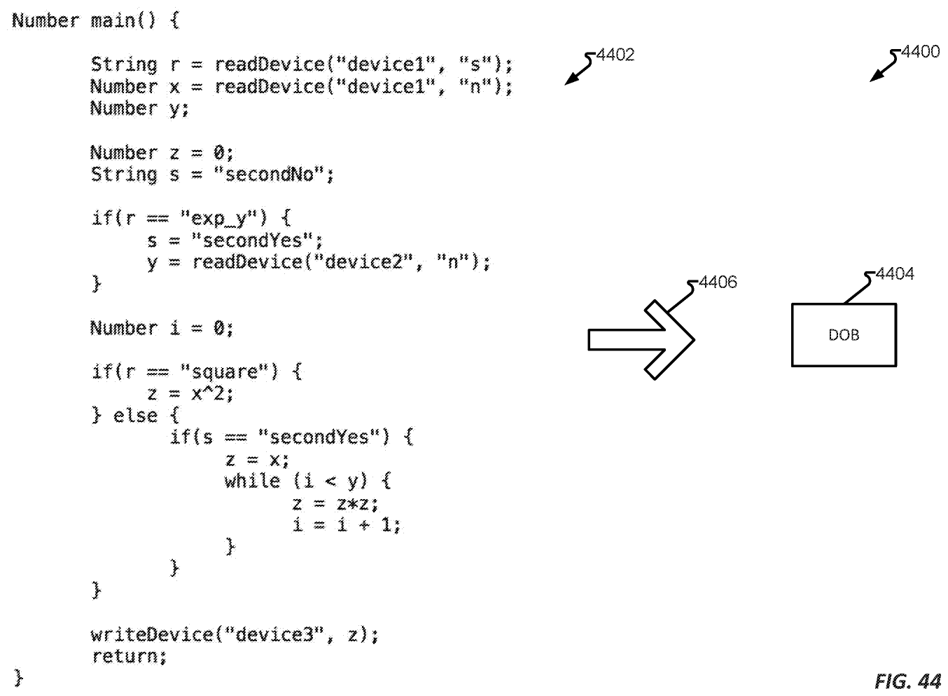

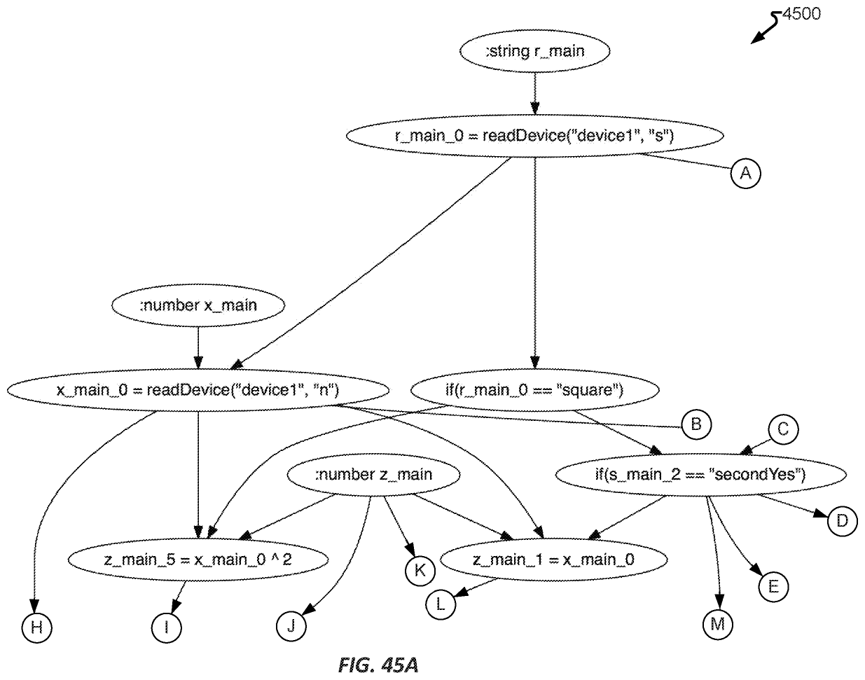

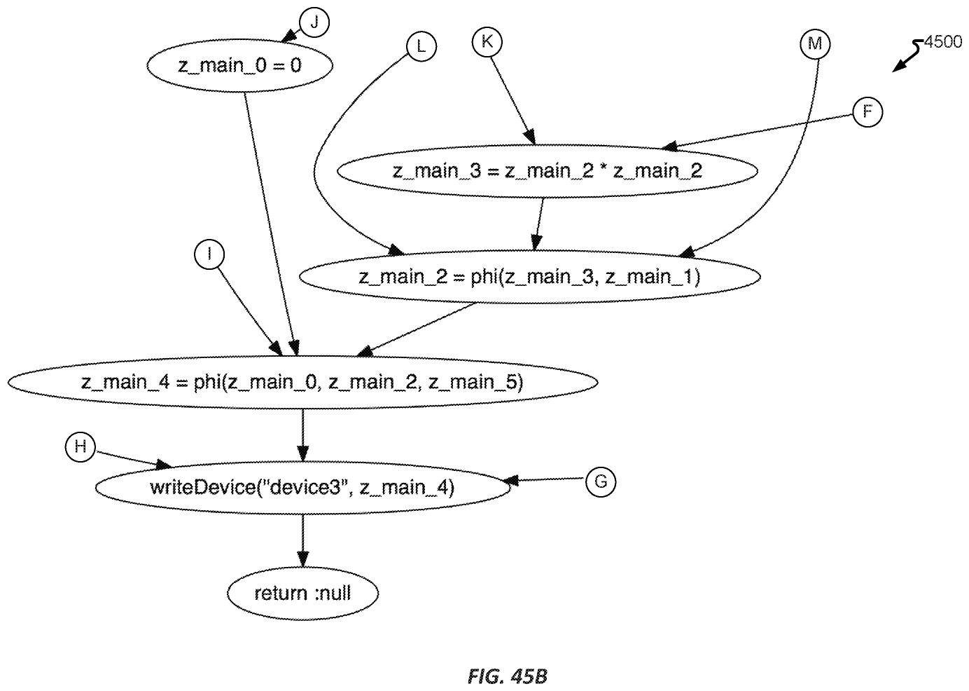

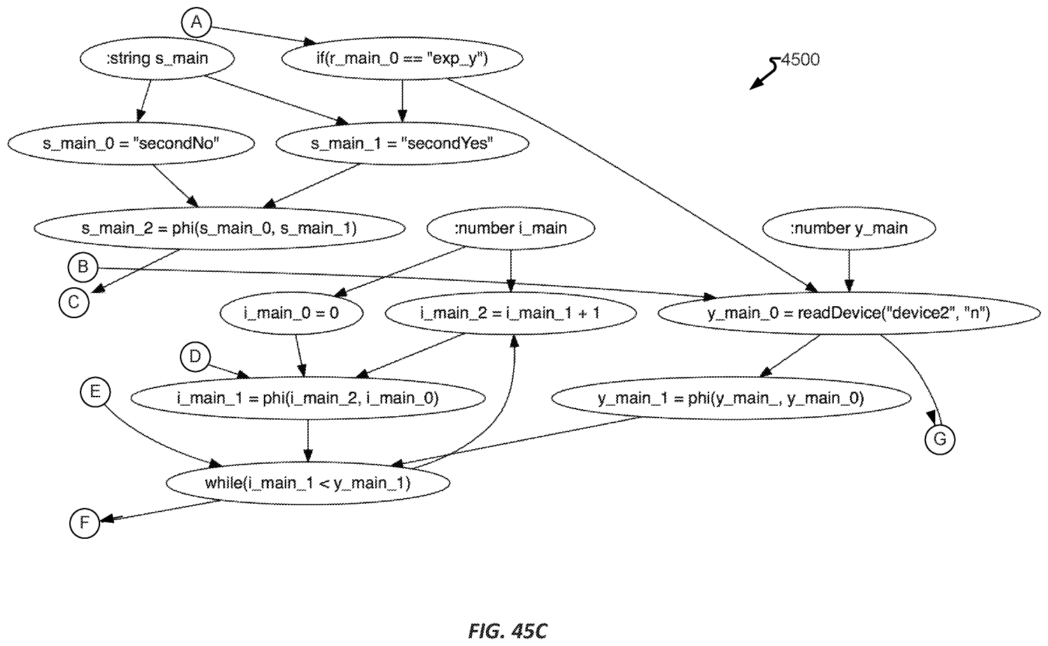

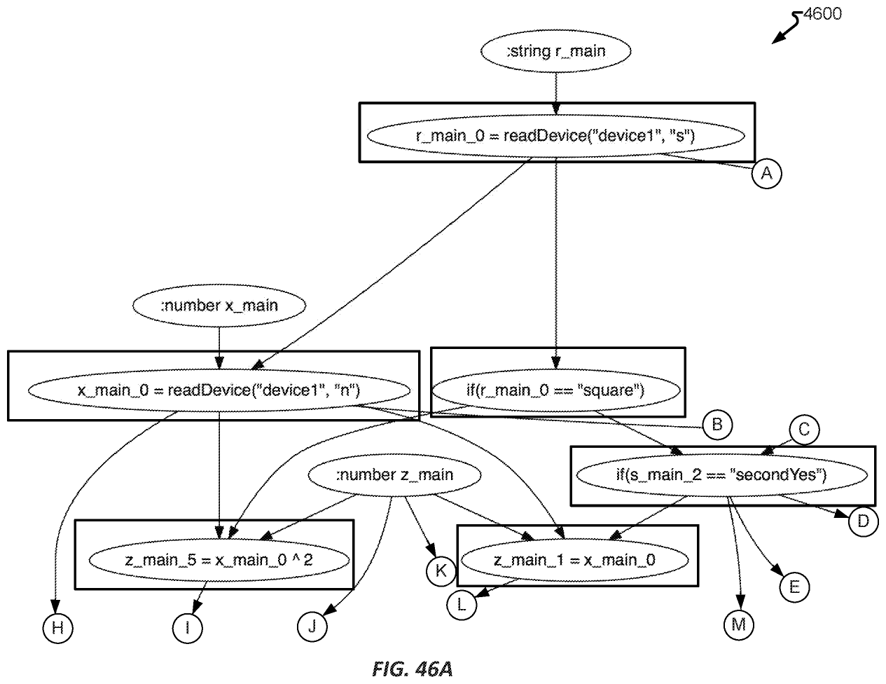

See, FIGS. 44 and 45 which illustrates an example source code and derived DOB, respectively.

DOB Data Flow Edges:

Statements whose edges represent dependencies in A. That is, there is a directed edge between vertices v₁ and v₂ if there is a dependency between statements s₁ and, s₂ (s₁ and s₂ are members of A). The notation v₁ may be utilized for both (1) the statement s₁ is a member of A and (2) the statement vertex v₁ is a member of GA to indicate that the vertices of the DOB to map to the original statements of the application. The edges between vertices may be control type and/or data type.

An edge v₁→_{d} v₂ represents a data dependency between statements v₁, v₂. Such an edge indicates that changing the relative ordering of v₁, v₂ might change the semantics of the application. There is an edge v₁→_{d} v₂ if and only if, there exists a direct definition and a usage (“def-use edge”) from v₁ to v₂ devoid of bypassing paths. For DOBs of While source, such edges can be labeled “declaration,” “data-flow,” or “data-flow-guard,” depending on the statement types of v₁ and v₂.

Next, and in another embodiment, a DOB is created from the SSA. In one embodiment, data dependency information is combined with the SSA CFG. A data dependency edge exists if and only if v₁→_{d} v₂. Vertices are variously embodied and comprise:

4. Declaration

5. Data-flow

6. Data-flow-guard.

Well-Formed DOB, Equality, and DOB Composition:

In another embodiment, a well-formed DOB is created at step 1110. A well-formed DOB satisfies three criteria: First, it must be functional in the sense that it is interpretable (executable); an interpretable connected subgraph is a well-formed DOB. A situation in which a DOB would not be executable would be using a constant as an argument for a DOB statement while never explicitly including it as an input to that DOB. That would result in breaking the functional nature of the DOB, rendering it uninterpretable and ill-formed.

Second, the interpreted DOB must have the equivalent behavior of the original source onto which it maps. If the DOB produces a different result than the source used to generate the DOB, then the DOB is not well-formed.

Third, the behavior of the DOB must be equivalent to the observations of a user of the original source. If a user can detect any functional or temporal behavior divergent from the source, then the DOB is not well-formed.

With all three criteria met, equality with respect to a DOB and the original source may be determined. Equality may be defined by behavior. A DOB and original source (or another DOB) are equal if for any given input (such as signatures or arguments), their outputs are equal. If the DOB and original source outputs are equal, then their behavior is equal, and the DOB and original source are equal by definition. Furthermore, the mathematically sophisticated reader will notice that this is the same equality defined for mathematical functions in general.

Similarly, DOB composition is defined as it is for any other function: Given two functions f(x), g(x) we can create a third function h(x) by first applying f to x and then applying g to the result f(x). That is, h(x)=g(f(x)). Using the notation of DOBs, given an input (or set of inputs) x, then DOB_{c}(x)=DOB_{b}(DOBₐ(x)).

DOB as an Abstract Data Type (ADT) and its Benefits:

In another embodiment, a DOB specifies an abstract data type (ADT) for a computation. The ADT defines a mathematical model of the data objects that comprise a data type and the behavior of the functions that operate on the data objects. In another embodiment, a DOB comprises a partial order defined by dependency (both control flow and data flow). DOBs may be visualized as graph structures comprising edges illustrating dependencies of various types (e.g., control, data, and input-output). Data dependencies illustrate data flow, and input-output (I/O) illustrates data flow within the program and/or external to the program (e.g., read-writes).

With the benefit of the DOB, two source code objects (e.g., programs, functions, etc.) may be determined to be equivalent as their DOBs, regardless of the original implementation, would be equivalent. As a further benefit, unnecessarily complex code may be identified and optionally replaced with simpler and/or more efficient code.

BHK Construction: Partial Ordering: Construction of a Cycle Free DOB (PoKn-DOB):

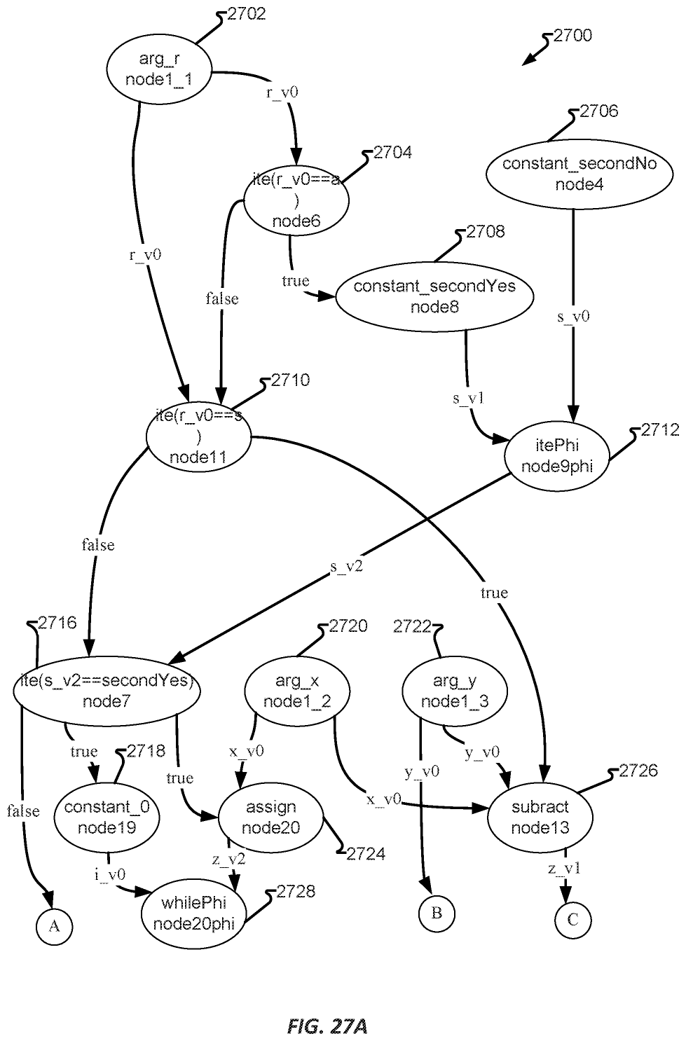

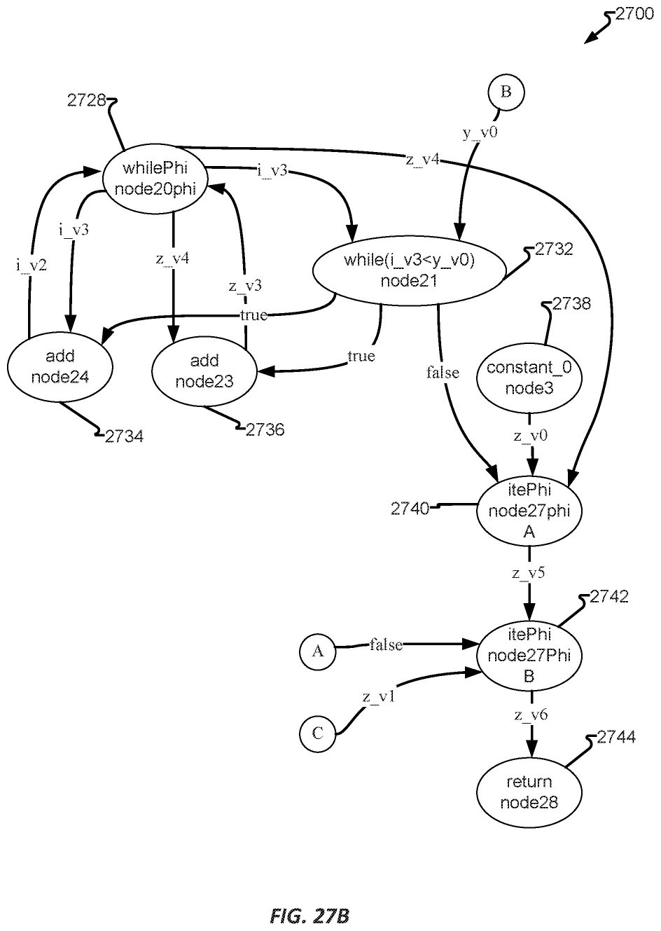

In one embodiment, cycle-free DOB 2800 is the output of DOB 2700 upon a processor executing non-transitory instructions to covert DOB 2700 into cycle-free 2800. Cycle-free 2800 removes loops, such as those illustrated by the up arrows (edges) between nodes 2734 and 2728 and 2736 and 2728 (See FIG. 27). As a result, cycle-free DOB 2800 always provides an answer, whereas DOB 2700 may be indeterminate as the number of cycles is unknown. In one embodiment, DOB 2700 is derived by the processes utilized to derive DOB 1110.

It is from the behavior perspective that loops and recursion become vexing problems. Witness the loop invariance challenge in proofs of correctness. From the specification perspective, iteration and recursion are finitely specified, usually as two cases: base specification and induction specification. The finite constraint on specification eliminates the difficulty: (1) For the “While” language because each instance of a while construction is unrolled once to assure that the both the base case and iteration block case are covered. This corresponds to covering the two sets of “stages of knowledge,” and (2) In languages that support recursion because an analogous approach is employed by reducing recursion to iteration.

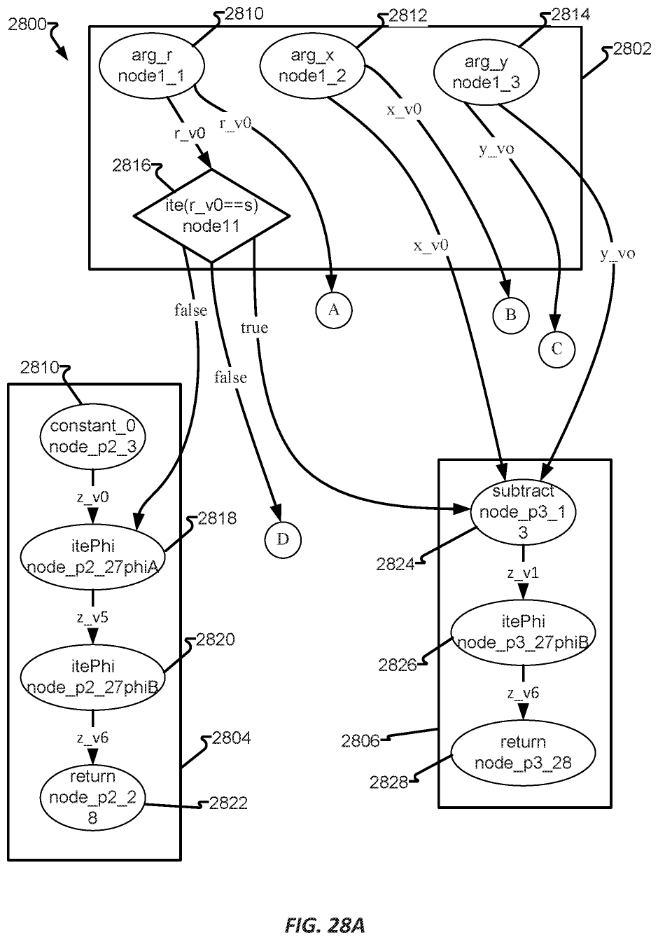

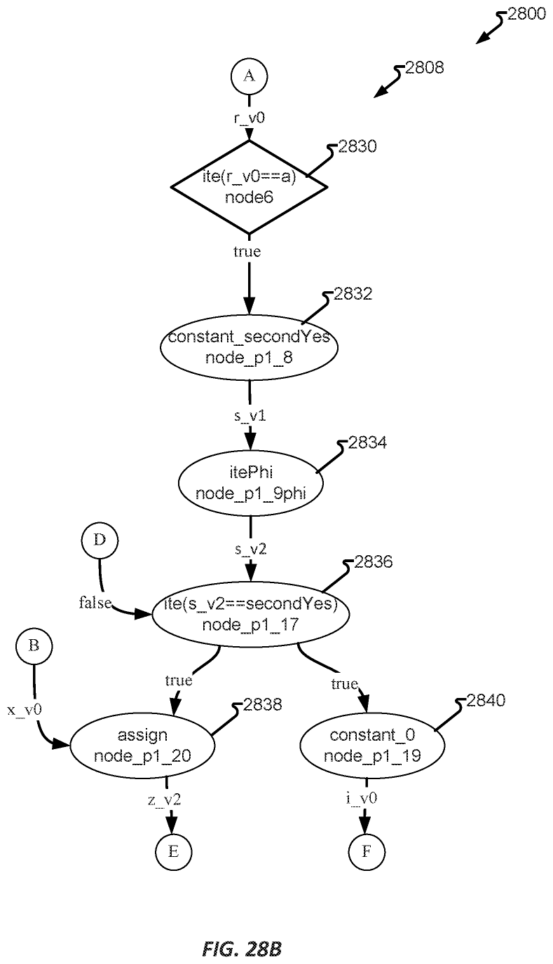

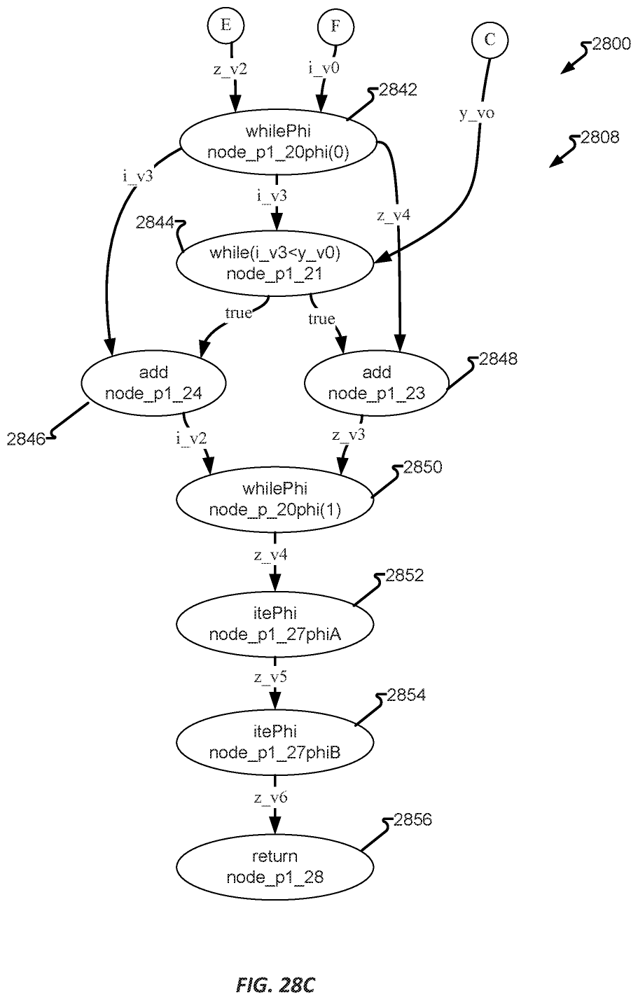

This results in a loop-free specification (or as a graph, a cycle-free graph). The unrolled structure of smallExample is illustrated in FIG. 28. We notice that node 20 can be reached from node 8 but not the other way around. It is so for every pair of nodes in PoKn-DOB.

Theoretical Background and Implications:

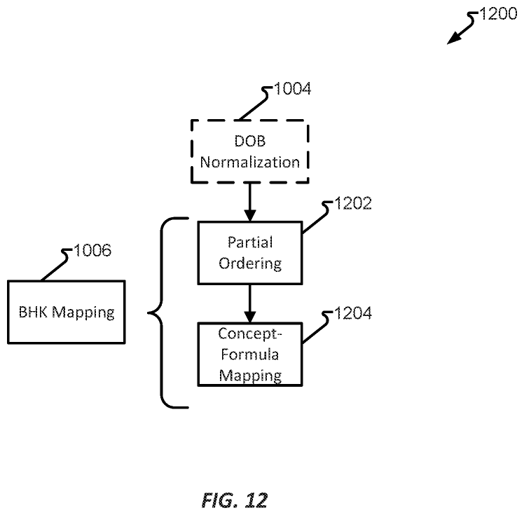

FIG. 12 depicts subprocess 1200 for BHK Mapping in accordance with embodiments of the present disclosure. Step 1006 (see FIG. 10) is known as “BHK” (after the intuitionist mathematical framework) in which a BHK Mapping is computed. In one embodiment, step 1006 comprises step 1202, known as “partial ordering,” and step 1204, known as “Concept-Formula mapping.”

Step 1202 formalizes the first DOB as a partial order under the successor operation. The resulting partial order is called a partially ordered knowledge-data ordered behavior (“PoKn-DOB”).

Central to constructivism and intuitionism is the notion of constructing knowledge as a process in a temporal sequence. Again, intuitively this seems consistent with applied computation, which creates data states through a process of program execution.

The application of Kripke modal logic semantics to intuitionism simplifies our mapping to applied computation and the DOB representation:

Each operation (viewed as a graph: vertex) corresponds to a stage or state of knowledge. Each such operation creates a value, corresponding to a static single assignment (SSA) versioned variable in step 1108.

The ordering of stages of knowledge is the dependency order, which is explicit in the DOB representation. When viewed as a graph, the ordering corresponds to the edges of the graph.

Conditional operations (e.g., If-Then-Else) create branches in the possible execution sequence of the states of knowledge. These branches correspond to branches in possible worlds.

It should be clear that this mapping can be seen in the DOB representation. As illustrated, the states of knowledge and possible world branches for smallExample (see, FIG. 27A-B). An “unrolling” of the addition loop, which is the topic of the next section and more fully described with respect to FIG. 28.

Formalisms that are applied to computational specifications often flounder or radically increase in complexity because of iteration (loops) or recursion. This is not the case here. In FIG. 28, formalization is applied to the DOB (e.g., DOB 2700, DOB from step 1110) from the perspective of specification of computational behavior, not from the perspective of evaluation of behavior. In other words, which computational elements are involved in determining a particular value, rather than what is the particular value.

Concept-Formula Mapping:

In one embodiment, step 1204 maps Concept-Formulae to Hereditary Sets in the PoKn-DOB.

The intuitive idea is that once knowledge is constructed, it remains immutably in existence for all subsequent time. In a BHK framework, the knowledge associated with a node p is always a subset of the knowledge associated with a subsequent node q (q being a successor of p). A hereditary DOB maps the knowledge (data state) associated with a node p to the DOB containing this knowledge. Such a DOB is easy to identify through a PoKn-DOB: it is the set of all the nodes that are the successors of p (p included) and we note it “p⬇”. Thus, we see why we have an ever “increasing” knowledge in a Hereditary DOB (HPoKn-DOB).

The “down arrow”, maps a node p in PoKn-DOB to the set of all its successors. We define its dual operator, “up arrow,” that maps a node p in PoKn-DOB to the set of all its predecessors, written “p⬆”.

The mapping is defined by a formula of the form “p⬇” (respectively “p⬆”) corresponding to the mathematical notion of Hereditary Set in PoKn-DOB (respectively in the transpose of PoKn-DOB). This formula is called “Concept-Formula” because it points at a unique slice of code (through a sub-DOB) corresponding to a certain concept.

A Concept-Formula is always associated with a unique statement: the one creating the relevant data state.

A Concept-Formula is either composed of an “up arrow” or a “down arrow”. In the first case, it is called an Up Concept-Formula, in the second case, a “Down Concept-Formula.”

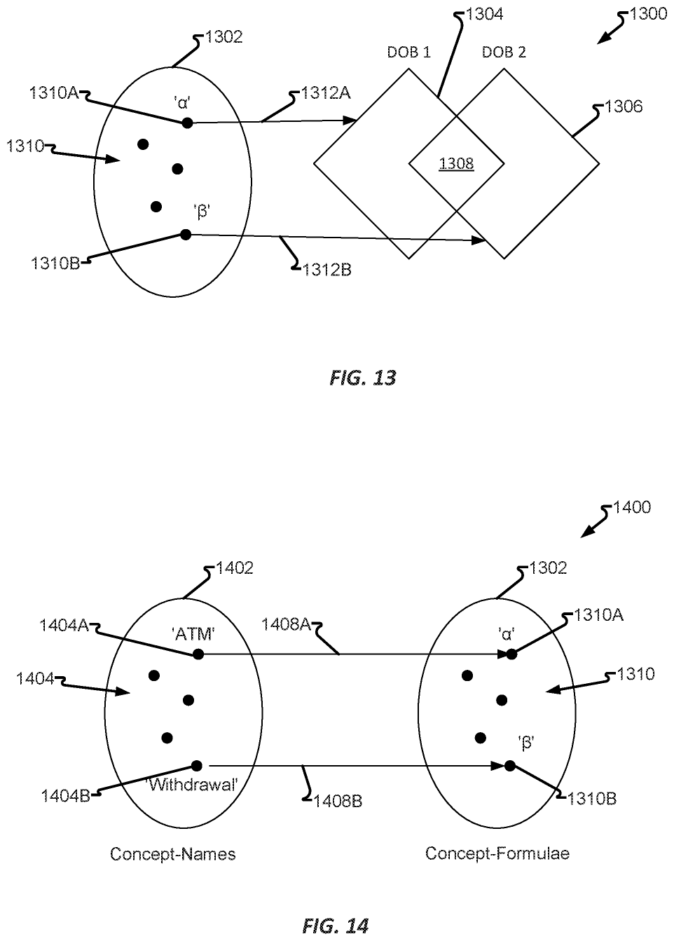

The BHK mapping is a way to do program slicing because it generates a set of conceptually meaningful sub-DOBs. The elements of this set, insofar as they are mapped to a Concept-Formulae, are called DOB-Concepts (represented as sets of nodes), as presented with respect to FIG. 13. A DOB-Concept associated with an Up (resp. Down) Concept-Formula is called an Up (resp. Down) DOB-Concept.

Theoretical Background and Implications:

The Constructivist/Intuitionistic state stages are conceived as not only temporal, but monotonically increasing in a cumulative process described as “hereditary sets.”

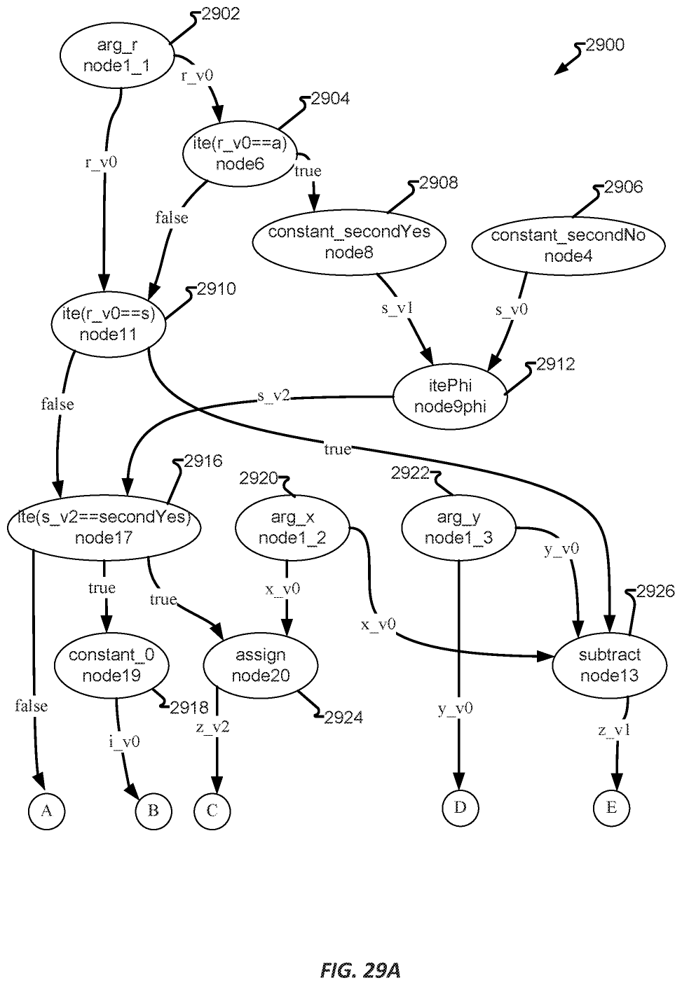

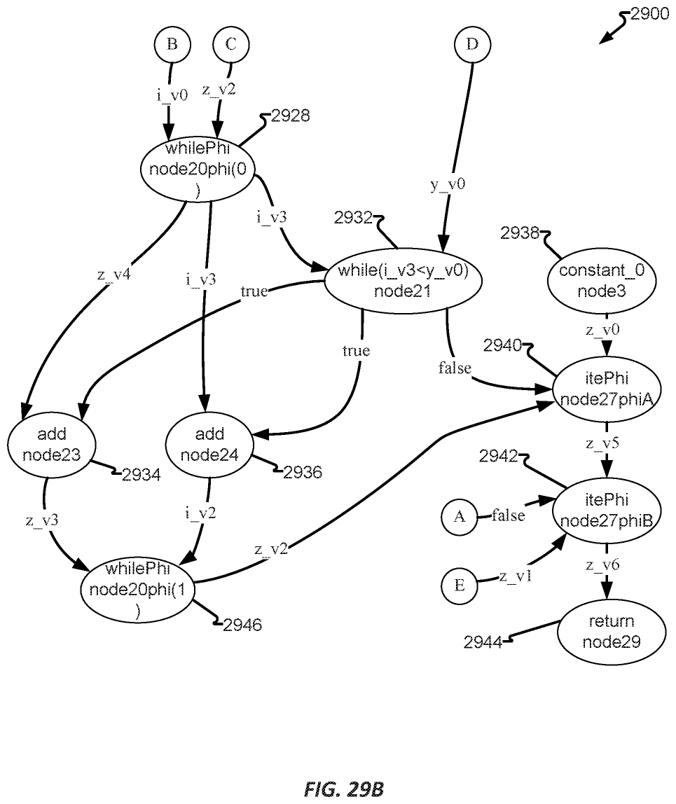

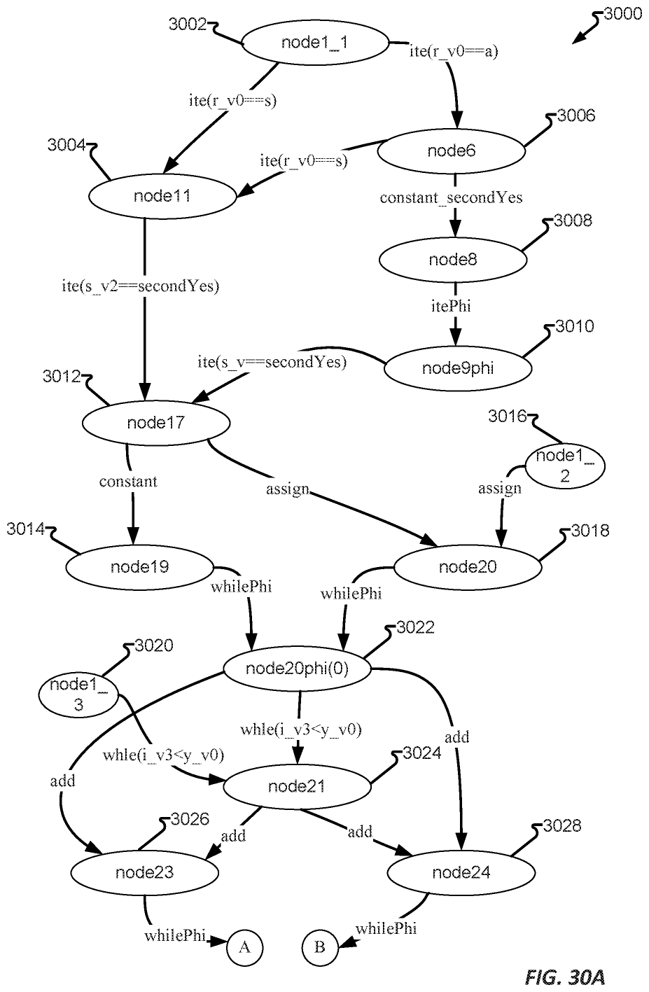

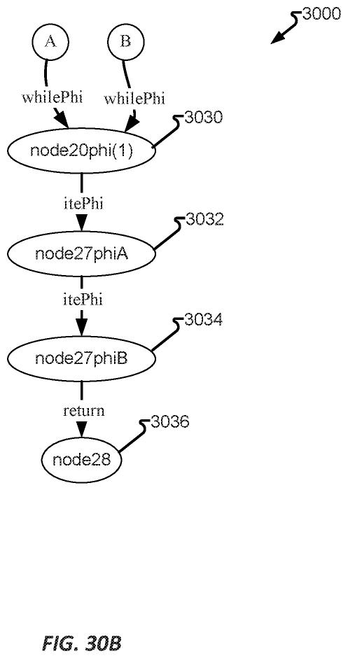

Hereditary sets, as described more completely with respect to FIG. 30, provide for the addition of path, or “hyperpath,” by building upon the “unrolled” DOB of FIG. 29, which also illustrates how mapping requirement may be satisfied by using the DOB representation, without having to create a new and distinct “hereditary” DOB.

The two diagrams, as illustrated in FIG. 29 and FIG. 30, are necessarily isomorphic because their stages are identical. Their unlabeled “skeletal” graph structures are identical.

Given this structural correspondence, the labeling difference may be resolved inductively. The base case corresponds to the root nodes of the graph. For the root nodes, the labels of the DOB and the hereditary graph are identical. For the induction case, the hereditary set of the next temporal stage is simply the union of the data values in the DOB's current state with those created in the next stage.

The process accommodates the branching-time aspect of possible worlds, as discussed above.

Having completed the process of mapping the DOB to BHK (steps 1202, 1204, and optionally 1004), we now shift our focus to the discussion of the actual operations and derived mathematical properties.

The good news is that these definitions by and large are quite familiar. Any variances from the classical formulation are quite familiar to computer scientists and developers. This community is accustomed to building and manipulating finite representations.

Differences from classical set theory stem from the fact that intuitionistic logical operations are defined from distinct set operations and have a one-to-one correspondence. Specifically, the intuitionistic and DOB implications cannot be defined as “˜Antecedent <or> Consequent.” Defining implication in this classical fashion presumes the “law of the excluded middle,” and results in oddities in implication involving Mick Jagger and pink elephants.

The analogue of implication must be defined distinctly in intuitionistic set theory. Even so, the intuitionistic set operation that defines logical implication corresponds to one used in introductory logic classes, which typically defines logical implications using sets in Venn diagrams.

Given the above definition, “intersection” is defined as:

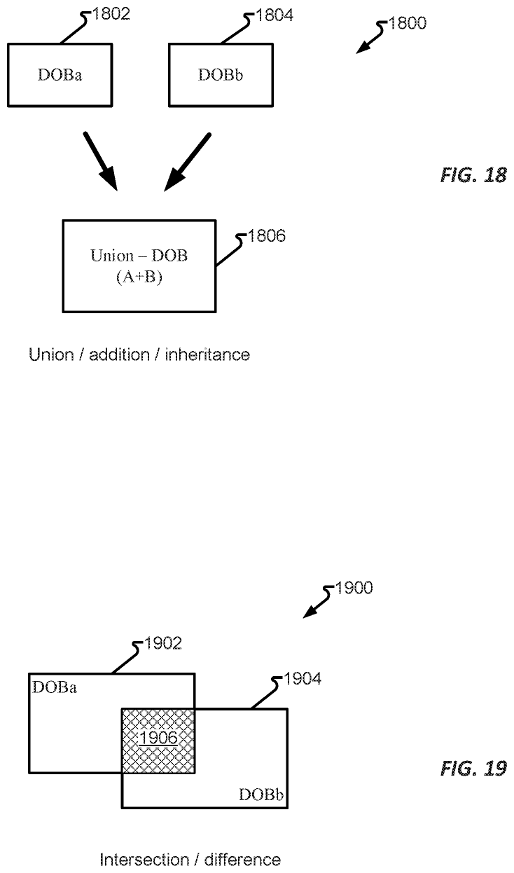

For DOBa and DOBb in DOB context, intersection(DOBa, DOBb) creates a value DOBv that is defined by the set vertex(X), vertex{X} is defined: X is a member of vertex(DOBa) and X is a member of vertex(DOBb). (See, FIG. 19).

“Complementation” may be defined as:

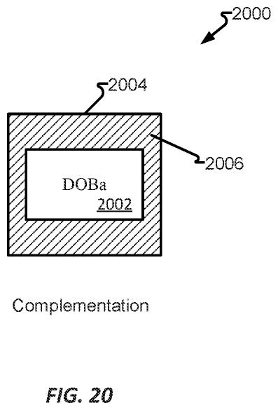

For DOBa in DOB context, complement(DOBa) creates a value DOBv that is defined by the set vertex(X), such that X is a member of vertex(X) if and only if X is a member of DOB context and X is not a member of DOBa (See, FIG. 20).

Relatively pseudo-complementation, the intuitionist version of implication is defined in terms of the temporal sequence of the “stages” of construction. A DOB operation instance corresponds to a “stage” of construction. Thus, for the implication of data values:

Given a data state DVi in Staget and data state DVj in Stagetu

DVi=>DVj, if t<u

The temporal sequence of BHK stages is “hereditary,” and each subsequent stage contains the union of all the prior stages' data values. Summing the inheritance is that any data value subset from a prior stage “implies” the newly constructed data values.

Embodiments are provided that are directed to a category of formal operations in the dependency ordered behavior (DOB) domain, more specifically, embodiments that manipulate DOBs as “specification concepts.” At a conceptual level, these formal operations manipulate the computation's specification using the DOB.

Familiar mathematical domains of numbers provide an allegory to representation and operations. As with numbers, there are analogues of arithmetic, algebra, and logical theories.

Embodiments are generally directed to: (1) Establishing a formal foundation of the analogy to numbers by mapping the DOB domain to the formalism of BHK intuitionism; and (2) providing a formal framework for set operations using the intuitionist formulation of mathematics.

FIG. 30 depicts unrolled DOB 3000. In one embodiment, hyperpath 3000 illustrates the hereditary sets for the addition path as illustrated in unrolled structure 2900 and comprises nodes 2902, 2904, 2908, 2912, 2916, 2918, 2922, 2924, 2928, 2902, 2936, 2934, 2940, 2943, 2944, and 2946.

In one embodiment, hyperpath 3000 nodes comprise root nodes (e.g., nodes that have no input) that are equivalent to corresponding unrolled structure 2900 (e.g., node 2902 is equivalent to node 3002, node 2920 is equivalent to node 3016, and node 2922 is equivalent to node 3020). Subsequent nodes are the union of the data values in the DOB's current state (e.g., individual nodes of unrolled structure 2900) and those created in the subsequent step (e.g., the node following the individual nodes of unrolled structure 2900). Again, hyperpath 3000 is merely an illustration to represent that which a processor would create or maintain in a memory or other data storage. Embodiments of nodes for hyperpath 3000 may include representations of:

Node 3002—“[r_v0]” (node1_1);

Node 3004—“[false(r_v0==s), r_v0,false(r_v0==a)]” (node11);

Node 3006—“[r_v0, false(r_v0==a)]” (node6);

Node 3008—“[r_v0, false(r_v0==a), s_v1]” (node8);

Node 3010—“[r_v0, false(r_v0==a), s_v1, s_v2]” (node9phi);

Node 3012—“[False(r_v0==s), true(s_v2==secondYes), r_v0,false(r_v0==a), s_v1, s_v2]” (node17);

Node 3014—“[False(r_v0==s), true(s_v2==secondYes), i_v0, r_v0, false(r_v0==a), s_v1, s_v2]” (node19);

Node 3016—“[x_v0]” (node1_2);

Node 3018—“[False(r_v0==s), true(s_v2==secondYes), r_v0, x_v0, z_v2, false(r_v0==a), s_v1, s_v2]” (node20);

Node 3020—“[y_v0]” (node 1_3);

Node 3022—“[false(r_v0==s), true(s_v2==secondYes), i_v0, r_v0, x_v0, z_v2, false(r_v0==a), s_v1, s_v2, i_v3]” (node20phi(0));

Node 3024—“[false(r_v0==s), true(s_v2==secondYes), i_v0, r_v0, x_v0, y_v0, z_v2, entry(true(i_v3<y_v0)),false(r_v0==a), s_v1, s_v2, i_v3]” (node21);

Node 3026—“[false(r_v0==s), true(s_v2==secondYes), i_v0, r_v0, x_v0, y_v0, z_v2, entry(true(i_v3<y_v0)), z_v3, false(r_v0==a), s_v1, s_v2, i_v3]” (node23);

Node 3028—“[false(r_v0==s), true(s_v2==secondYes), i_v0, r_v0, x_v0, y_v0, z_v2, entry(true(i_v3<y_v0)), i_v2, false(r_v0==a), s_v1, s_v2, i_v3]” (node24);

Node 3030—“[false(r_v0==s), true(s_v2==secondYes), i_v0, r_v0, x_v0, y_v0, z_v2, entry(true(i_v3<y_v0)), z_v3,i_v2, false(r_v0==a), s_v1, s_v2, i_v3, exit(false(i_v3<y_v0))]” (node20phi(1));

Node 3032—“[false(r_v0==s), true(s_v2==secondYes), i_v0, r_v0, x_v0, y_v0, z_v2, entry(true(i_v3<y_v0)), z_v3,i_v2, z_v5, false(r_v0==a), s_v1, s_v2, i_v3, exit(false(i_v3<y_v0))]” (node27phiA);

Node 3034—“[false(r_v0==s), true(s_v2==secondYes), i_v0, r_v0, x_v0, y_v0, z_v2, entry(true(i_v3<y_v0)), z_v3,i_v2, z_v5, z_v6, false(r_v0==a), s_v1, s_v2, i_v3, exit(false(i_v3<y_v0))]” (node27phiB); and

Node 3036—(node28).

The edges between nodes of hyperpath 3000 may be determined as the subsequent node from any preceding node. For example, node 3002 (“r_v0”) is the input into node 2904 (“ite(r_v0==a)”), therefore, the edge from node 3002 and node 3004 then becomes “ite(r_v0==a).”

The application of BHK in the realm of applied computation is fulfilled with the reduction of the DOB to the BHK model.

In one embodiment, one node inherits all aspects of the subsequent node. For example, node 3004 is inherited by node 3012 whereby node 3012 comprises the features of node 3004. Union operations may be performed on single nodes or collections of nodes. As a result, each node comprises the features of all preceding nodes.

Continuing with “smallExample” (source code 2600) which comprises awkward structuring and unnecessary complexity, functionality may be determined. In one embodiment, an end node that returns a value, (e.g., each node 3036) comprises all functionality that lead to the execution of the source code portion represented by the end node. Should there be an unreachable code, such “dead code” would be absent from the end node. Similarly, and as further described herein, operations may be refined, simplified, omitted, or restructured to further describe a source code with respect to essential elements.

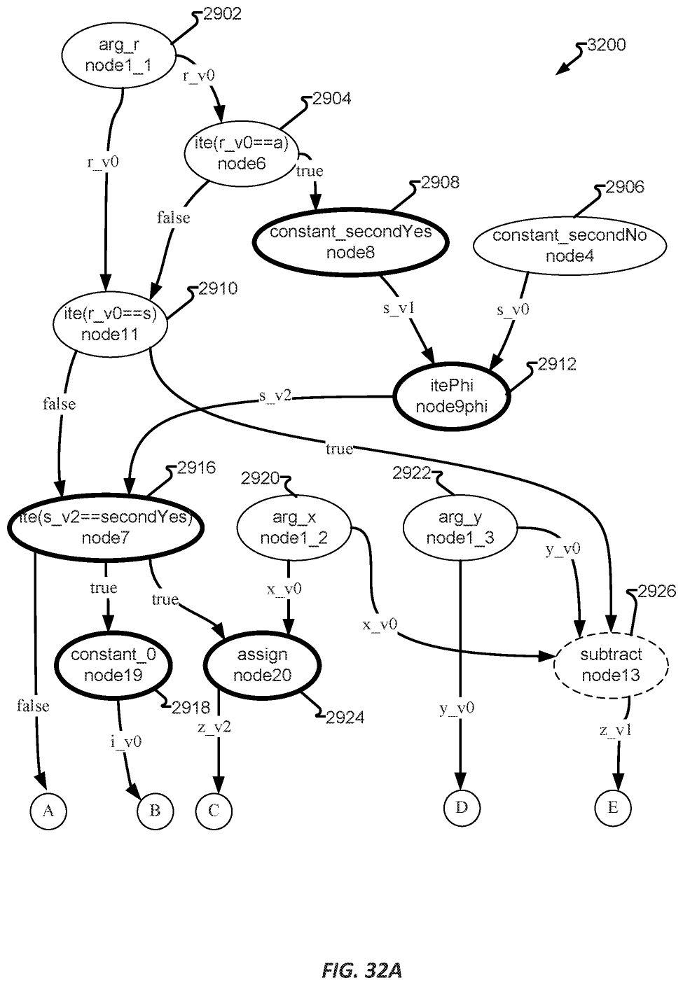

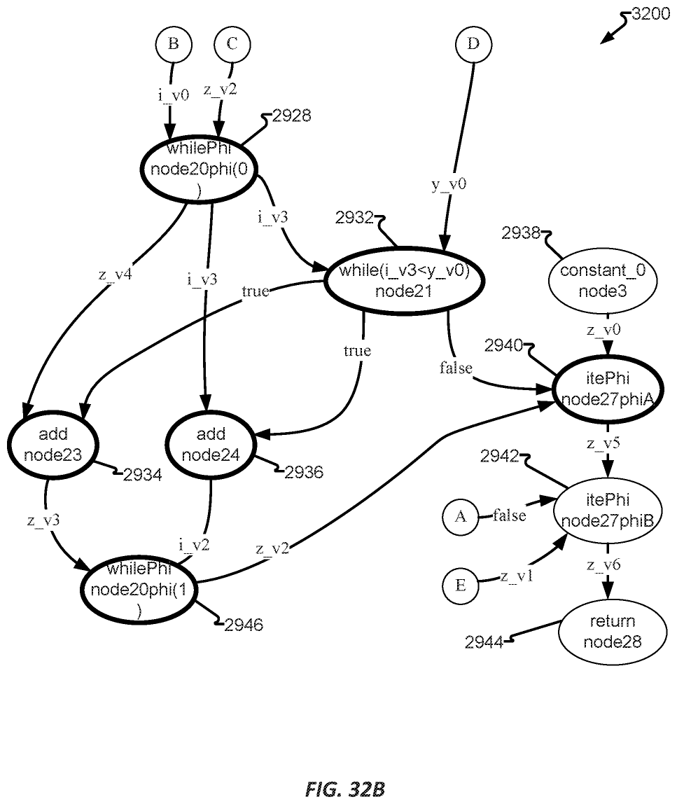

FIG. 32 depicts unrolled structure 3200 in accordance with embodiments of the present disclosure. In one embodiment, portions of unrolled structure 2900 are emphasized, the addition portion identified by bolded nodes (e.g., nodes 2908, 2912, 2916, 2918, 2924, 2928, 2932, 2934, 2936, 2940, and 2946) and the subtraction portion identified by dashed nodes (e.g., node 2926).

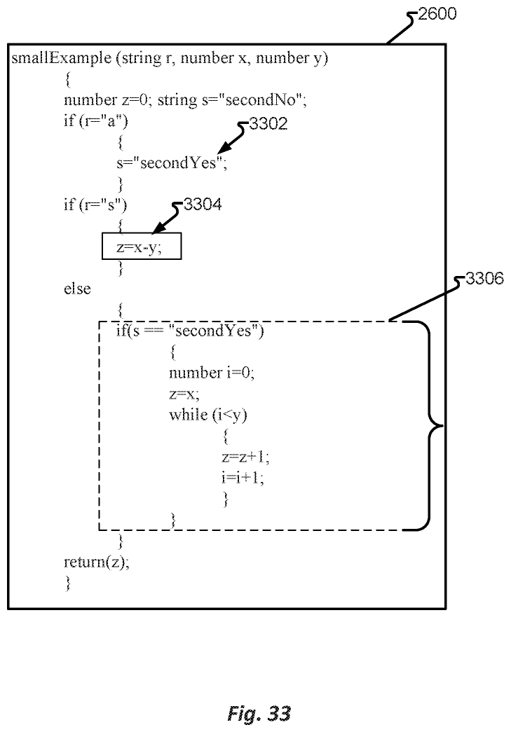

Subtraction may be provided by user-selects(s_UBX, _UBY). The analogous formula of set operations results in the aforementioned dashed nodes. The correctness may be apparent when projecting the emphasized portions on to “smallExample,” as will be described more completely with respect to FIG. 33.

This mapping from a data state to a hereditary DOB provides a one-to-one correspondence between the data states and the DOBs. It is a crucial step for selecting a meaningful (relatively small) subset of DOBs. Indeed, through this mapping, we're ruling out all the DOBs that don't contain a persisting data state and all the DOBs that are not unique in respect to some data state.

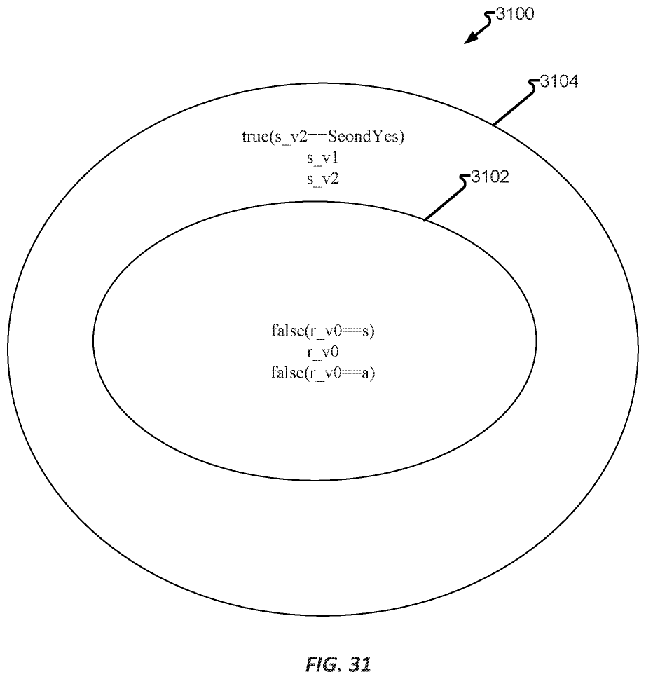

FIG. 31 depicts Venn diagram 3100 in accordance with embodiments of the present disclosure. In one embodiment, diagram 3100 illustrates node 3004 as outer portion 3104 and node 3012 as inner portion 3102, such as to illustrate the truth-table of implication, that is node 3104=>node 3102. In another embodiment, Venn diagram 3100 illustrates “implication.”

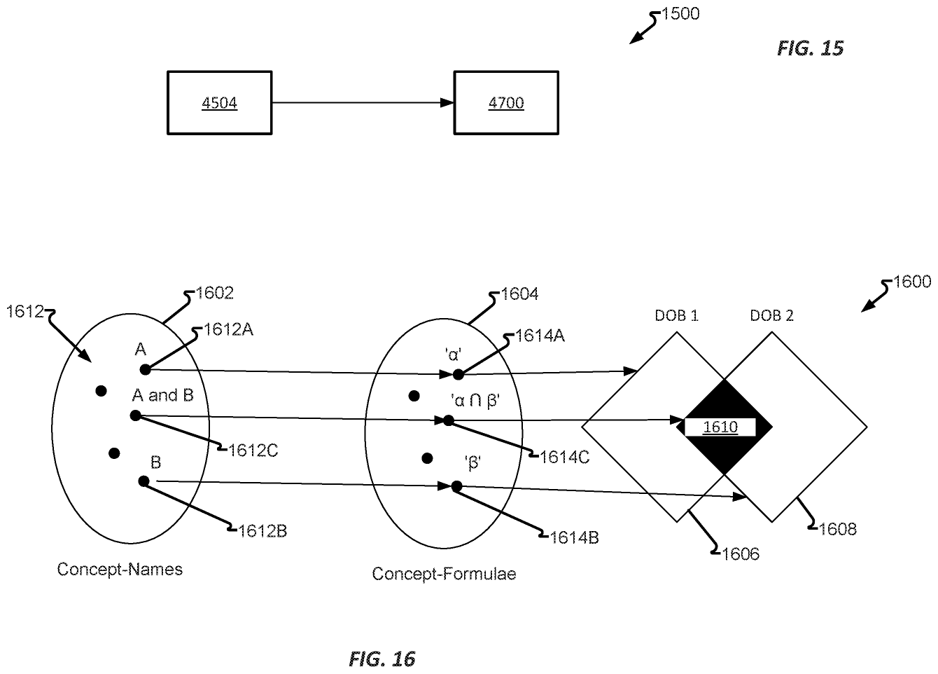

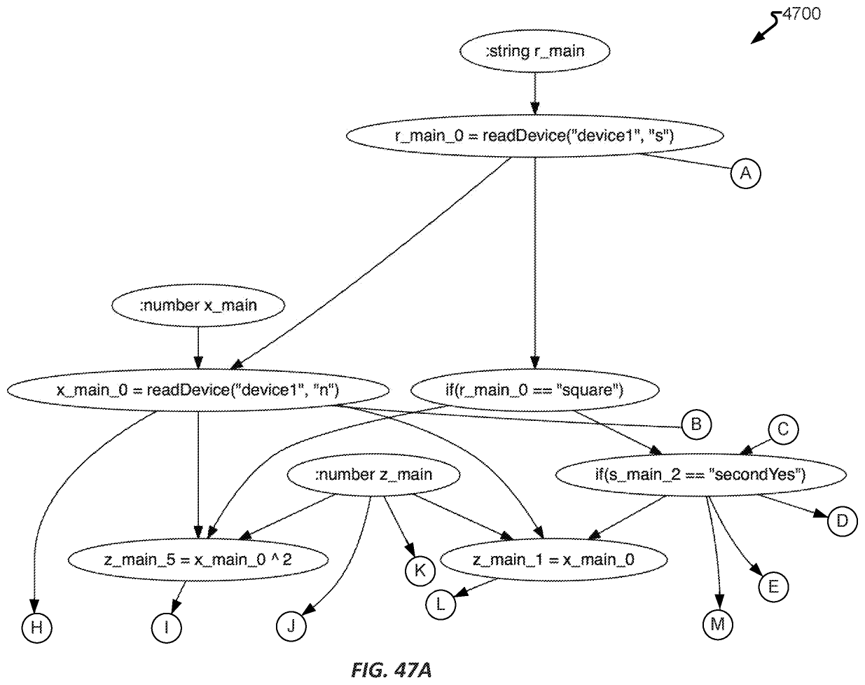

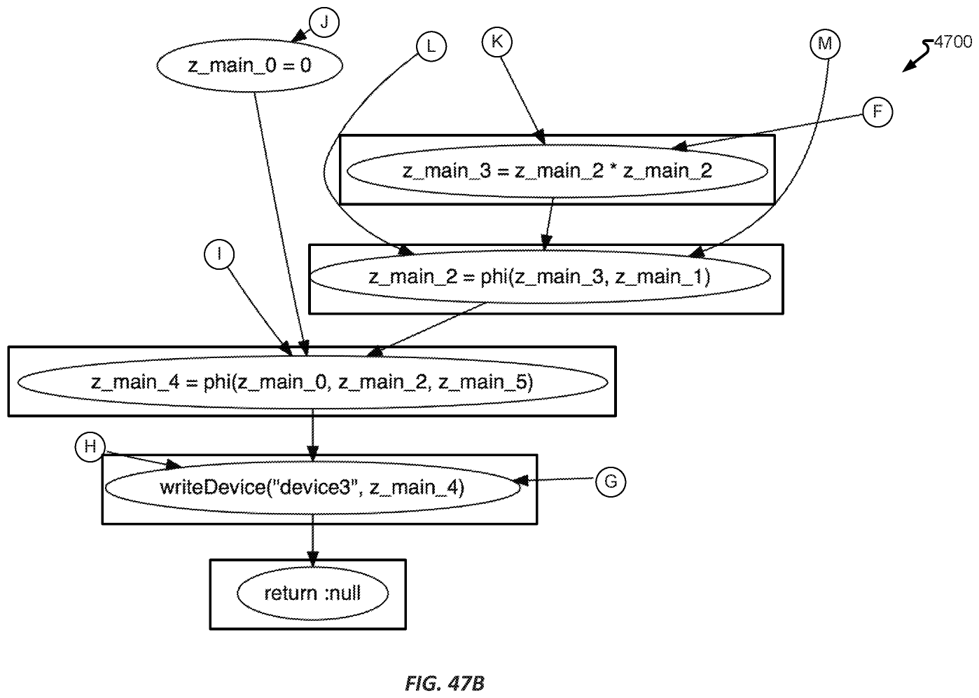

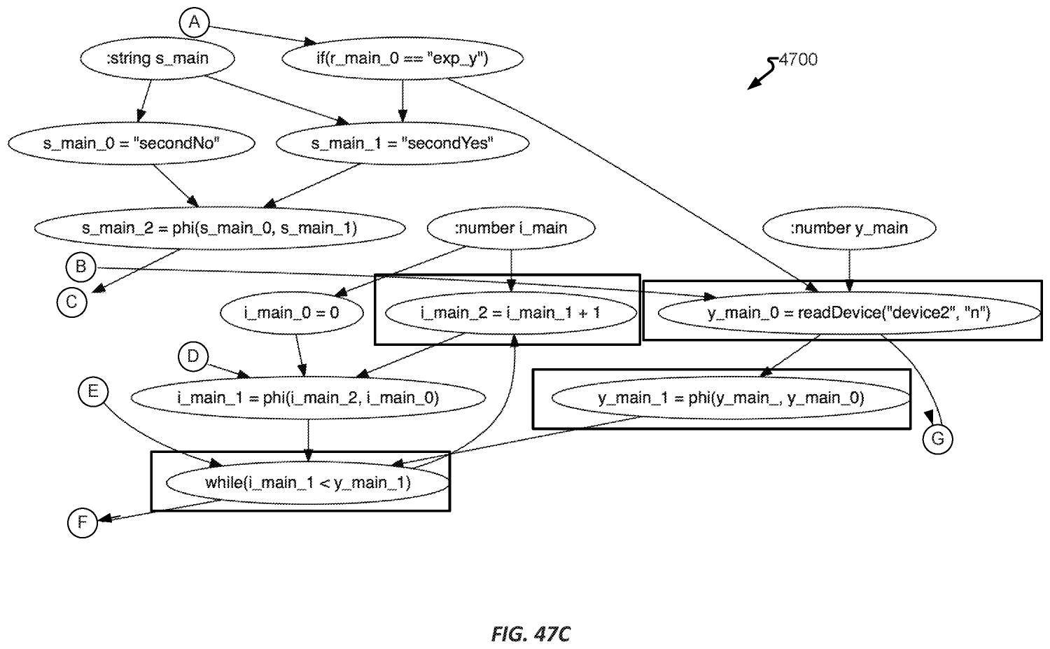

FIG. 15 depicts DOB-to-DOB mapping 1500 in accordance with embodiments of the present disclosure. In one embodiment, a DOB, such as DOB 4504, describing a subtraction operation, is mapped to another DOB, such as 4700 describing the use of a particular device. (See, FIGS. 45 and 47, respective).

This mapping is conceptually meaningful, because it associates a data state with the source code of the corresponding specification concept. In other words, we select a particular subset of the code that has to do with this concept; the rest of the code doesn't.

Concept-Name Mapping:

FIGS. 13 and 14 depict concept-to-formula mapping 1300 and 1400, respectively, in accordance with embodiments of the present disclosure. This process is known as “Concept-Name Mapping” and results in a mapping between Concept-Formulae 1302 and Concepts in the Application Domain (e.g. “ATM” or “Withdrawal”) 1402.

In one embodiment, mapping 1300 depicts the mapping between Concept-Formulae 1302 and DOBs. In this example, the Concept-Formula ‘a’ 1310A maps to DOB 1 1304 and the Concept-Formula ‘β’ 1310B maps to DOB 2 1306. We'll see later, in FIG. 16, how set operations gives a mapping to the intersection of DOB 1 and DOB 2 1308 as well (therefore node 1308 is mapped to node 1610).

In another embodiment, DOB 1 1304 is mapped via mappings 1312A from node 1310A of nodes 1310 illustrating a plurality of concepts. Similarly, DOB 2 1306 is mapped via mappings 1312B from nodes 1310B having a different plurality of concepts and creating intersection 1308. In one embodiment, intersection 1308 illustrates concepts 1310 overlapping between DOB 1 1304 and DOB 2 1306.

A Concept-Formula is not a human concept because it is expressed in formal mathematical terms (e.g. “the hereditary set generated by statement ‘x’ with respect to variable s′ in the context of the application PoKn-DOB”), but Concept-Names in the application domain (like “ATM” or “Withdrawal”) 1402 can be mapped to Concept-Formulae 1302.

A Concept-Name is a Natural Language description in the Application Domain (banking, for instance) associated with a Concept-Formula 1302.

In what follows, we present the process to associate the Concept-Names in the domain of Devices with the corresponding Concept-Formula 1302.

Theoretical Background and Implications:

The API ontology is a hierarchy of API concepts in the application domain (e.g. “ATM,” “ATM input,” “ATM output,” etc.), formalized as a partial order. These API concepts are instances of Concept-Names 1402 and are depicted on FIG. 14 (e.g. 1404A is “ATM” and 1404B is “Withdrawal”).

In one embodiment, concepts 1404 comprise hardware components, such as automated teller machine (ATM) 1404A as well as operations, such as withdrawal, 1404B. Mapping 1408A associates concept 1404A to node 1301A and mapping 1408B associates concept 1404B to node 1310B.

A device selection statement is a statement including a call to an API method.

The pre-defined API mapping associates elements of the API ontology with a device selection statement.

As we said before, a Concept-Formula is always associated with a unique statement. In one embodiment, we can define a device embodiment of Concept-Formula 1302 for a device as “Device Concept-Formula,” the Concept-Formula 1302 associated with a device selection statement. A Device Concept-Formula uniquely defines a DOB-Concept associated with a particular device selection statement. As explained before, it also directly refers to a unique slice of code. It is why we can say that the identification of Device Concept-Formulae is a form of program slicing with respect to a device selection.

By the pre-defined API mapping, we can associate a Device Concept-Formula with a Concept-Name through the corresponding device selection statements.

Closure Under Set Operations:

FIG. 16 depicts a name-to-DOB mapping 1600 in accordance with embodiments of the present disclosure. As represented in mapping 1600, there is an isomorphism between the set of DOB-Concepts 1606 and 1608 closed under the usual set operations (considering a DOB-Concept as a set of Nodes) on one hand, and the set of Concept-Names 1612 closed under the usual logical operations on the other hand.

Therefore, Concept-Names 1602 also are closed under the logical operations of conjunction, disjunction, and negation. The Concept-Name Ontology defines a hierarchy of complex concepts defined from the logical combination of more elementary concepts.

For instance, we said earlier that the API ontology is a hierarchy of API concepts in the application domain (e.g. “ATM,” “ATM input,” “ATM output,” etc.). These API concepts are instances 1612 of Concept-Names (e.g., FIG. 16, “A” 1612A, “B” 1612B or “A and B” 1612C). An API concept is either an elementary API concept (such as “A” 1612A) or a logical compound of API concepts (such as “A and B” 1612C). Such complex API concepts, which are also Concept-Names, provide the system with richer semantics.

In another embodiment, nodes 1612 of Concept-Names 1602 are mapped to Concept-Formulae 1604, which in turn are mapped to DOB 1606 and DOB 1608. For example, concept name “A” node 1612A is mapped to Concept-Formulae node 1616A and to DOB 1606. Concept-Name 1612C “A and B” node 1612C is mapped to Concept-Formulae node 1614C and to DOB intersection 1610. Concept-Name “B” node 1612B is mapped to Concept-Formulae node 1614B and to DOB 1608.

Mapping 1600 depicts an example of such a Concept-Name to DOB mapping through Concept-Formula. In this example, the concept-Name A 1612A maps to the DOB DOB1 1606, through the Concept-Formula ‘a’ 1614A; the concept-Name B 1612B maps to the DOB DOB2 1608, through the Concept-Formula ‘β’ 1614B; and, adding the set operations, the concept-Name A and B 1612C maps to the DOB DOB1∪DOB2 1610, through the Concept-Formula ‘α∪β’ 1614C.

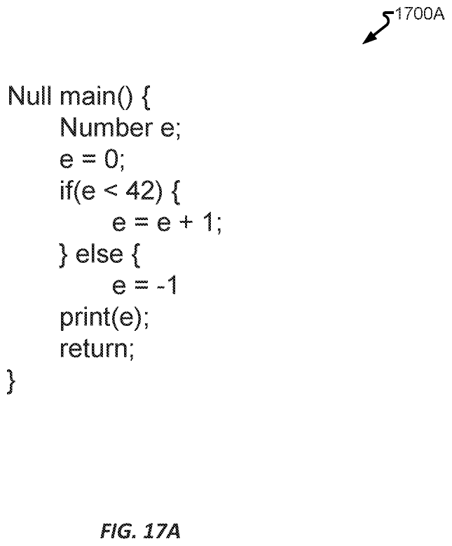

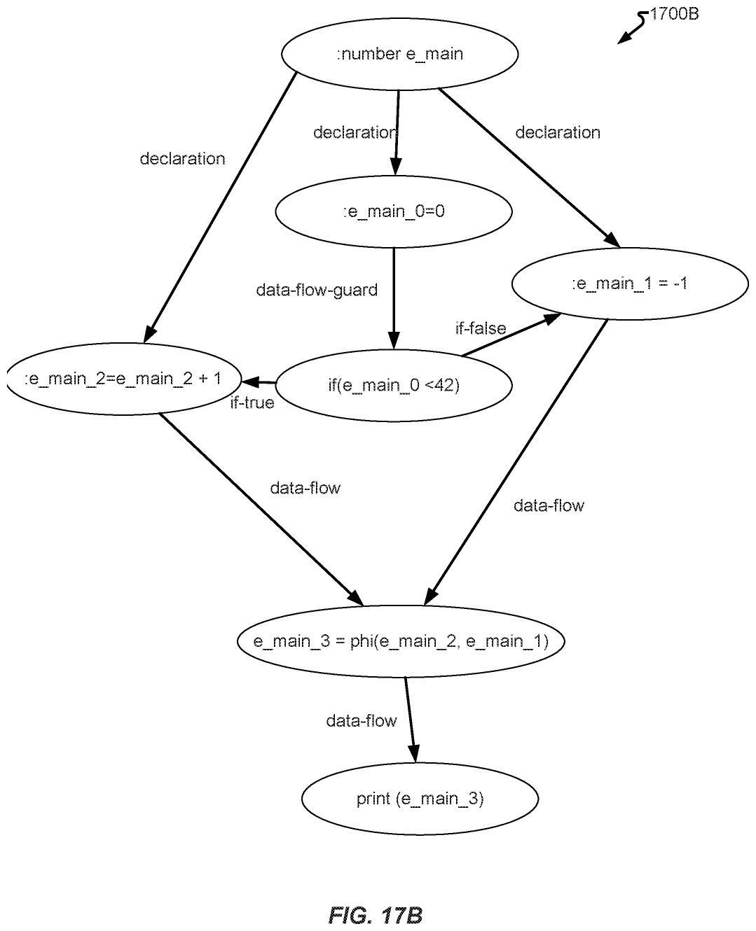

FIGS. 17A-B depicts another process in accordance with embodiments of the present disclosure. More specifically, FIGS. 17A-B illustrate another example whereby source code 1700A may be transformed into DOB 1700B by certain embodiments described herein.

Theoretical Background and Implications:

FIGS. 18-20 illustrate embodiments whereby software is data. Various “data” operations are well known, such as the set operations of union, intersection, and complement. The embodiments described with respect to FIGS. 18-20 enable software. The embodiments described are directed towards software and, in particular, source code. In other embodiments, object code, executable code, or other compiled, interpreted link files, or other instruction-containing files, or file portions, are provided. For example, a modification to a source code may be applied and an executable code is determined to be equivalent, such as when the source code has been lost and only the executable code remains. A functional equivalence between the source code and the executable code may then be discovered and a functionally equivalent modification selected and implemented.

Set operations are the foundation of all operations on the DOB specification. For the DOB, these operations are largely the core familiar ones: intersection, union, and complementation.

Fundamental for these set operations is that they all occur in a DOB context; their effect is bounded by the context of an encompassing DOB.

The DOB context provides the set of DOB operations and execution dependencies between them, where they exist. We often talk about the DOB interchangeably as a computational specification or alternatively as a graph structure, although clearly a graph is simpler semantically. In this context, the simplicity of graphs is an ally and, consequently, the set semantics associated with DOBs are easier to describe using graph terminology.

The DOB context of the operations provides a set of vertices (operations) and a set of edges (dependencies), which reference the vertices as ordered pairs. (1) Set operations are functions whose parameters are sets of vertices, and whose values are also sets of vertices. (2) The value set “inherit” the edges defined in the encompassing DOB context and define one or more graph components.

The resulting graph components correspond to the DOB (or DOBs) that result from the set operation. Each graph component is, by definition, a subgraph of the DOB context.

FIG. 18 depicts union operation 1800 in accordance with embodiments of the present disclosure. In one embodiment, function 1802 and function 1804 comprise code that is not entirely identical (e.g., at least one functional difference exists between function 1802 and function 1804). Function 1802 and function 1804 may be embodied as a function, functions, or portion of instructions with a single program file, program files, or a plurality of program files and may further be differently or similarly embodied. Function 1802 and function 1804 are then added to produce function 1806.

The union operation allows for two disparate entities to be combined such that the result comprises each feature of both entities. Such is true in mathematics (e.g., the union of the set {1, 2, 3} and the set {3, 4, 5} results union {1, 2, 3, 4, 5}) and, as described herein, similarly true with software.

FIG. 19 depicts intersection operation 1900 in accordance with embodiments of the present disclosure. In one embodiment, DOBa 1902 and DOBb 1904 each have associated code that is partially the same. Accordingly, difference 1906 may be identified. Furthermore, difference 1906 may be removed from one or both of DOBa 1902 or DOBb 1904 and thereby subtract the common function (e.g., difference 1906) from one or more of functions 1902 or function 1904.

FIG. 20 depicts complementation operation 2000 in accordance with embodiments of the present disclosure. In one embodiment, negation is a complementation. However, and in other embodiments, negation is a functional counterpart. For example, DOBa 2002 may be “withdrawal with fee” operation and DOB 2004 may be a “withdrawal” operation, and complementation 2006 may be the complement of “withdrawal with fee” in the context “withdrawal” (e.g., “withdrawal without fee”).

For example, consider the Concept-Name associated with a particular device selection statement. It is not always very meaningful by itself. A program may contain many identical API calls related to the same device. Because the set of Concept-Names is closed under the disjunction, we can easily aggregate such similar concepts into one, more meaningful concept. In general:

instances of the same API calls can be aggregated into a disjunction to mean, “the concept of selecting a specific call for a given device” (e.g., the write to screen);

instances of different calls from the same device can be aggregated into a disjunction to mean, “the concept of selecting a specific device” (e.g., the ATM);

instances of different devices can be aggregated into a disjunction to mean, “the concept of selecting this collection of devices” (e.g., the web-based devices).

An example of complex Concept-Name made out of a conjunction would be the “online check deposit,” which is the conjunction of a “device connected to the web” and a “deposit.”

Another example of complex Concept-Name made out of a conjunction would be “inputting an amount and outputting a balance,” which is the conjunction corresponding to the intersection of a Down DOB-Concept and an Up DOB-Concept, one associated with “inputting an amount” and the other with “outputting a balance.” Such Complex-Name maps to what is usually called a “reaching operation” in program analysis.

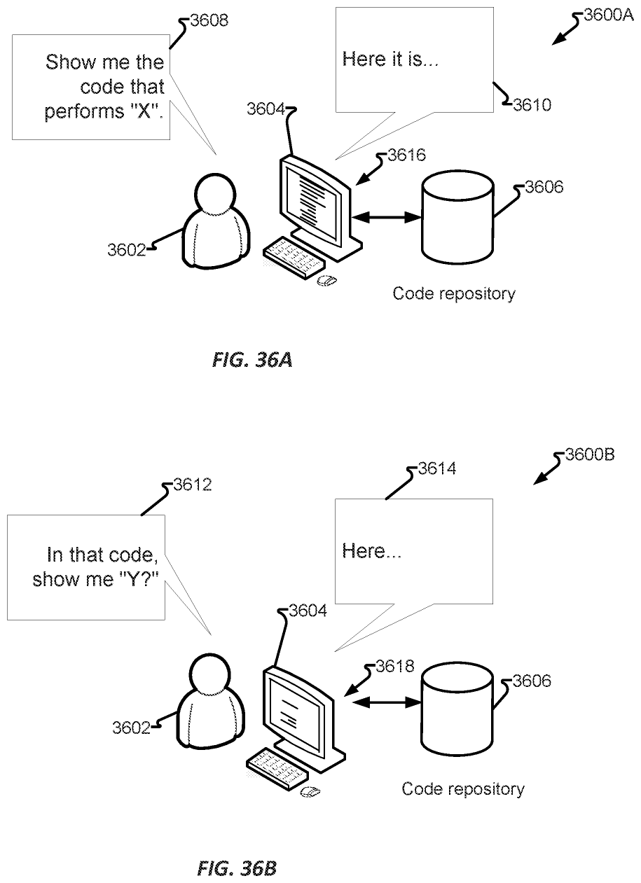

FIGS. 36A-B depict interaction 3600A-B in accordance with embodiments of the present disclosure. In one embodiment, user 3602 is a human that issues requests, such as request 3608 to computer 3604. In another embodiment, request 3608 may be issues from a program, computer device, network interface, artificial agent, and/or other computing component. In such an embodiment, request 3608 may be via machine instruction provided by a network interface to computer 3604. Response 3610 and 3614 are provided as an optional cue to what is displayed on computer 3604, such as displayed content 3616 and displayed content 3618. Although request 3608; as well as request 3608, response 3610, and response 3614 are illustrated to indicate spoken communications, it should be appreciated that such interactions may be conducted in any form from one entity issuing a request, such as user 3602, to another entity able to respond to the request, such as computer 3604, in spoken, visual, tactile (e.g., keyboard, mouse, trackpad, etc.), wired (Ethernet, telephone, etc.), and/or wireless (e.g., WiFi, WiMax, Near Field, Bluetooth, infrared, etc.) form, without departing from the embodiments described herein.

In another embodiment, computer 3604, in response to receiving request 3608, accesses source code from repository 3606. Repository 3606 may be an optical, magnetic, distributed (e.g., data “farm”), shared (e.g., “cloud”), and/or other repository configured to maintain source code, such as a source code file. Computer 3604, in response to request 3608, accesses source code from source code repository 3606, and presents a response to the request. The details of how computer 3604 presents displayed content 3616 and displayed content 3618 are provided in more detail with respect to the embodiments that follow. For example, user 3602 may issue request 3608 seeking to have a particular feature of a source code, which may be limited to a particular domain in advance of request 3608 or in conjunction with request 3608. Computer 3604 presents displayed content 3616 providing a response to request 3608.

As will be appreciated, the source code to be processed in order to present displayed content 3604 may range from a handful of instructions to many millions of lines of code, which may be associated with a plurality, often in the thousands, of files, modules, functions, and/or other structures.

In one embodiment, interaction 3600A illustrates a request for a certain portion (e.g., “X”) of a source code file. In another embodiment, interaction 3600B refines the request, via request 3612, based upon a prior request, namely that of request 3608. In response, computer 3604 responds with response 3614 as an optional cue that displayed content 3618 is available for viewing a display of computer 3604. As described above with respect to FIG. 36A, other forms of communication are also contemplated by the embodiments herein and spoken cues (e.g., response 3614) and visual displays (e.g., displayed content 3618) may be communicated to user 3602 via other means without departing from the scope of the embodiments described herein. In another embodiment, requests 3608 and 3612 may be combined, such as when issuing multiple targets comprising the same search. For example, “show me the code for withdrawals and for ATMs.” Accordingly, code comprising either “withdrawals,” comprise one target, and code for “ATMs,” comprise a second target. Accordingly, computer 3604 determines which code applies to either, or union, of code for “withdrawals” and “ATMs.” Alternative set operations may be utilized, as described more completely with respect to certain embodiments below. By way of an introduction, negation and intersection may be utilized. For example, “show me the code for withdrawals from ATMs,” may then be the intersection of code for “withdrawals” and “ATMs.” In another example, “show me the code for withdrawals but not from ATMs” would be the set of code that is the union of “withdrawals” and code that is not code for “ATMs.”

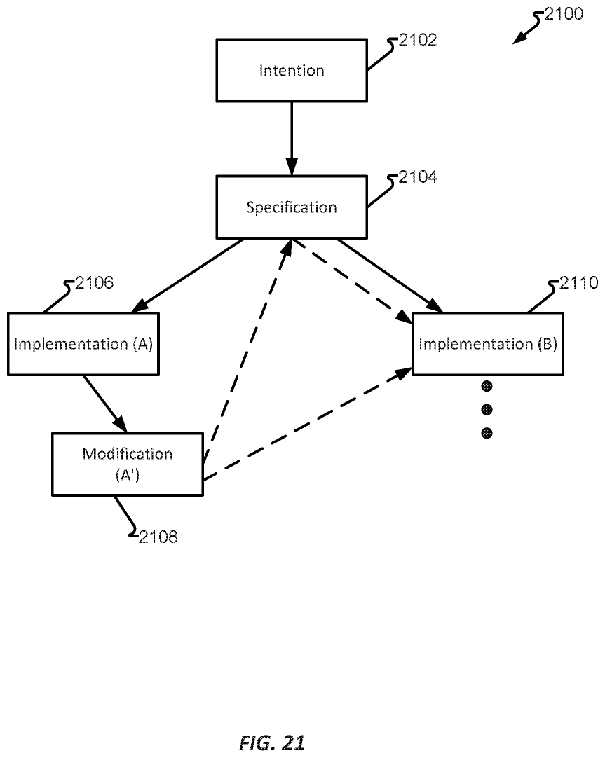

FIG. 21 depicts interaction 2100 in accordance with embodiments of the present disclosure. In one embodiment intention 2102 describes a desired operation of a system (e.g., configured computing hardware, networking components, etc.). Intention 2102 may be conceptual (e.g., “debt account by the amount withdrawn.”). Intention 2102 may be human or machine descriptive and may be considered a requirement for a system.

From intention 2102, specification 2104 may be derived. In one embodiment, specification 2104 defines the components and the operations of the components required in order to fulfill intention 2102. In one embodiment, specification 2104 is developed in parallel with a particular implementation, such as one of implementation 2106 or 2110.

In another embodiment, from specification 2104, implementation 2106 is derived. In another embodiment, from specification 2104, implementation 2106 and 2110 are derived concurrently or serially. Implementations 2106 and 2110 may differ. The difference does not result in a variance from specification 2104 nor from intention 2102. For example, implementations 2106 and 2110 may differ in terms of target platform, target operating system, programming language, programming language version, architecture (e.g., host-client, cloud-client, stand-alone computer, etc.), etc. Differences may also be provided by non-functional requirements. For example, one of implementations 2106 or 2110 may incorporate additional or different security, which may be associated with a particular architecture as compared to the other; or one may be optimized for speed; or one may accumulate tasks for batch processing.

Modification 2108 may then be provided based on a modification to implementation 2106. As a benefit of the embodiments provided herein, the modifications may then be a particular “slice” or a change in a “slice” of a DOB. Differences in the DOBs may then be mapped to specification 2104 and then to another implementation, such as implementation 2110, or to implementation 2110 directly. For example, a harmonization may be performed such that a DOB derived from the source code utilized for implementation 2106 and another DOB, derived from the source code utilized for implementation 2110 is compared. As described herein, the differences may be automatically applied to implementation 2110 as a result of modification 2108 to cause a modification to implementation 2110 (not shown) to have an equivalent DOB to the DOB of implementation 2106. A machine may be utilized, without a human input, to cause modification 2108 to be applied to implementation 2110.

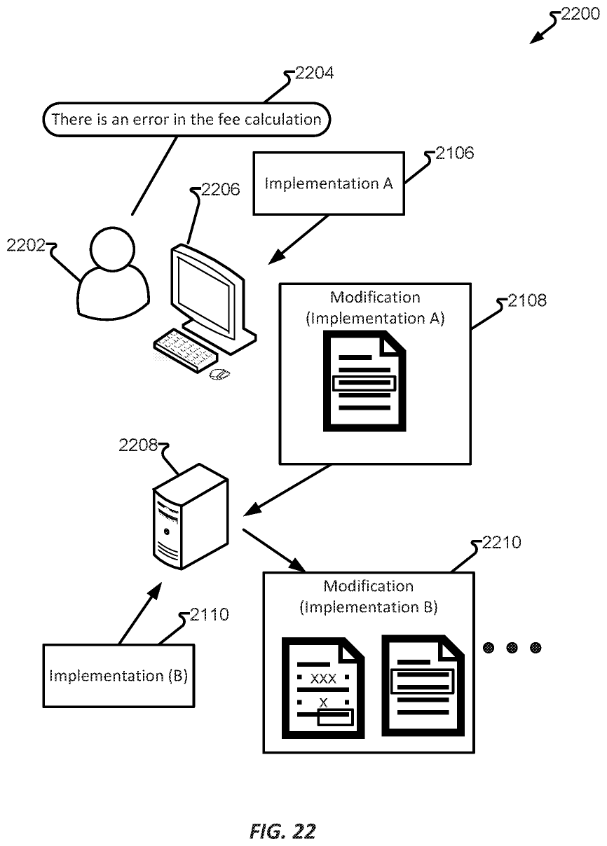

In another embodiment, modification 2108 may produce a DOB as a query, such as when the behavior is a modified behavior (e.g., “A prime”). Additionally or alternatively, a set operation may then be performed, such as intersection, to determine where a DOB associated with implementation 2110 differs and corrected automatically. Further additional and alternative embodiments are provided with respect to FIG. 22.

FIG. 22 depicts interaction 2200 in accordance with embodiments of the present disclosure. Dialog 2204 by user 2202 illustrates one intention 2102 from FIG. 21, specifically not for a new program but for a modification. User 2202 interacts with computer 2206 or other human-machine interface to input dialog 2204. Computer 2206 (alone or with benefit of server 2208 which may comprise memory, storage, additional processors, network connections, etc.) may optionally present implementation 2106 or a portion thereof for viewing by user 2202. User 2202, via computer 2206, causes modification 2108, such as by changing a portion of a source code file which is then prepared for execution (e.g., compiled, linked, etc.).

Server 2208 is a processing device or devices receiving modification 2108 as an input. Sever 2208 derives a Dependency Ordered Behavior (“DOB”) to extract the meaning behind modification 2108. Server 2208 obtains or generates a DOB for implementation 2110, applies the changes to the DOB derived from modification 2108 and modifies the affected source code (or machine code) to generate modification 2210 of implementation 2110 without requiring any human intervention.

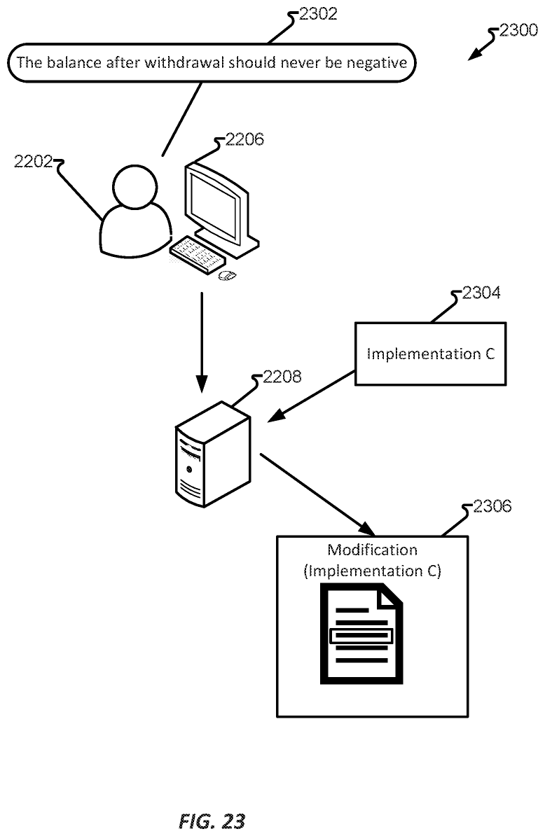

FIG. 23 depicts interaction 2300 in accordance with embodiments of the present disclosure. Intention 2302 is provided by user 2202, such as to computer 2206 or other human-machine interface. Server 2208 accesses implementation 2304 and associated DOB (not shown) or generates a DOB. The native instruction provided in intention 2302 is then mapped to the DOB and resulting code changes applied to create modification 2306. DOB is described more completely with regard to the embodiments that follow.

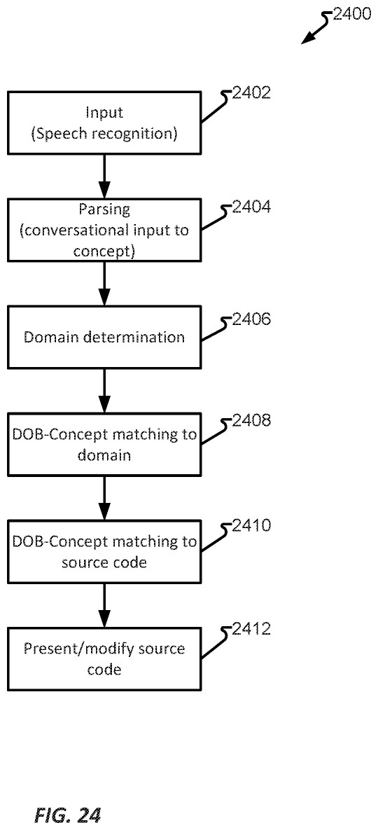

FIG. 24 depicts process 2400 in accordance with embodiments of the present disclosure. In one embodiment, a user provides input 2402 which may be spoken, typed, or otherwise input into a human-machine interface for use by a computer. Step 2404 parses the input to extract parts of speech, key words, action, subjects, and/or other grammatical elements. Next, step 2406 determine a domain and a desired action (e.g., modification) from the parsed speech. A DOB-concept matching is performed for the domain in step 2408. Step 2410 matches the DOB-concept to the source code which is then modified, presented, or otherwise manipulated, by step 2412, in accord with input 2402.

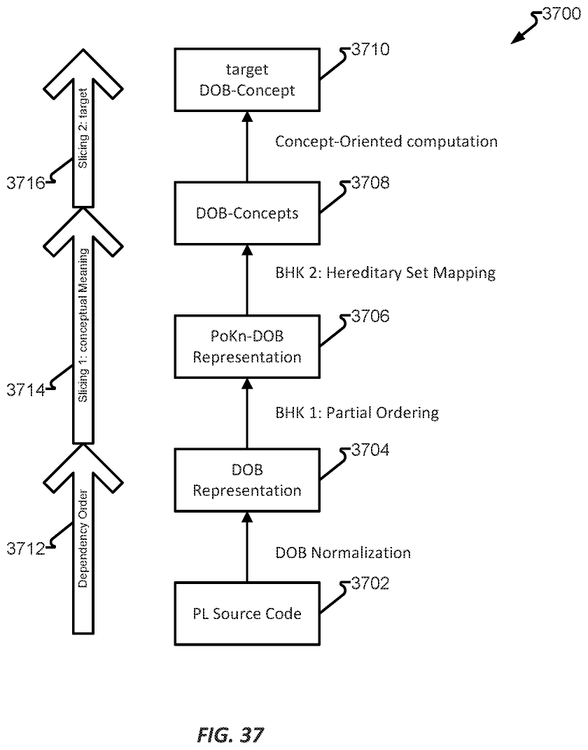

FIG. 37 depicts process flow 3700 in accordance with embodiments of the present disclosure. In one embodiment, programming language source code 3702, via a determination of DOB 3712, is transformed into DOB 3704. DOB 3704 is transformed, via slicing 3714 into PoKN-DOB 3706 and then into DOB concepts 3708. DOB concepts 3708 is then transformed by slicing 3716 into target DOB-concept 3710.

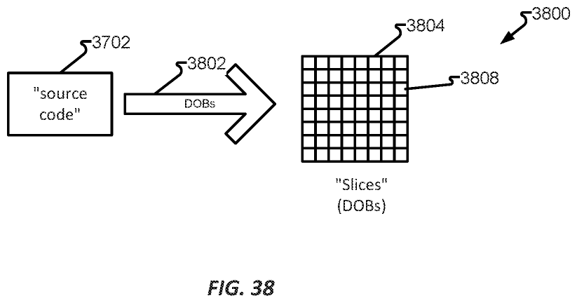

FIG. 38 depicts a DOB slicing 3800 in accordance with embodiments of the present disclosure. In one embodiment, process 3802 takes source code 3702 and returns a plurality of DOBs 3804. A particular one DOB 3808 may then be selected as a “slice” performing a particular behavior associated with a portion of source code 3702.

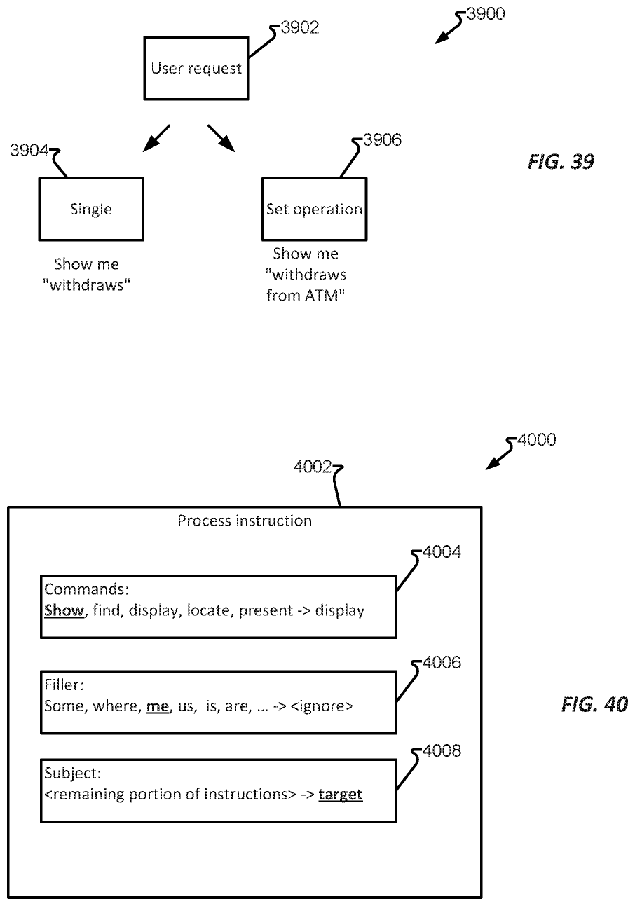

FIG. 39 depicts high-level instruction parsing 3900 in accordance with embodiments of the present disclosure. In one embodiment, a user request 3902 is parsed to determine whether it is single request 3904 or set operation 3906. For example, single request 3904 may comprise a single feature, for example, “show me withdrawals,” “display use of ‘device 1,’” etc. Set operation 3906 comprises at least one set operation. For example, “show me the code that is not related to fees,” “show me deposits at ATMs,” “show withdrawals and fees,” “show fees, but not overdraft,” etc. As can be appreciated, set operations may be more complicated, such as when utilizing a prior set operation result. For example, “in the code of withdrawals or fees, show telephone banking.”

FIG. 40 depicts more detailed instruction parsing 4000 in accordance with embodiments of the present disclosure. In one embodiment, process 4000 performs operation 4004 whereby a command is extracted from a request, such as request 3608 from FIG. 36A. For example, “show,” “move,” “replace,” etc. Operation 4006 illustrates words that do not impact either the operation or the subject of the operation and may be discarded for purposes of processing a request. For example, “show fees” may be equivalent, following process 4006, of the more verbose, “show me the source code that is used to determine or present fee information.” Accordingly, process 4006 may omit words that are determined to convey no additional meaning beyond the command and target. Process 4008 determines the target, which may be the remaining portion of a request following removal of non-meaning words in process 4006 and determining the operation in process 4004.

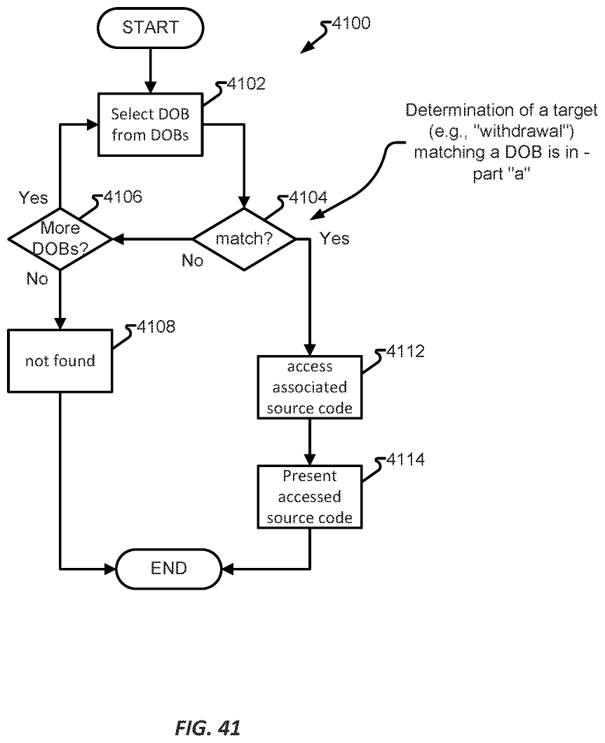

FIG. 41 depicts process 4100 in accordance with embodiments of the present disclosure. In one embodiment, process 4100 first iterates through the DOBs in step 4102 whereby a DOB is selected from the DOBs. Step 4104 determines whether a match exists with a particular code slice. For example, a code slice of “withdrawal” may be provided, such as in regards to a banking application (e.g., request 3608, request 3612, etc. of FIGS. 36A-B). If step 4104 finds a match with the DOB selected in step 4102, then processing continues to step 4112, otherwise processing continues to step 4106 whereby a determination is made if there are more DOBs. If step 4106 is determined in the negative, then processing continues to step 4108, such as to notify a requesting user or system that no such DOB exists within the domain of source code considered and having the associated DOBs. If step 4106 is determined in the affirmative, processing continues back to step 4102 whereby the next DOB is selected, and a determination is made, in step 4104, whether the currently selected DOB is a match.

Next, step 4112 accesses the source code associated with the matching slice and presents the accessed source code in step 4114. In another embodiment, process 4100 may be interactive, such as when user 3602 (of FIG. 36A) or other requesting entity or system, is presented with the accessed source code in step 4114 and refines the request. For example, the listing of source code associated with “withdrawal” may be too voluminous to be usable and thereby prompt another iteration of process 4100, such as (from the results presented in step 4114), “show ATM” to further drill-down into the source code.

It should be appreciated that process 4100 is not program slicing, but rather DOB slicing.

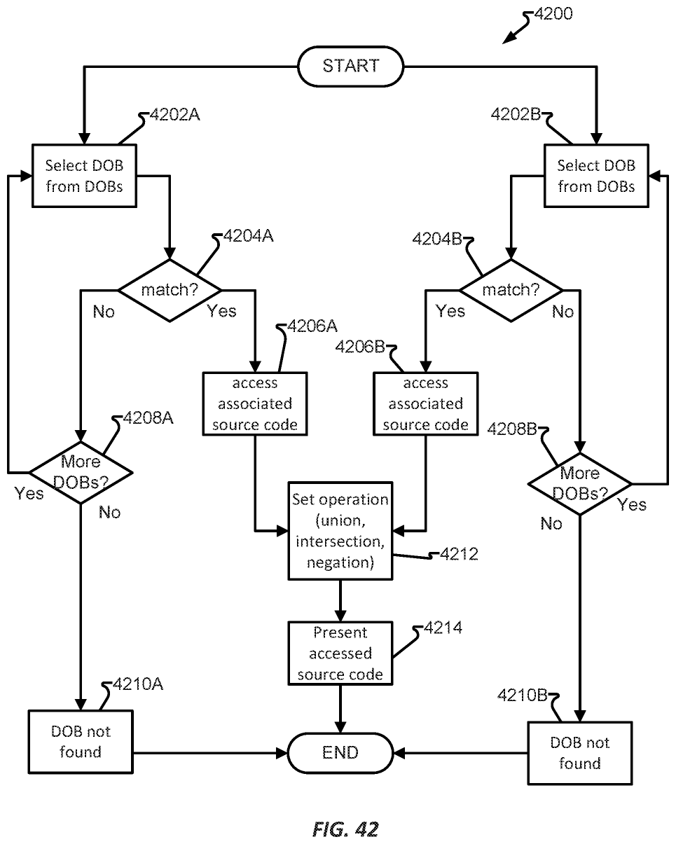

FIG. 42 depicts process 4200 in accordance with embodiments of the present disclosure. In one embodiment, process 4200 comprises a set operation, such as a union (e.g., “show withdrawals and ATM”), intersection (e.g., “show withdrawals from ATMs”), and negation (e.g., “show withdrawals not from a human teller”). Process 4200 may begin with the execution of step 4202, which may comprise steps 4202A and 4202B, for each portion of a compound request. Process 4200 is illustrated with two components, a first component comprising steps 4202A, 4204A, 4206A, and 4208A, and a second component comprising steps 4202B, 4204B, 4206B, and 4208B, such as when the compound requests comprises two subjects. It should be appreciated that three or more subjects, and associated third or more components of process 4200, may be utilized without departing from the scope of the embodiments. It should also be appreciated that components 4202, 4204, 4206, and 4208 may be executed multiple times, one for each subject, and thereby cause process 4200 to execute, at least in part, in series.

In one embodiment, step 4202 selects a DOB from the set of DOBs and step 4204 determines if the subject matches the selected DOB. If step 4204 is determined in the negative, processing continues to step 4208 to determine if there are more DOBs. If step 4208 is determined in the negative, processing continues to step 4210 and, at least a portion of process 4200, ends. In one embodiment, step 4210 may cause step 4212 to be omitted or executed without the results from each component. For example, a search for “withdrawals from Internet” may not exist for a particular bank, such as when one may transfer funds but obtaining currency is not possible. As a result, step 4212 may be modified to either omit all processing, such as to least to step 4212 presenting a null set of source code, or step 4212 may be modified and produce a list of “withdrawal” code with an indication that “withdrawal from Internet” is a null set.

If step 4204 is determined in the affirmative, processing continues to step 4206, whereby the associated source code is accessed and step 4212 then performs the set operation on the source code. The result is then presented in step 4214. It should be appreciated that step 4214 may present the source code, such as on a computer monitor or other display, or create a record for storage and/or transmission to another component, such as a requesting process.

Process 4200 may be executed in series, such as when step 4202B is not initiated unless step 4204A is determined in the affirmative; in parallel, such as when step 4202A, 4204A, and 4206A execute without regard to another processing thread comprising the execution of steps 4202B, 4204B, and 4206B. Step 4208 may comprise a delay if one processing thread (e.g., a thread comprising steps 4202A, 4204A, 4206A, a thread comprising steps 4202B, 4204B, and 4206B, etc.) has yet to reach step 4212.

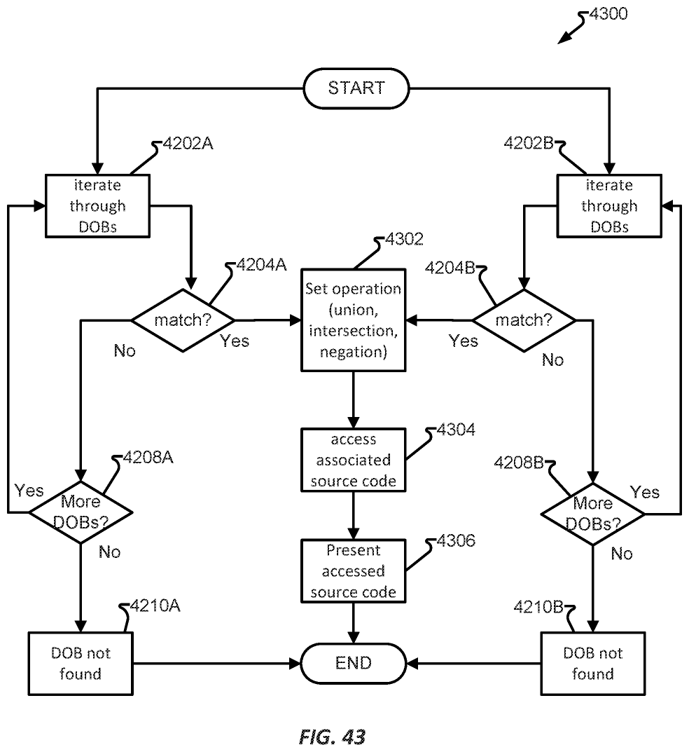

FIG. 43 depicts process 4300 in accordance with embodiments of the present disclosure. In one embodiment, steps 4202, 4204, 4208, 4210 may be performed as described more completely with respect to FIG. 42. In another embodiment, step 4302 performs a set operation on a compound query from the DOBs matched in two or more steps 4204. Accordingly, step 4304 then accesses the source code from the resulting set operation for presentation by step 4306.

FIG. 44 depicts DOB generation 4400 in accordance with embodiments of the present disclosure. In one embodiment, source code 4402 is mapped 4406 to DOB 4404.

FIG. 45A-C depicts DOB 4500, which may be sliced in to sub-DOBs.

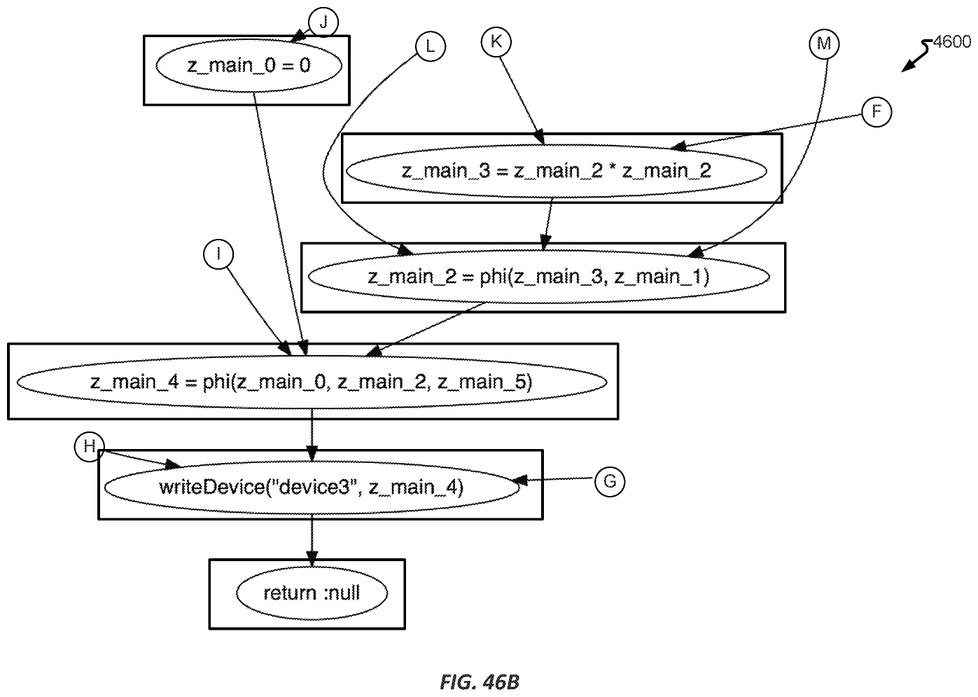

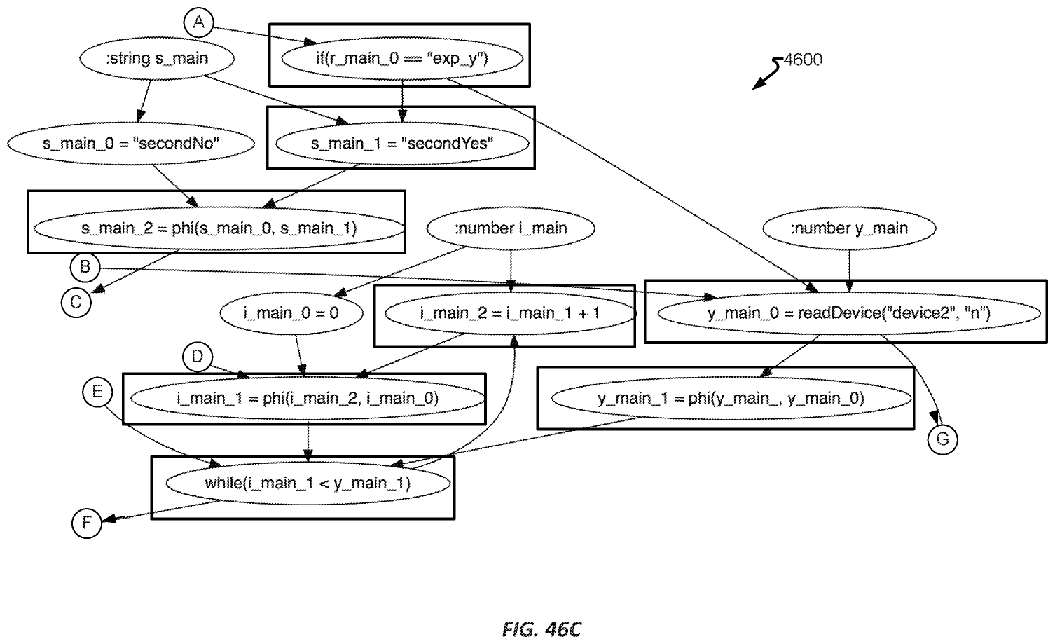

FIG. 46A-C depicts DOB 4600, which may be a slice (e.g., emphasized nodes) of DOB 4500.

FIG. 47A-C depicts DOB 4700, which may be a slice (e.g., emphasized nodes) of DOB 4500.

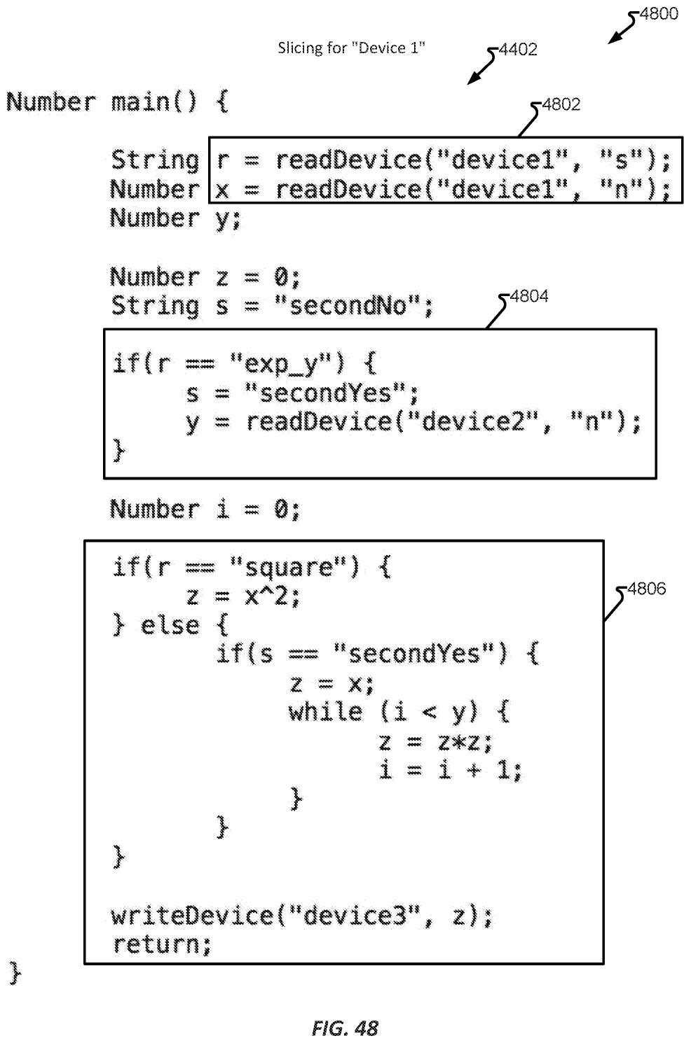

FIG. 48 depicts source code, with emphasized nodes associated with DOB 4600.

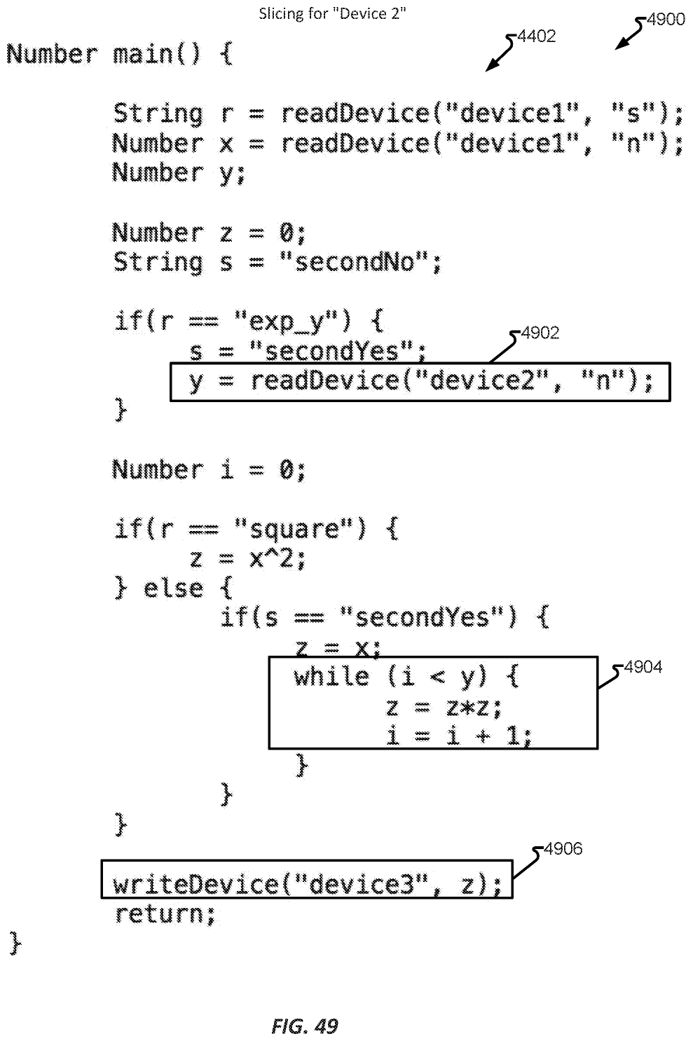

FIG. 49 depicts source code, with emphasized nodes associated with DOB 4700.

Small Example:

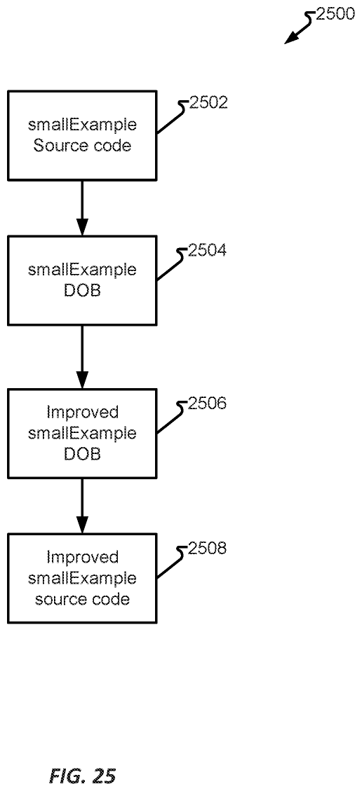

FIG. 25 depicts process 2500. In one embodiment, a source code (“smallExample”) is accessed in step 2502. Next, step 2504 creates a DOB of the source code smallExample. Next, in step 2506 an improved smallExample DOB is produced and, in step 2508, an improved source code is produced therefrom. Steps 2502, 2504, 2506, and 2508 being performed by a machine, such as a computer or portion thereof (e.g., processor), without human intervention or input.

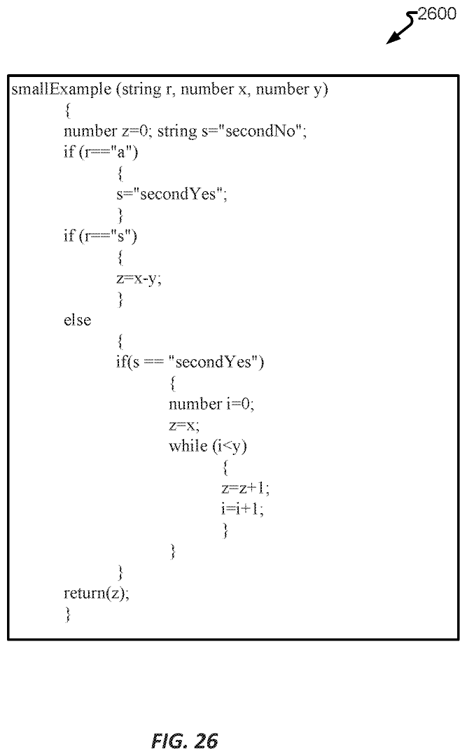

FIG. 26 depicts source code 2600 in accordance with embodiments of the present disclosure. In one embodiment, source code 2600 is an arbitrary, non-null set of instructions written in a programming language in a manner selected as conducive to human comprehension. In a further embodiment, source code 2600 is created and/or modified by a human. In another embodiment, source code 2600 comprises at least one variable identifier selected to symbolically represent a data value. As an example, and in one embodiment, source code 2600 comprises the instructions as illustrated.

Source code 2600 is illustrated as being written in the “While” programming language and called “smallExample.” The resulting DOB is illustrated and described with respect to FIGS. 27A-B.

FIGS. 27A-B depict DOB 2700 in accordance with embodiments of the present disclosure. Construction of Knowledge, Data States: Central to both applied computation and BHK intuitionism is that knowledge is explicitly constructed, or, in other words, explicitly created. Although this may seem a trivial restriction, in the classical formulation of logic, propositions can be implicitly created through assumption of contradiction. The most cited example of this is the “law of the excluded middle,” which allows statement such as; “Mick Jagger is POTUS, therefore, pink elephants exist,” to be true. These implicit constructions are the source of paradox, and are explicitly excluded in the constructivist/intuitionistic framework.

In an applied computation DOB, the BHK notion of “construction of knowledge” is simply mapped to the creation of a data value. Any operation that creates a value is “construction.” For example, a “while loop,” such as the while loop of smallExample (see. FIG. 26) contains two arithmetic operations in its iteration block: (1) z=z+1 and (2) i=i+1. Both of these operations, and any others that accept arguments and produce or assign new data states, correspond to “constructing” knowledge in the BHK formalism. Thus, by definition, the DOB conforms to the constructivist requirement.

In one embodiment, DOB 2700 is derived from source code 2600. DOB 2700 comprises nodes 2702-2744 and connections between nodes are known as vertices (or “edges”). The methodology for converting individual statements of source code 2600 to one of nodes 2702-2744 and edges will now be described. As a preliminary matter, the nomenclature for “if-then-else” is abbreviated in the figure as “ite.”

In one embodiment, arguments, such as nodes 2702, 2720, and 2722 are determined by input parameters to source code 2600 (e.g., input parameters “string r, number x, number y”). Starting at nodes 2702, 2720, and 2722, edges are labeled in accordance with the name of the variable (e.g., “r”, “x”, and “y”) and a version (e.g., “v0”, “v1”, etc.). A variable that does, or may change, values is represented by an incremented version portion of the edge name. As a result, an edge name identifies a specific variable at a specific point in execution illustrated by DOB 2700. Additionally, edge names indicating constants and/or control flow, such as edges connecting nodes with “true” or “false,” may be non-unique.

In another embodiment, constants, such as those represented by nodes 2706, 2708, 2718, and 2738, are determined in accordance with the instantiation of variables (e.g., “number z=0; string s=‘secondNo’”) local to source code 2600.

In another embodiment, assignments, such as those represented by nodes 2724, are determined in accordance with an assignment (e.g., “z=x+y”).

It should be noted that single node 2728 is illustrated on both FIG. 27A and FIG. 27B merely to avoid use of a plurality of additional off-page connectors that may impair readability. In another embodiment, phi-type nodes, such as those represented by nodes 2712, 2728, and 2742, are determined by machine-generated state to indicate a value that becomes known at runtime. For example, in source code 2600, the value of “s” cannot be determined by merely examining source code 2600. An input, such as the value of “r” determines which portion of code 2600 is executed, which in turn determines the value of “s” (e.g., “s=secondYes” or “s=secondNo”). Node 2712, for examples, reconciles the results of node 2708 and 2706 outputting “s_v1” and “s_v2,” respectively. The resulting edge from node 2712 (e.g., “s_v2”) is a third iteration of the value for “s,” from the inputs (e.g., “s_v0” and “s_v1”) where the if-then-else operation selectively determines the value of s_v2 and either the value represented by s_v0 or s_v1, whichever preceding node (e.g., node 2708 or node 2706) provides the edge to node 2712. Similar operations are provided by nodes 2740 and 2742. Nodes, such as nodes 2728 and 2732, similarly execute in accordance with a value determined at runtime.

In another embodiment, code statements, such as those represented by nodes 2704, 2710, and 2716 are determined by code statements, for example (and utilizing apostrophes in place of quotation marks to delineate list elements containing quotation marks), ‘if(r==“a”)’, ‘if(r==“s”)’, ‘if(s==“secondYes”)’, respectively.

In another embodiment, subtraction, such as that represented by node 2726 is determined by subtraction operation (e.g., “z=x−y”) performing a subtraction operation on “x_v0” and “y_v0” upon node 2710 determining “ite(r_v0==s)” (e.g., corresponding to source code 2600 where ‘if(r=“s”)’). Similarly, addition, such as represented by nodes 2734 and 2736 combine inputs to produce an output. And, in yet another embodiment, node 2744 is determined as a return value from source code 2600 (e.g., “return(z)”).

It should be appreciated by those of ordinary skill in the art that DOB 2700 is a graphical representation of a data structure derived and/or maintained in a computer-readable media (e.g., magnetic, electric, and/or optical media). A processor or processors, such as a processor within server 104 (See, FIG. 1), may access source code 2600 and execute non-transitory instructions to cause DOB 2700 to result therefrom. DOB 2700 may be held in a memory and/or written to a media for further processing.

FIGS. 28A-28C depict cycle-free DOB 2800 in accordance with embodiments of the present disclosure.

The smallExample program (see FIG. 26) illustrates a software source code that is awkwardly implemented and needlessly complex. Two specific issues are:

(1) The initial conditional detects an addition selection or request from the user. The body of the conditional does nothing other than set a “flag” that is then used by a subsequent conditional to test (again) for the addition request. This second conditional “guards” the actual loop that executes the addition. This duplication is confusing and is unnecessary in terms of smallExample's functional behavior; and

(2) The addition loop itself is a needlessly verbose approach to implementing addition. The “While” language itself implements addition in its libraries and, therefore, the loop could be collapsed into a concise arithmetic expression using the “+” operator.

Using the representations and operations herein, the following sections will walk-through the steps of transforming smallExample into an improved version that eliminates the two “addition issues” described above, while leaving the rest of smallExample's behavior unchanged.

The process identifies internal subordinate DOB concepts in smallExample and uses formal operations to transform the program source.

The refactoring example also touches on two major productivity issues in application evolution: comprehensible code and reuse of existing libraries. Both topics have a very deep literature, but the example may motivate the reader to consider thought experiments using this framework in other potential applications.

Fundamentals: User Function Selection DOB:

In the case of smallExample, user selection occurs as a command line interaction. If the user wants to subtract 10 from 20, she enters:

>smallExample s,20,10

Correspondingly, if the user wants to add 30 to 71, she enters:

>smallExample a,30,71

Selecting the first argument, either “a” or “s”, is a “user function selection” in smallExample. We can see a DOB's corresponding user selection options (FIG. 28). The selection of “a” corresponds to the DOB, which is the union of the subgraph 2802 and subgraph 2808. Not surprisingly, the selection of “s” corresponds to the union of subgraph 2802 and subgraph 2806. The notation for the “a” DOB shall be “DOB_A.” Correspondingly, the “s” DOB will be “DOB_S.”

DOB subgraphs 2804 and 2806 move us into a process of defining the refactoring problem, but without further manipulation, they are not really sufficient for our task. Here, both include subgraph 2802, which is a “function selection plumbing” that directs the user selection to the code that supports the selected function.

We need, therefore, to isolate the actual selected functions (DOB) from the “plumbing” of subgraph 2802, the next step in the process. The “user-selects” function defines a DOB using reaching operations. The basis of the reaching is defined by the user interaction in the command line interaction introduced above. The additional arguments (e.g. _UBX) represent anonymous variables corresponding to binding to any integer value.

Subgraph 2802 illustrates a portion of cycle-free DOB 2800 associated with common functionality from DOB 2700. Subgraph 2802 represents nodes executed when DOB 2700 (or cycle-free DOB 2800) is executed regardless of the input values. Accordingly, a processor may map node 2802 to 2810, 2820 to 2822, 2822 to 2814, and 2810 to 2816 and, as no “unrolling” is provided by the aforementioned nodes, the mapping may be a straightforward node-to-node mapping. Subgraph 2804 represents nodes executed when node 2816 determines the value of “r_v0==s” to be false. Additionally, subgraph 2808 illustrates additional groups of nodes executed when node 2816 determines the value of “r_v0==s” to be false.

Eliminating subgraph 2802 eliminates the common “plumbing.” This may be accomplished by a straight-forward use of set operations. We find the common code using an intersection operation on the user selection of addition (e.g., r=“a”) and subtraction (e.g., r=“s”), which results in subgraph 2802. We then subtract subgraph 2802 from subgraph 2804. Formulaically, the operation may be described as:

intersection(user-selects(a, _UBX, _UBY),
complement(

intersection( user-selects(a, _UBX, _UBY),

user-selects(a, _UBX, _UBY)

)

```
    )
  )
```

In another embodiment, subgraph 2804 comprises nodes 2810, 2818, 2820, and 2822 which map to nodes 2838, 2840, 2842, and 2844, respectively. In another embodiment, subgraph 2806 comprises nodes 2824, 2826, and 2828 which map to nodes 2826, 2842, and 2844, respectively. In another embodiment, node 2820 and node 2826 are functionally identical and each derived from node 2842 but now outside of any loop. Similarly, node 2822 and node 2828 are functionally identical and each derived from node 2844, but here to, outside of any loop.

In another embodiment, node 2830 is derived from node 2804 and, similarly, node 2832 from node 2808, node 2834 from node 2812, node 2836 from node 2816, node 2838 from node 2824, node 2840 from node 2818, node 2842 from node 2828, node 2844 from node 2828, node 2846 from node 2834, node 2848 from node 2836, node 2850 from node 2828, node 2852 from node 2840, node 2854 from node 2842, and node 2856 from node 2844. While some derivations are straightforward, removing loops may require additional processing. For example, the combination of node 2844, node 2842, and node 2850 is derived, at least in part, from node 2828 to remove the loop elements.

Here to it should be appreciated that cycle-free DOB 2800 is illustrated graphically for the promotion of human understanding. As with DOB 2700 and other figures herein, the representation may be embodied within a processor and/or a memory or other data storage device as may be created and/or maintained by a processor, such as a processor(s) within server 104.

FIGS. 29A-B depict unrolled structure 2900 in accordance with embodiments of the present disclosure. In one embodiment, a processor utilizes cycle-free DOB 2800 to create unrolled structure 2900. As a benefit, unrolled structure 2900 provides a graphical illustration of source code 2600 that is immutable in existence for all subsequent times. Here too the illustration of unrolled structure 2900 is merely a representation to promote human comprehension of what a processor creates and/or maintains in a memory or other storage device.

In one embodiment, nodes from DOB 2700 map to unrolled structure 2900 except to resolve looping. More specifically, nodes of DOB 2700 may map to nodes of unrolled structure 2900: node 2802 to 2902, 2804 to 2904, 2806 to 2906, 2808 to 2908, 2810 to 2910, 2812 to 2912, 2816 to 2916, 2818 to 2918, 2820 to 2920, 2822 to 2922, 2824 to 2924, 2826 to 2926, 2828 to 2928, 2832 to 2932, 2834 to 2934, 2836 to 2936, 2838 to 2938, 2840 to 2940, 2842 to 2942, and 2844 to 2944.

In another embodiment, node 2946 is created to track iterations of the “while” statement (see, source code 2600). Nodes 2934 and nodes 2936 output to “whilePhi” node 2946 which then flows to node 2940. As a result, no loops are present in unrolled structure 2900.

To conclude on the Example, FIG. 32 illustrates the example code “smallExample” comprising two concepts: addition and subtraction. Herein, we use smallExample to illustrate the principle that even simple applications, such as smallExample, are not only concepts, but themselves contain subordinate concepts.

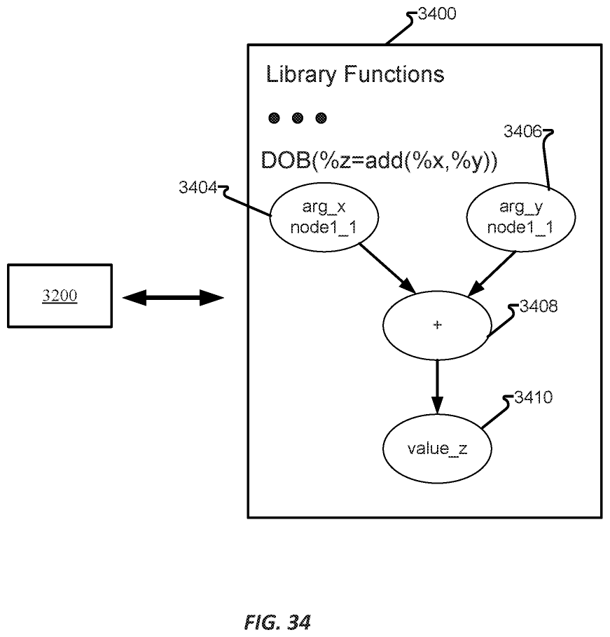

The library “addition,” (see FIG. 34 ref. 3400) can be used to define the “addition concept,” and maps all possible implementations of addition to a single canonical representative. More specifically, the library contains the canonical “While”-programming language representation of a behavioral equivalence class, namely, that of the “addition.” This use of equivalence classes creates the basis for an unambiguous strong semantics of comprehension.

The equivalence class allows computational behavior to be canonical and conceptually independent from specification. Many different specifications map to identical functional behavior. As previously discussed, this form of semantics is extensible with DOBs that are useful for reuse in domain-specific applications, whether banking, gaming, or avionics.

Again, this resonates with the requirements of a collaborative representation, and is meaningful to both human engineers and the machine agents serving them. The use of set operations to define the “user-selected function” demonstrates one of many circumstances in which we can formally define reusable subordinate concepts.

The significance that “user-selected function” can be defined using these operations, without reference to the original source code, is of paramount importance to independent conceptual comprehension, interpretation, and use by machine agents.

Library Functions and Functional Equivalence:

FIG. 33 depicts source code 2600 in accordance with embodiments of the present disclosure.

The DOB refactoring step replaces the awkward “addition” DOB with a more concise version that uses the “While” language native addition expression.

This specific refactoring operation is illustrated with respect to FIG. 34. The refactoring proceeds simply by replacing the DOB in smallExample (bolded nodes 2908, 2912, 2916, 2918, 2924, 2928, 2932, 2934, 2936, 2946, 2940) with the library-based addition DOB (FIG. 34, 3400). The signature of both is guaranteed to be identical by definition of DOB functional equivalence. Therefore, the subgraph replacement operation is a simple cut and replace.

The cut-and-replace refactoring is guaranteed to be conceptually independent from other concepts by virtue of the actual set operations used, as discussed above.

In one embodiment, the bolded nodes and dashed nodes of unrolled structure 3200 as illustrated in FIG. 32 are projected onto source code 2600. In particular, bolded nodes (i.e., addition notes) are mapped to code segment 3302 and code segment 3306. Dashed nodes (i.e, subtraction nodes) are mapped to code segment 3304.

The portions not emphasized (i.e., the portion of source code 2600 other than the portions identified as code segment 3302, 3304, and 3306) identify common language or “plumbing” and defined the distinct DOBs, which behaviorally differentiate addition from subtraction.

The bolded portions of FIG. 32 and code segments 3302 and 3306 contain the awkward programming language and redundant use of the while-loop, rather than a simple arithmetic expression. Resolution may now be applied.

FIG. 34 depicts library functions 3400 in accordance with embodiments of the present disclosure. In one embodiment, source code 2600 is edited to comprise library function 3400 comprised of nodes 3404, 3406, 3408, and 3410 such as to replace the addition portion identified as code segment 3302 and 3304. In one embodiment, a cut-and-replace refactoring is utilized to replace code segment 3302 and 3304 with library function 3400.

Source Generation and Clean-up:

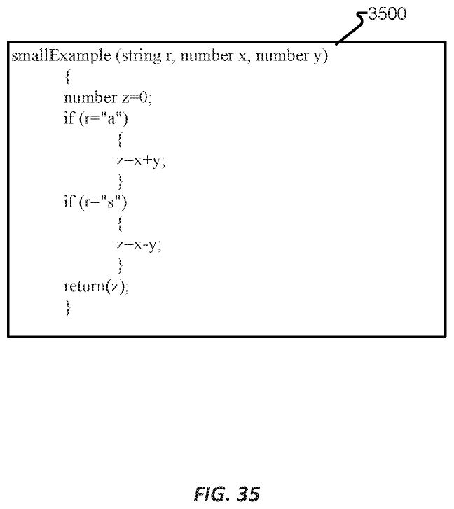

FIG. 35 depicts refactored source code 3500 in accordance with embodiments of the present disclosure.

Source code 3500 illustrates the result of the smallExample refactoring projected on its “While” source code. The result is that which most developers would view as a cogent, simple implementation.

In this case, the actual programming language source code is independent, in the sense of “impact analysis.” There is no intersection of the mapping of the source code corresponding with the other defined concept, subtraction. A more complex refactoring example might require automated “post-factoring.”

For clarity sake, we assume that any tool that does such automated refactoring would employ long-existing compiler techniques that facilitate elimination of unused variable declarations and empty “else” clauses.

In one embodiment, refactored source code 3500 results from a processor substituting the “a” library function for code segments, such as code segments 3302 and 3304 being replaced by library function 3400 (see, FIG. 34).

Actualization: Concepts, Intention, Program Analysis:

This DOB-concept approach to program analysis and automated comprehension is a shift from the low-level graph-analysis-approach typically used today in the software industry.

In the above example used in this article we fixed both the “conditional” and “loop” issues with one refactoring operation. This happy outcome results from both issues being encapsulated in the same concept—the addition DOB (bolded nodes 2908, 2912, 2916, 2918, 2924, 2928, 2932, 2934, 2936, 2946, 2940). When we replaced the concept from the “While” library, we replaced the DOB (bolded nodes 2908, 2912, 2916, 2918, 2924, 2928, 2932, 2934, 2936, 2946, 2940), and both issues were resolved. Though happy, this is not serendipity nor a random event.

The sub-DOBs identified in smallExample correspond to the programmer's intention. The programmer intended to implement subtraction when “s” was selected and addition when “a” was selected. These are literally the concepts that the programmer intended.

The BHK set operations facilitated the automation to comprehend and manipulate smallExample using the concepts in the programmer's intention.

The phrase “execution path” refers to the specific instructions, in a set of instructions utilized to produce a particular behavior, output, or result.

Exemplary aspects are directed toward:

A method for improving source code maintenance by identifying a target source code portion having a behavior from a source code is disclosed, comprising:

accessing an indicia of the behavior, the behavior comprising a result of an execution of a multi-step computer operation;

accessing a first source code, wherein the first source code when converted to machine-readable instructions, comprises the multi-step computer operation, the first source code further comprising a plurality of functional structures, each functional structure performing a logical computing function comprising at least one functional element;

deriving, from the first source code, a first dependency ordered behavior (DOB) associated with a plurality of the functional elements independent of their respective functional structures and identifying an execution path utilized to produce the behavior; and storing the plurality of functional elements in a non-transitory media to allow for more efficient maintenance of the first source code.

Any of the above aspects, wherein the execution path is one of a plurality of execution paths.

Any of the above aspects, wherein deriving the first DOB comprises, searching the first source code for an output having an associated human-readable description of the output associated with the behavior.

Any of the above aspects, wherein the description of the output associated with the behavior comprises a use-case.

Any of the above aspects, wherein the human-readable description of the output is associated with the behavior when the human-readable description is descriptively equivalent to the indicia of the behavior.

Any of the above aspects, wherein the descriptively equivalent comprises differences between the human-readable description and the indicia of the behavior being synonyms.

Any of the above aspects, wherein the deriving the first DOB further comprises: deriving an abstract syntax tree (AST) from the source code; deriving a control flow graph (CFG) from the AST; and deriving a single static assignment control flow graph (SSA-CFG) from the CFG; and wherein the first DOB is derived from the SSA-CFG.

Any of the above aspects, wherein the deriving the control flow graph (CFG) from the AST further comprises: deriving an inlined-AST from the AST; and deriving the control flow graph (CFG) from the inlined-AST.

Any of the above aspects, wherein deriving a first DOB further comprises: slicing a source code DOB into sub-DOBs indexed according to their specific and unique data-dependency inheritance.

Any of the above aspects, wherein associating with each sub-DOB a unique Concept-Formula identifying the unique statement that generates the inheritance and a unique direction for this inheritance (forward or backward).

Any of the above aspects, wherein selecting a second source code, wherein the selection of the second source code is performed based upon the second source code having an associated second DOB and the second DOB being equivalent to the first DOB; and replacing the first source code with the second source code.

Any of the above aspects, wherein accessing the stored functional elements for presentation on a display.

Any of the above aspects, wherein recursively performing at least once: accessing the indicia of a sub-behavior, the sub-behavior comprising one result of an execution of the plurality of functional elements; accessing a second source code, wherein the second source code when converted to machine-readable instructions, comprises the multi-step computer operation, the second source code further comprising a second plurality of functional structures, each functional structure performing a logical computing function comprising at least one functional element; deriving, from the second source code, a second dependency ordered behavior (DOB) associated with the second plurality of the functional elements independent of their respective functional structures and identifying a second execution path utilized to produce the sub-behavior; and storing the second plurality of functional elements in a non-transitory media.

Any of the above aspects, wherein the second source code comprises the first source code.

Any of the above aspects, wherein the behavior is an anticipated behavior received as a query.

Any of the above aspects, wherein the query further comprises a logical combination of a plurality of queries, each of the plurality of queries being operands in the query.

Any of the above aspects, wherein accessing a plurality of candidate source codes; deriving, from ones of the plurality of candidate source codes, an associated and corresponding plurality of candidate DOBs; deriving a query DOB associated with anticipated behavior; and upon determining one of the plurality of candidate DOBs is functionally equivalent to the query DOB, selecting corresponding one of the candidate source code as the first source code.

Any of the above aspects, wherein accessing a plurality of candidate source codes; deriving, from ones of the plurality of candidate source codes, an associated and corresponding plurality of candidate DOBs; deriving a DOB, resulting from a set operation (union, intersection and/or complementation) over the plurality of candidate DOBs, that is associated with anticipated behavior; and associating the corresponding first source code to that behavior, and describing that behavior as a logical operation (or, and, not) over the behaviors corresponding to the candidate DOBs.

Any of the above aspects, wherein the data storage comprises at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

A method for improving source code maintenance by identifying a target source code portion having a behavior from a source code, comprising: accessing an indicia of the behavior, the behavior comprising a result of an execution of a multi-step computer operation and wherein the result defines a node of an operation in the source code and further defining a cone-of-influence comprising only nodes in the source code reachable by the node to produce the result; accessing a first source code, wherein the first source code when converted to machine-readable instructions, comprises the multi-step computer operation, the first source code further comprising a plurality of functional structures, each functional structure performing a logical computing function comprising at least one functional element; deriving, from the first source code, a first dependency ordered behavior (DOB) associated with a plurality of the functional elements independent of their respective functional structures and identifying an execution path utilized to produce the behavior; and storing the plurality of functional elements in a non-transitory media to allow for more efficient maintenance of the first source code.

Any of the above aspects, wherein the execution path is one of a plurality of execution paths.

Any of the above aspects, wherein deriving the first DOB comprises, searching the first source code for an output having an associated human-readable description of the output associated with the behavior.

Any of the above aspects, wherein the description of the output associated with the behavior comprises a use-case.

Any of the above aspects, wherein the human-readable description of the output is associated with the behavior when the human-readable description is descriptively equivalent to the indicia of the behavior.

Any of the above aspects, wherein descriptively equivalent comprises differences between the human-readable description and the indicia of the behavior being synonyms.

Any of the above aspects, wherein the deriving the first DOB further comprises: deriving an abstract syntax tree (AST) from the source code; deriving a control flow graph (CFG) from the AST; and deriving a single static assignment control flow graph (SSA-CFG) from the CFG; and wherein the first DOB is derived from the SSA-CFG.

Any of the above aspects, wherein the deriving the control flow graph (CFG) from the AST further comprises: deriving an inlined-AST from the AST; and deriving the control flow graph (CFG) from the inlined-AST.

Any of the above aspects, wherein deriving a first DOB further comprises: slicing a source code DOB into sub-DOBs indexed according to their specific and unique data-dependency inheritance.

Any of the above aspects, wherein associating with each sub-DOB a unique Concept-Formula identifying the unique statement that generates the inheritance and a unique direction for this inheritance (forward or backward).

Any of the above aspects, wherein selecting a second source code, wherein the selection of the second source code is performed based upon the second source code having an associated second DOB and the second DOB being equivalent to the first DOB; and replacing the first source code with the second source code.

Any of the above aspects, wherein accessing the stored functional elements for presentation on a display.

Any of the above aspects, wherein recursively performing at least once: accessing the indicia of a sub-behavior, the sub-behavior comprising one result of an execution of the plurality of functional elements; accessing a second source code, wherein the second source code when converted to machine-readable instructions, comprises the multi-step computer operation, the second source code further comprising a second plurality of functional structures, each functional structure performing a logical computing function comprising at least one functional element; deriving, from the second source code, a second dependency ordered behavior (DOB) associated with the second plurality of the functional elements independent of their respective functional structures and identifying a second execution path utilized to produce the sub-behavior; and storing the second plurality of functional elements in a non-transitory media.

Any of the above aspects, wherein the second source code comprises the first source code.

Any of the above aspects, wherein the behavior is an anticipated behavior received as a query.

Any of the above aspects, wherein the query further comprises a logical combination of a plurality of queries, each of the plurality of queries being operands in the query.

Any of the above aspects, wherein accessing a plurality of candidate source codes; deriving, from ones of the plurality of candidate source codes, an associated and corresponding plurality of candidate DOBs; deriving a query DOB associated with anticipated behavior; and upon determining one of the plurality of candidate DOBs is functionally equivalent to the query DOB, selecting corresponding one of the candidate source code as the first source code.

Any of the above aspects, wherein accessing a plurality of candidate source codes; deriving, from ones of the plurality of candidate source codes and corresponding plurality of candidate DOBs; deriving a DOB, resulting from a set operation (union, intersection and/or complementation) over the plurality of candidate DOBs, that is associated with anticipated behavior; and associating the corresponding first source code to that behavior, and describing that behavior as a logical operation (or, and, not) over the behaviors corresponding to the candidate DOBs.

Any of the above aspects, wherein the data storage comprises at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

A system, comprising: a processor; and a data storage; and wherein the processor: accesses, from the data storage, an indicia of the behavior, the behavior comprising a result of an execution of a multi-step computer operation; accesses, from the data storage, a first source code, wherein the first source code when converted to machine-readable instructions, comprises the multi-step computer operation, the first source code further comprising a plurality of functional structures, each functional structure performing a logical computing function comprising at least one functional element; derives, from the first source code, a first dependency ordered behavior (DOB) associated with a plurality of the functional elements independent of their respective functional structures and identifying an execution path utilized to produce the behavior; and stores, in the data storage, the plurality of functional elements in a non-transitory media to allow for more efficient maintenance of the first source code.

Any of the above aspects, wherein the execution path is one of a plurality of execution paths.

Any of the above aspects, wherein deriving the first DOB comprises, searching the first source code for an output having an associated human-readable description of the output associated with the behavior.

Any of the above aspects, wherein the description of the output associated with the behavior comprises a use-case.

Any of the above aspects, wherein the human-readable description of the output is associated with the behavior when the human-readable description is descriptively equivalent to the indicia of the behavior.

Any of the above aspects, wherein descriptively equivalent comprises differences between the human-readable description and the indicia of the behavior being synonyms.

Any of the above aspects, wherein the deriving the first DOB further comprises: deriving an abstract syntax tree (AST) from the source code; deriving a control flow graph (CFG) from the AST; and deriving a single static assignment control flow graph (SSA-CFG) from the CFG; and wherein the first DOB is derived from the SSA-CFG.

Any of the above aspects, wherein the deriving the control flow graph (CFG) from the AST further comprises: deriving an inlined-AST from the AST; and deriving the control flow graph (CFG) from the inlined-AST.

Any of the above aspects, wherein deriving a first DOB further comprises: slicing a source code DOB into sub-DOBs indexed according to their specific and unique data-dependency inheritance.

Any of the above aspects, wherein associating with each sub-DOB a unique Concept-Formula identifying the unique statement that generates the inheritance and a unique direction for this inheritance (forward or backward).

Any of the above aspects, wherein selecting a second source code, wherein the selection of the second source code is performed based upon the second source code having an associated second DOB and the second DOB being equivalent to the first DOB; and replacing the first source code with the second source code.

Any of the above aspects, wherein accessing the stored functional elements for presentation on a display.

Any of the above aspects, wherein recursively performing at least once: accessing the indicia of a sub-behavior, the sub-behavior comprising one result of an execution of the plurality of functional elements; accessing a second source code, wherein the second source code when converted to machine-readable instructions, comprises the multi-step computer operation, the second source code further comprising a second plurality of functional structures, each functional structure performing a logical computing function comprising at least one functional element; deriving, from the second source code, a second dependency ordered behavior (DOB) associated with the second plurality of the functional elements independent of their respective functional structures and identifying a second execution path utilized to produce the sub-behavior; and storing the second plurality of functional elements in a non-transitory media.

Any of the above aspects, wherein the second source code comprises the first source code.

Any of the above aspects, wherein the behavior is an anticipated behavior received as a query.

Any of the above aspects, wherein the query further comprises a logical combination of a plurality of queries, each of the plurality of queries being operands in the query.

Any of the above aspects, wherein accessing a plurality of candidate source codes; deriving, from ones of the plurality of candidate source codes, an associated and corresponding plurality of candidate DOBs; deriving a query DOB associated with anticipated behavior; and upon determining one of the plurality of candidate DOBs is functionally equivalent to the query DOB, selecting corresponding one of the candidate source code as the first source code.

Any of the above aspects, wherein accessing a plurality of candidate source codes; deriving, from ones of the plurality of candidate source codes and corresponding plurality of candidate DOBs; deriving a DOB, resulting from a set operation (union, intersection and/or complementation) over the plurality of candidate DOBs, that is associated with anticipated behavior; and associating the corresponding first source code to that behavior, and describing that behavior as a logical operation (or, and, not) over the behaviors corresponding to the candidate DOBs.

Any of the above aspects, wherein the data storage comprises at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

A system, comprising: means for accessing an indicia of the behavior, the behavior comprising a result of an execution of a multi-step computer operation; means for accessing a first source code, wherein the first source code when converted to machine-readable instructions, comprises the multi-step computer operation, the first source code further comprising a plurality of functional structures, each functional structure performing a logical computing function comprising at least one functional element; means for deriving, from the first source code, a first dependency ordered behavior (DOB) associated with a plurality of the functional elements independent of their respective functional structures and identifying an execution path utilized to produce the behavior; and means for storing the plurality of functional elements in a non-transitory media to allow for more efficient maintenance of the first source code. Any of the above aspects, wherein the execution path is one of a plurality of execution paths.

Any of the above aspects, wherein deriving the first DOB comprises, searching the first source code for an output having an associated human-readable description of the output associated with the behavior.

Any of the above aspects, wherein the description of the output associated with the behavior comprises a use-case.

Any of the above aspects, wherein the human-readable description of the output is associated with the behavior when the human-readable description is descriptively equivalent to the indicia of the behavior.

Any of the above aspects, wherein descriptively equivalent comprises differences between the human-readable description and the indicia of the behavior being synonyms.

Any of the above aspects, wherein the deriving the first DOB further comprises: deriving an abstract syntax tree (AST) from the source code; deriving a control flow graph (CFG) from the AST; and deriving a single static assignment control flow graph (SSA-CFG) from the CFG; and wherein the first DOB is derived from the SSA-CFG.

Any of the above aspects, wherein the deriving the control flow graph (CFG) from the AST further comprises: deriving an inlined-AST from the AST; and deriving the control flow graph (CFG) from the inlined-AST.

Any of the above aspects, wherein deriving a first DOB further comprises: slicing a source code DOB into sub-DOBs indexed according to their specific and unique data-dependency inheritance.

Any of the above aspects, wherein associating with each sub-DOB a unique Concept-Formula identifying the unique statement that generates the inheritance and a unique direction for this inheritance (forward or backward).

Any of the above aspects, wherein selecting a second source code, wherein the selection of the second source code is performed based upon the second source code having an associated second DOB and the second DOB being equivalent to the first DOB; and replacing the first source code with the second source code.

Any of the above aspects, wherein accessing the stored functional elements for presentation on a display.

Any of the above aspects, wherein recursively performing at least once: accessing the indicia of a sub-behavior, the sub-behavior comprising one result of an execution of the plurality of functional elements; accessing a second source code, wherein the second source code when converted to machine-readable instructions, comprises the multi-step computer operation, the second source code further comprising a second plurality of functional structures, each functional structure performing a logical computing function comprising at least one functional element; deriving, from the second source code, a second dependency ordered behavior (DOB) associated with the second plurality of the functional elements independent of their respective functional structures and identifying a second execution path utilized to produce the sub-behavior; and storing the second plurality of functional elements in a non-transitory media.

Any of the above aspects, wherein the second source code comprises the first source code.

Any of the above aspects, wherein the behavior is an anticipated behavior received as a query.

Any of the above aspects, wherein the query further comprises a logical combination of a plurality of queries, each of the plurality of queries being operands in the query.

Any of the above aspects, wherein accessing a plurality of candidate source codes; deriving, from ones of the plurality of candidate source codes, an associated and corresponding plurality of candidate DOBs; deriving a query DOB associated with anticipated behavior; and upon determining one of the plurality of candidate DOBs is functionally equivalent to the query DOB, selecting corresponding one of the candidate source code as the first source code.

Any of the above aspects, wherein accessing a plurality of candidate source codes; deriving, from ones of the plurality of candidate source codes and corresponding plurality of candidate DOBs; deriving a DOB, resulting from a set operation (union, intersection and/or complementation) over the plurality of candidate DOBs, that is associated with anticipated behavior; and associating the corresponding first source code to that behavior, and describing that behavior as a logical operation (or, and, not) over the behaviors corresponding to the candidate DOBs.

A system on a chip (SoC) including any one or more of the above aspects.

One or more means for performing any one or more of the above aspects.

Any one or more of the aspects as substantially described herein.

Any of the above aspects, wherein the data storage comprises at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method for improving source code maintenance by identifying a target source code portion having a behavior from a source code, comprising:
accessing an indicia of the behavior, the behavior comprising a result of an execution of a multi-step computer operation;
accessing a first source code, wherein the first source code when converted to machine-readable instructions, comprises the multi-step computer operation, the first source code further comprising a plurality of functional structures, each functional structure performing a logical computing function comprising at least one functional element;
deriving, from the first source code, a first dependency ordered behavior (DOB) associated with a plurality of the functional elements independent of their respective functional structures and identifying an execution path utilized to produce the behavior; and
storing the plurality of functional elements in a non-transitory media to allow for more efficient maintenance of the first source code.

2. The method of claim 1, wherein the execution path is one of a plurality of execution paths.

3. The method of claim 1, wherein, deriving the first DOB comprises, searching the first source code for an output having an associated human-readable description of the output associated with the behavior.

4. The method of claim 3, wherein the description of the output associated with the behavior comprises a use-case.

5. The method of claim 3, wherein the human-readable description of the output is associated with the behavior when the human-readable description is descriptively equivalent to the indicia of the behavior.

6. The method of claim 5, wherein descriptively equivalent comprises differences between the human-readable description and the indicia of the behavior being synonyms.

7. The method of claim 1, wherein deriving the first DOB further comprises:
deriving an abstract syntax tree (AST) from the source code;
deriving a control flow graph (CFG) from the AST; and
deriving a single static assignment control flow graph (SSA-CFG) from the CFG; and
wherein the first DOB is derived from the SSA-CFG.

8. The method of claim 7, wherein deriving the control flow graph (CFG) from the AST further comprises:
deriving an inlined-AST from the AST; and
deriving the control flow graph (CFG) from the inlined-AST.

9. The method of claim 1, further comprising:
selecting a second source code, wherein the selection of the second source code is performed based upon the second source code having an associated second DOB and the second DOB being equivalent to the first DOB; and
replacing the first source code with the second source code.

10. The method of claim 1, further comprising, accessing the stored functional elements for presentation on a display.

11. The method of claim 1, further comprising, recursively performing at least once:
accessing the indicia of a sub-behavior, the sub-behavior comprising one result of an execution of the plurality of functional elements;
accessing a second source code, wherein the second source code when converted to machine-readable instructions, comprises the multi-step computer operation, the second source code further comprising a second plurality of functional structures, each functional structure performing a logical computing function comprising at least one functional element;
deriving, from the second source code, a second dependency ordered behavior (DOB) associated with the second plurality of the functional elements independent of their respective functional structures and identifying a second execution path utilized to produce the sub-behavior; and
storing the second plurality of functional elements in a non-transitory media.

12. The method of claim 11, wherein the second source code comprises the first source code.

13. The method of claim 1, wherein the behavior is an anticipated behavior received as a query.

14. The method of claim 13, wherein the query further comprises a logical combination of a plurality of queries, each of the plurality of queries being operands in the query.

15. The method of claim 13, further comprising:
accessing a plurality of candidate source codes;
deriving, from ones of the plurality of candidate source codes, an associated and corresponding plurality of candidate DOBs;
deriving a query DOB associated with anticipated behavior; and
upon determining one of the plurality of candidate DOBs is functionally equivalent to the query DOB, selecting corresponding one of the candidate source code as the first source code.

16. A method for improving source code maintenance by identifying a target source code portion having a behavior from a source code, comprising:
accessing an indicia of the behavior, the behavior comprising a result of an execution of a multi-step computer operation and wherein the result defines a node of an operation in the source code and further defining a cone-of-influence comprising only nodes in the source code reachable by the node to produce the result;
accessing a first source code, wherein the first source code when converted to machine-readable instructions, comprises the multi-step computer operation, the first source code further comprising a plurality of functional structures, each functional structure performing a logical computing function comprising at least one functional element;
deriving, from the first source code, a first dependency ordered behavior (DOB) associated with a plurality of the functional elements independent of their respective functional structures and identifying an execution path utilized to produce the behavior; and
storing the plurality of functional elements in a non-transitory media to allow for more efficient maintenance of the first source code.

17. A system, comprising
a processor; and
a data storage; and
wherein the processor:
accesses, from the data storage, an indicia of the behavior, the behavior comprising a result of an execution of a multi-step computer operation;
accesses, from the data storage, a first source code, wherein the first source code when converted to machine-readable instructions, comprises the multi-step computer operation, the first source code further comprising a plurality of functional structures, each functional structure performing a logical computing function comprising at least one functional element;
derives, from the first source code, a first dependency ordered behavior (DOB) associated with a plurality of the functional elements independent of their respective functional structures and identifying an execution path utilized to produce the behavior; and
stores, in the data storage, the plurality of functional elements in a non-transitory media to allow for more efficient maintenance of the first source code.

18. The system of claim 17, wherein the data storage comprises at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

19. A system, comprising:
means for accessing an indicia of the behavior, the behavior comprising a result of an execution of a multi-step computer operation;
means for accessing a first source code, wherein the first source code when converted to machine-readable instructions, comprises the multi-step computer operation, the first source code further comprising a plurality of functional structures, each functional structure performing a logical computing function comprising at least one functional element;
means for deriving, from the first source code, a first dependency ordered behavior (DOB) associated with a plurality of the functional elements independent of their respective functional structures and identifying an execution path utilized to produce the behavior; and
means for storing the plurality of functional elements in a non-transitory media to allow for more efficient maintenance of the first source code.
